(19) United States
(12) Patent Application Publication
(10) Pub. No.: US 2024/0264410 A1
(43) Pub. Date: Aug. 8, 2024

(54) PHOTOGRAPHING SYSTEM LENS ASSEMBLY, IMAGING APPARATUS AND ELECTRONIC DEVICE

(71) Applicant: LARGAN PRECISION CO., LTD., Taichung City (TW)

(72) Inventors: Kuan-Ting YEH, Taichung City (TW); Cheng-Yu TSAI, Taichung City (TW)

(21) Appl. No.: 18/432,213

(22) Filed: Feb. 5, 2024

(30) Foreign Application Priority Data
Feb. 6, 2023 (TW) 112104143

(51) Int. Cl. G02B 13/00; G02B 9/64

(52) U.S. Cl. CPC G02B 13/0045; G02B 9/64

(57) ABSTRACT

A photographing system lens assembly includes eight lens elements, the eight lens elements being, in order from an object side to an image side, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side.

### RELATED APPLICATIONS

This application claims priority to Taiwan Application Serial Number 112104143, filed Feb. 6, 2023, which is herein incorporated by reference.

### BACKGROUND

### Technical Field

The present disclosure relates to a photographing system lens assembly and an imaging apparatus. More particularly, the present disclosure relates to a photographing system lens assembly and an imaging apparatus with compact size applicable to electronic devices.

### Description of Related Art

With recent technology of semiconductor process advances, performances of image sensors are enhanced, so that the smaller pixel size can be achieved. Therefore, optical lens assemblies with high image quality have become an indispensable part of many modern electronics. With rapid developments of technology, applications of electronic devices equipped with optical lens assemblies increase and there is a wide variety of requirements for optical lens assemblies. However, in a conventional optical lens assembly, it is hard to balance among image quality, sensitivity, aperture size, volume or field of view. Thus, there is a demand for an image capturing system lens assembly that meets the aforementioned needs.

### SUMMARY

According to one aspect of the present disclosure, a photographing system lens assembly includes eight lens elements, the eight lens elements being, in order from an object side to an image side, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. When a focal length of the photographing system lens assembly is f, a focal length of the fifth lens element is f5, a focal length of the sixth lens element is f6, a focal length of the seventh lens element is f7, a focal length of the eighth lens element is f8, a sum of central thicknesses of the lens elements of the photographing system lens assembly is ΣCT, a sum of all axial distances between adjacent lens elements of the photographing system lens assembly is ΣAT, a curvature radius of the image-side surface of the second lens element is R4, a curvature radius of the image-side surface of the sixth lens element is R12, a curvature radius of the image-side surface of the seventh lens element is R14, and a curvature radius of the image-side surface of the eighth lens element is R16, the following conditions are satisfied: 0<(|f/f5|+|f/f6|)/(|f/f7|+|f/f8|)<0.50; 2.0<ΣCT/ΣAT<5.0; −10.0<f7/f8<−1.5; 0.9<(R12+R16)/(R12−R16)<3.0; and −1.95<(R4+R14)/(R4−R14)<−0.51.

According to one aspect of the present disclosure, an imaging apparatus includes the photographing system lens assembly of the aforementioned aspect and an image sensor, wherein the image sensor is disposed on an image surface of the photographing system lens assembly.

According to one aspect of the present disclosure, an electronic device includes the imaging apparatus of the aforementioned aspect.

According to one aspect of the present disclosure, a photographing system lens assembly includes eight lens elements, the eight lens elements being, in order from an object side to an image side, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. The object-side surface of the seventh lens element is convex in a paraxial region thereof; the image-side surface of the eighth lens element includes at least one inflection point. When a focal length of the photographing system lens assembly is f, a focal length of the first lens element is f1, a focal length of the second lens element is f2, a focal length of the fifth lens element is f5, a focal length of the sixth lens element is f6, a focal length of the seventh lens element is f7, a focal length of the eighth lens element is f8, a sum of central thicknesses of the lens elements of the photographing system lens assembly is ΣCT, a sum of all axial distances between adjacent lens elements of the photographing system lens assembly is ΣAT, a central thickness of the first lens element is CT1, a central thickness of the fifth lens element is CT5, a central thickness of the sixth lens element is CT6, a central thickness of the seventh lens element is CT7, a curvature radius of the image-side surface of the seventh lens element is R14, and a curvature radius of the image-side surface of the eighth lens element is R16, the following conditions are satisfied: 0<(|f/f5|+|f/f6|)/(|f/f7|+|f/f8|)<0.50; 2.0<ΣCT/ΣAT<5.0; 0.5<CT5/(CT6+CT7)<1.0; 0.16<(R14+R16)/(R14−R16)<2.10; 0.1<f1/CT1<10.0; and 0.30<|f1/f2|<2.0.

### BRIEF DESCRIPTION OF THE DRAWINGS

The present disclosure can be more fully understood by reading the following detailed description of the embodiment, with reference made to the accompanying drawings as follows:

FIG. 1 is a schematic view of an imaging apparatus according to the 1st embodiment of the present disclosure.

FIG. 2 shows spherical aberration curves, astigmatic field curves and a distortion curve of the imaging apparatus according to the 1 st embodiment.

FIG. 3 is a schematic view of an imaging apparatus according to the 2nd embodiment of the present disclosure.

FIG. 4 shows spherical aberration curves, astigmatic field curves and a distortion curve of the imaging apparatus according to the 2nd embodiment.

FIG. 5 is a schematic view of an imaging apparatus according to the 3rd embodiment of the present disclosure.

FIG. 6 shows spherical aberration curves, astigmatic field curves and a distortion curve of the imaging apparatus according to the 3rd embodiment.

FIG. 7 is a schematic view of an imaging apparatus according to the 4th embodiment of the present disclosure.

FIG. 8 shows spherical aberration curves, astigmatic field curves and a distortion curve of the imaging apparatus according to the 4th embodiment.

FIG. 9 is a schematic view of an imaging apparatus according to the 5th embodiment of the present disclosure.

FIG. 10 shows spherical aberration curves, astigmatic field curves and a distortion curve of the imaging apparatus according to the 5th embodiment.

FIG. 11 is a schematic view of an imaging apparatus according to the 6th embodiment of the present disclosure.

FIG. 12 shows spherical aberration curves, astigmatic field curves and a distortion curve of the imaging apparatus according to the 6th embodiment.

FIG. 13 is a schematic view of an imaging apparatus according to the 7th embodiment of the present disclosure.

FIG. 14 shows spherical aberration curves, astigmatic field curves and a distortion curve of the imaging apparatus according to the 7th embodiment.

FIG. 15 is a schematic view of an imaging apparatus according to the 8th embodiment of the present disclosure.

FIG. 16 shows spherical aberration curves, astigmatic field curves and a distortion curve of the imaging apparatus according to the 8th embodiment.

FIG. 17 is a schematic view of an imaging apparatus according to the 9th embodiment of the present disclosure.

FIG. 18 shows spherical aberration curves, astigmatic field curves and a distortion curve of the imaging apparatus according to the 9th embodiment.

FIG. 19 is a schematic view of an imaging apparatus according to the 10th embodiment of the present disclosure.

FIG. 20 shows spherical aberration curves, astigmatic field curves and a distortion curve of the imaging apparatus according to the 10th embodiment.

FIG. 21 is a schematic view of the inflection points and the critical points of each lens element according to the 1st embodiment.

FIG. 22 is a schematic view of partial parameters according to the 1st embodiment.

FIG. 23 is a schematic view of an imaging apparatus according to the 11th embodiment of the present disclosure.

FIG. 24A is a schematic view of one side of an electronic device according to the 12th embodiment of the present disclosure.

FIG. 24B is a schematic view of another side of the electronic device of FIG. 24A.

FIG. 24C is a system schematic view of the electronic device of FIG. 24A.

FIG. 25 is a schematic view of one side of an electronic device according to the 13th embodiment of the present disclosure.

FIG. 26 is a schematic view of one side of an electronic device according to the 14th embodiment of the present disclosure.

FIG. 27A is a schematic view of one side of an electronic device according to the 15th embodiment of the present disclosure.

FIG. 27B is a schematic view of another side of the electronic device according to the 15th embodiment of FIG. 27A.

FIG. 28A is a schematic view of an arrangement of a light path folding element in the photographing system lens assembly of the present disclosure.

FIG. 28B is a schematic view of another arrangement of the light path folding element in the photographing system lens assembly of the present disclosure.

FIG. 28C is a schematic view of an arrangement of two light path folding elements in the photographing system lens assembly of the present disclosure.

### DETAILED DESCRIPTION

The present disclosure provides a photographing system lens assembly, which includes eight lens elements, the eight lens elements being, in order from an object side to an image side, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side.

The first lens element can have positive refractive power, so that the volume of the photographing system lens assembly can be reduced. The object-side surface of the first lens element can be convex in a paraxial region thereof, so that it is favorable for adjusting the refractive power of the first lens element.

The second lens element can have negative refractive power, so that it is favorable for balancing aberrations generated by the first lens element and correcting chromatic aberration. The image-side surface of the second lens element can be concave in a paraxial region thereof, so that it is favorable for balancing spherical aberration and coma aberration of the photographing system lens assembly.

The image-side surface of the fourth lens element can be convex in a paraxial region thereof, so that it is favorable for enlarging the image surface by adjusting the travelling direction of the light.

The object-side surface of the sixth lens element can be convex in a paraxial region thereof, so that the symmetry of the photographing system lens assembly can be enhanced so as to avoid too much aberration to be generated.

The seventh lens element can have positive refractive power, so that it is favorable for balancing the refractive power of the eighth lens element and controlling the travelling direction of the light. The object-side surface of the seventh lens element can be convex in a paraxial region thereof, so that it is favorable for compressing the volume of the photographing system lens assembly and correcting aberrations by adjusting the surface shape and the refractive power of the seventh lens element.

The eighth lens element can have negative refractive power, so that it is favorable for controlling the back focal length of the photographing system lens assembly effectively so as to avoid excessive total track length thereof. The image-side surface of the eighth lens element can be concave in a paraxial region thereof, so that it is favorable for compressing the back focal length. The image-side surface of the eighth lens element can include at least one inflection point, so that it is favorable for correcting off-axis aberration by adjusting the surface shape of the eighth lens element.

When a focal length of the photographing system lens assembly is f, a focal length of the fifth lens element is f5, a focal length of the sixth lens element is f6, a focal length of the seventh lens element is f7, and a focal length of the eighth lens element is f8, the following condition is satisfied: 0<(|f/f5|+|f/f6|)/(|f/f7|+|f/f8|)<0.50. Therefore, it is favorable for enhancing the light converging ability of the lens element on the image side and reducing the total track length of the photographing system lens assembly. Further, the following condition can be satisfied: 0.01<(|f/f5|+|f/f6|)/(|f/f7|+|f/f8|)<0.40. Furthermore, the following condition can be satisfied: 0.02<(|f/f5|+|f/f6|)/(|f/f7|+|f/f8|)<0.35.

When a sum of central thicknesses of the lens elements of the photographing system lens assembly is ΣCT, and a sum of all axial distances between adjacent lens elements of the photographing system lens assembly is ΣAT, the following condition is satisfied: 2.0<ΣCT/ΣAT<5.0. Therefore, it is favorable for obtaining the balance between the lens element arrangements and the lens thicknesses and distances between the lens elements so as to increase the efficiency of the space utilization. Further, the following condition can be satisfied: 2.1<ΣCT/ΣAT<4.0. Furthermore, the following condition can be satisfied: 2.2<ΣCT/ΣAT<3.5.

When the focal length of the seventh lens element is f7, and the focal length of the eighth lens element is f8, the following condition is satisfied: −10.0<f7/f8<−1.5. Therefore, it is favorable for balancing the back focal length of the photographing system lens assembly by arranging the refractive power so as to satisfy various applications. Further, the following condition can be satisfied: −6.0<f7/f8<−1.8. Furthermore, the following condition can be satisfied: −4.0<f7/f8<−2.0.

When a curvature radius of the image-side surface of the sixth lens element is R12, and a curvature radius of the image-side surface of the eighth lens element is R16, the following condition is satisfied: 0.9<(R12+R16)/(R12−R16)<3.0. Therefore, it is favorable for reducing spherical aberration by adjusting the curvature radius of the image-side surface of the sixth lens element and the curvature radius of the image-side surface of the eighth lens element. Further, the following condition can be satisfied: 1.1<(R12+R16)/(R12−R16)<2.8.

When a curvature radius of the image-side surface of the second lens element is R4, and a curvature radius of the image-side surface of the seventh lens element is R14, the following condition is satisfied: −1.95<(R4+R14)/(R4−R14)<−0.51. Therefore, the image-side surface of the second lens element can obtain stronger refractive ability so as to control the travelling direction of the light path. Further, the following condition can be satisfied: −1.90<(R4+R14)/(R4−R14)<−0.60. Furthermore, the following condition can be satisfied: −1.50<(R4+R14)/(R4−R14)<−0.75.

When a central thickness of the fifth lens element is CT5, a central thickness of the sixth lens element is CT6, and a central thickness of the seventh lens element is CT7, the following condition is satisfied: 0.5<CT5/(CT6+CT7)<1.0. Therefore, it is favorable for balancing the ratio between the central thickness of the fifth lens element and the sum of the central thicknesses of the sixth lens element and the seventh lens element so as to maintain the optimum space arrangement. Further, the following condition can be satisfied: 0.54<CT5/(CT6+CT7)<0.9.

When the curvature radius of the image-side surface of the seventh lens element is R14, and the curvature radius of the image-side surface of the eighth lens element is R16, the following condition is satisfied: 0.16<(R14+R16)/(R14−R16)<2.10. Therefore, it is favorable for balancing the surface shape of the seventh lens element and the eighth lens element effectively so as to improve the light gathering effect on the image center. Further, the following condition can be satisfied: 0.30<(R14+R16)/(R14−R16)<2.00. Furthermore, the following condition can be satisfied: 0.60<(R14+R16)/(R14−R16)<1.80.

When the focal length of the first lens element is f1, and a central thickness of the first lens element is CT1, the following condition is satisfied: 0.1<f1/CT1<10.0. Therefore, it is favorable for balancing the refractive power of and the central thickness of the first lens element so as to obtain the balance between the control of the direction of the light path and the compression of the volume of the photographing system lens assembly. Further, the following condition can be satisfied: 1.0<f1/CT1<8.0. Furthermore, the following condition can be satisfied: 3.0<f1/CT1<7.0.

When a focal length of the first lens element is f1, and a focal length of the second lens element is f2, the following condition is satisfied: 0.30<|f1/f2|<2.0. Therefore, it is favorable for enhancing the arrangement of the refractive power of the first lens element, and balancing aberrations generated from the first lens element by the second lens element. Further, the following condition can be satisfied: 0.35<|f1/f2|<1.5. Furthermore, the following condition can be satisfied: 0.40<|f1/f2|<1.0.

When an axial distance between the object-side surface of the first lens element and the image surface is TL, and an axial distance between the image-side surface of the eighth lens element and the image surface is BL, the following condition is satisfied: 7.5<TL/BL<13.5. Therefore, it is favorable for reducing the back focal length of the photographing system lens assembly so as to control the total track length thereof. Further, the following condition can be satisfied: 8.0<TL/BL<13.0. Furthermore, the following condition can be satisfied: 7.5<TL/BL<11.0.

When the focal length of the photographing system lens assembly is f, a curvature radius of the object-side surface of the fifth lens element is R9, and a curvature radius of the image-side surface of the fifth lens element is R10, the following condition is satisfied: 0.10<|f/R9|+|f/R10|<0.90. Therefore, it is favorable for correcting the image quality by adjusting the surface shape and the refractive power of the fifth lens element. Further, the following condition can be satisfied: 0.20<|f/R9|+|f/R10|<0.80.

When a central thickness of the first lens element is CT1, and a central thickness of the fifth lens element is CT5, the following condition is satisfied: 0.5<CT1/CT5<2.0. Therefore, it is favorable for balancing the ratio between the central thicknesses of the first lens element and the fifth lens element so as to control the volume of the photographing system lens assembly. Further, the following condition can be satisfied: 0.8<CT1/CT5<1.5.

When a central thickness of the fourth lens element is CT4, and an axial distance between the third lens element and the fourth lens element is T34, the following condition is satisfied: 1.1<CT4/T34<5.0. Therefore, it is favorable for obtaining the balance between the assembling error and the manufacturability by adjusting the ratio between the thickness of the fourth lens element and the distance between the third lens element and the fourth lens element. Further, the following condition can be satisfied: 1.5<CT4/T34<4.0.

When an f-number of the photographing system lens assembly is Fno, the following condition is satisfied: 1.0<Fno<2.0. Therefore, it is favorable for obtaining the balance between the illumination and the depth of field, and also increasing the amount of incoming light so as to enhancing the image quality. Further, the following condition can be satisfied: 1.2<Fno<1.9. Furthermore, the following condition can be satisfied: 1.3<Fno<1.8. Moreover, the following condition can be satisfied: 1.4<Fno<1.75.

When the focal length of the photographing system lens assembly is f, and a composite focal length of the sixth lens element and the seventh lens element is f67, the following condition is satisfied: 0.1<f/f67<0.65. Therefore, it is favorable for balancing the arrangement of the refractive power of the sixth lens element and the seventh lens element so as to obtain the balance between the compression of the volume of the photographing system lens assembly and the enhancement of the image quality. Further, the following condition can be satisfied: 0.15<f/f67<0.60.

When the axial distance between the object-side surface of the first lens element and the image surface is TL, and a maximum image height of the photographing system lens assembly is ImgH, the following condition is satisfied: 0.5<TL/ImgH<2.0. Therefore, it is favorable for compressing the total track length of the photographing system lens assembly effectively with the sufficient image size. Further, the following condition can be satisfied: 1.0<TL/ImgH<1.8. Furthermore, the following condition can be satisfied: 1.3<TL/ImgH<1.6.

When a central thickness of the third lens element is CT3, the central thickness of the fourth lens element is CT4, and the central thickness of the fifth lens element is CT5, the following condition is satisfied: 0.05<CT3/(CT4+CT5)<0.45. Therefore, it is favorable for balancing the arrangement of the central thicknesses of the lens element on the middle area so as to achieve the compactness of the photographing system lens assembly. Further, the following condition can be satisfied: 0.10<CT3/(CT4+CT5)<0.40.

When a central thickness of the second lens element is CT2, and a focal length of the second lens element is f2, the following condition is satisfied: −1.0<10×CT2/f2<−0.15. Therefore, the refractive power and the central thickness of the second lens element can be effectively balanced, which is favorable for correcting chromatic aberration and balancing aberrations generated by the first lens element. Further, the following condition can be satisfied: −0.6<10×CT2/f2<−0.18.

When an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the sixth lens element is V6, an Abbe number of the seventh lens element is V7, an Abbe number of the eighth lens element is V8, and a minimum among V1, V2, V3, V4, V5, V6, V7 and V8 is Vmin, the following condition is satisfied: 5.0<Vmin<20.0. Therefore, it is favorable for balancing the light converging ability with different wavelengths and correcting chromatic aberration by adjusting the light path of the photographing system lens assembly. Further, the following condition can be satisfied: 10.0<Vmin<19.8.

When a curvature radius of the object-side surface of the first lens element is R1, and a curvature radius of the object-side surface of the sixth lens element is R11, the following condition is satisfied: −0.2<R1/R11<0.5. Therefore, the shape variation of the object-side surface of the first lens element can be strengthened so as to ensure the light path arrangement can be effectively controlled by the first lens element. Further, the following condition can be satisfied: −0.1<R1/R11<0.4.

When an Abbe number of one of the lens elements is V, and a refractive index of the lens element is N, at least one of the eight lens elements satisfies the following condition: 5.0<V/N<12.0. Therefore, it is favorable for balancing the light with short wavelength to be over-bended so as to enhance the chromatic aberration ability of the photographing system lens assembly. Further, at least two of the eight lens elements satisfy the following condition: 5.0<V/N<12.0.

When the Abbe number of the first lens element is V1, and the Abbe number of the fifth lens element is V5, the following condition is satisfied: 0.6<V5/V1<1.5. Therefore, it is favorable for avoiding overlapped image by effectively correcting the focusing locations of different wavelength. Further, the following condition can be satisfied: 0.8<V5/V1<1.2.

When a distance in parallel with the optical axis between a maximum effective radius position on the object-side surface of the sixth lens element and a maximum effective radius position on the image-side surface of the sixth lens element is ET6, and the central thickness of the sixth lens element is CT6, the following condition is satisfied: 1.15<ET6/CT6<2.5. Therefore, the sixth lens element can obtain greater thickness in the peripheral region thereof so as to enhance peripheral brightness of the image. Further, the following condition can be satisfied: 1.3<ET6/CT6<2.0.

When an axial distance between the seventh lens element and the eighth lens element is T78, a displacement in parallel with the optical axis from an axial vertex on the image-side surface of the seventh lens element to a maximum effective radius position on the image-side surface of the seventh lens element is Sag7R2, and a displacement in parallel with the optical axis from an axial vertex on the object-side surface of the eighth lens element to a maximum effective radius position on the object-side surface of the eighth lens element is Sag8R1, the following condition is satisfied: 0<(T78-Sag7R2+Sag8R1)/T78<0.70. Therefore, the peripheral distance between the seventh lens element and the eighth lens element can be adjusted, so that it is favorable for controlling the incident light on the image from each field of view and also enhancing the illumination of peripheral area of the image. Further, the following condition can be satisfied: 0.15<(T78-Sag7R2+Sag8R1)/T78<0.60.

When a displacement in parallel with the optical axis from an axial vertex on the object-side surface of the seventh lens element to a maximum effective radius position on the object-side surface of the seventh lens element is Sag7R1, and the central thickness of the seventh lens element is CT7, the following condition is satisfied: 0<|Sag7R1|/CT7<0.60. Therefore, it is favorable for balancing the distortion of the surface shape in the peripheral region of the object-side surface of the seventh lens element so as to moderate the refractive angle of light. Further, the following condition can be satisfied: 0.2<|Sag7R1|/CT7<0.58.

When the focal length of the photographing system lens assembly is f, a focal length of the fourth lens element is f4, the focal length of the fifth lens element is f5, and the focal length of the sixth lens element is f6, the following condition is satisfied: 0.10<|f/f4|+|f/f5|+|f/f6|<0.70. Therefore, the direction of the light paths from different field of view can be adjusted by balancing the arrangement of the refractive power of the lens elements on the middle area of the photographing system lens assembly, so that it can be more flexible to design. Further, the following condition can be satisfied: 0.15<|f/f4|+|f/f5|+|f/f6|<0.45.

When the focal length of the second lens element is f2, and the focal length of the sixth lens element is f6, the following condition is satisfied: 0<|f2/f6|<1.2. Therefore, it is favorable for increasing the symmetry of the photographing system lens assembly and reducing the light spots on the central field of view by balancing the refractive power of the second lens element and the sixth lens element. Further, the following condition can be satisfied: 0.02<|f2/f6|<1.0.

When the focal length of the photographing system lens assembly is f, and the axial distance between the object-side surface of the first lens element and the image surface is TL, the following condition is satisfied: 0.5<TL/f<2.0. Therefore, it is favorable for obtaining the balance between the total track length and the field of view. Further, the following condition can be satisfied: 0.8<TL/f<1.8. Furthermore, the following condition can be satisfied: 1.0<TL/f<1.6.

When a curvature radius of the object-side surface of the seventh lens element is R13, and the curvature radius of the image-side surface of the seventh lens element is R14, the following condition is satisfied: −1.5<(R13+R14)/(R13−R14)<0. Therefore, it is favorable for enhancing the image quality of the center by adjusting the curvature radii of the object-side surface and the image-side surface of the seventh lens element. Further, the following condition can be satisfied: −1.4<(R13+R14)/(R13−R14)<−0.3. Furthermore, the following condition can be satisfied: −1.2<(R13+R14)/(R13−R14)<−0.5.

When an axial distance between the sixth lens element and the seventh lens element is T67, and the axial distance between the seventh lens element and the eighth lens element is T78, the following condition is satisfied: 0<T67/T78<0.40. Therefore, it can be more flexible to design by obtain enough space for the seventh lens element and the eighth lens element. Further, the following condition can be satisfied: 0.02<T67/T78<0.30.

When the focal length of the photographing system lens assembly is f, the curvature radius of the object-side surface of the seventh lens element is R13, and the curvature radius of the image-side surface of the seventh lens element is R14, the following condition is satisfied: 0.1<|f/R13|+|f/R14|<2.0. Therefore, it is favorable for effectively controlling the strength of the refractive power of the seventh lens element so as to obtain sufficient field of view. Further, the following condition can be satisfied: 0.5<|f/R13|+|f/R14|<1.85.

When the focal length of the first lens element is f1, and a curvature radius of the image-side surface of the first lens element is R2, the following condition is satisfied: 0.1<f1/R21<0.50. Therefore, it is favorable for correcting aberrations of the photographing system lens assembly and reducing the stray light inside the lens element by effectively balancing the refractive power and the surface shape of the lens element. Further, the following condition can be satisfied: 0.15<f1/R21<0.45.

When the Abbe number of the first lens element is V1, the Abbe number of the second lens element is V2, the Abbe number of the third lens element is V3, the Abbe number of the fourth lens element is V4, the Abbe number of the fifth lens element is V5, the Abbe number of the sixth lens element is V6, the Abbe number of the seventh lens element is V7, and the Abbe number of the eighth lens element is V8, the following condition is satisfied: 5.0<Vi<20.0, wherein i is at least one of 1, 2, 3, 4, 5, 6, 7, 8. Therefore, it is favorable for correcting chromatic aberration generated by the photographing system lens assembly and also enhancing the image quality. Further, the following condition can be satisfied: 5.0<Vi<20.0, wherein i is each of at least two of 1, 2, 3, 4, 5, 6, 7, 8. Furthermore, the following condition can be satisfied: 5.0<Vi<20.0, wherein i is each of at least three of 1, 2, 3, 4, 5, 6, 7, 8.

When the Abbe number of the fourth lens element is V4, and the Abbe number of the sixth lens element is V6, the following condition is satisfied: 20.0<V4+V6<45.0. Therefore, it is favorable for correcting chromatic aberration by adjusting the arrangement of the lens material. Further, the following condition can be satisfied: 30.0<V4+V6<42.0. Furthermore, the following condition can be satisfied: 35.0<V4+V6<40.0.

When half of a maximum field of view of the photographing system lens assembly is HFOV, the following condition is satisfied: 30.0 degrees<HFOV<50.0 degrees. Therefore, it is favorable for obtaining sufficient imaging range of the photographing system lens assembly so as to satisfy the requirement the field of view of the applied device. Further, the following condition can be satisfied: 35.0 degrees<HFOV<45.0 degrees.

When a focal length of the third lens element is f3, and the focal length of the seventh lens element is f7, the following condition is satisfied: −6.0<f3/f7<3.2. Therefore, it is favorable for balancing the arrangement of the refractive power of the lens elements on the object side and the image side so as to enhance the image quality. Further, the following condition can be satisfied: −4.0<f3/f7<3.0. Furthermore, the following condition can be satisfied: −1.0<f3/f7<2.8.

When the curvature radius of the image-side surface of the eighth lens element is R16, and the central thickness of the fourth lens element is CT4, the following condition is satisfied: 2.9<R16/CT4<8.0. Therefore, it is favorable for reducing the total track length of the photographing system lens assembly and also maintaining the rate of the space utilization by effectively controlling the back focal length thereof. Further, the following condition can be satisfied: 3.5<R16/CT4<7.0.

Each of the aforementioned features of the photographing system lens assembly can be utilized in various combinations for achieving the corresponding effects.

According to the photographing system lens assembly of the present disclosure, the lens elements thereof can be made of glass or plastic materials. When the lens elements are made of glass materials, the distribution of the refractive power of the photographing system lens assembly may be more flexible to design. The glass lens element can either be made by grinding or molding. When the lens elements are made of plastic materials, manufacturing costs can be effectively reduced. Furthermore, surfaces of each lens element can be arranged to be aspheric (ASP), since the aspheric surface of the lens element is easy to form a shape other than a spherical surface so as to have more controllable variables for eliminating aberrations thereof, and to further decrease the required amount of lens elements in the photographing system lens assembly. Therefore, the total track length of the photographing system lens assembly can also be reduced. The aspheric surfaces may be formed by a plastic injection molding method, a glass molding method or other manufacturing methods.

According to the photographing system lens assembly of the present disclosure, additives can be selectively added into any one (or more) material of the lens elements so as to change the transmittance of the lens element in a particular wavelength range. Therefore, the stray light and chromatic aberration can be reduced. For example, the additives can have the absorption ability for light in a wavelength range of 600 nm-800 nm in the photographing system lens assembly so as to reduce extra red light or infrared light, or the additives can have the absorption ability for light in a wavelength range of 350 nm-450 nm in the photographing system lens assembly so as to reduce blue light or ultraviolet light. Therefore, additives can prevent the image from interfering by light in a particular wavelength range. Furthermore, the additives can be homogeneously mixed with the plastic material, and the lens elements can be made by the injection molding method. Moreover, the additives can be coated on the lens surfaces to provide the aforementioned effects.

According to the photographing system lens assembly of the present disclosure, when a surface of the lens element is aspheric, it indicates that entire optical effective region of the surface of the lens element or a part thereof is aspheric.

According to the photographing system lens assembly of the present disclosure, when the lens elements have surfaces being convex and the convex surface position is not defined, it indicates that the aforementioned surfaces of the lens elements can be convex in the paraxial region thereof. When the lens elements have surfaces being concave and the concave surface position is not been defined, it indicates that the aforementioned surfaces of the lens elements can be concave in the paraxial region thereof. In the photographing system lens assembly of the present disclosure, if the lens element has positive refractive power or negative refractive power, or the focal length of the lens element, all can be referred to the refractive power, or the focal length, in the paraxial region of the lens element.

According to the photographing system lens assembly of the present disclosure, a critical point is a non-axial point of the lens surface where its tangent is perpendicular to the optical axis; an inflection point is a point on a lens surface with a curvature changing from positive to negative or from negative to positive.

According to the photographing system lens assembly of the present disclosure, the image surface thereof, based on the corresponding image sensor, can be flat or curved. In particular, the image surface can be a concave curved surface facing towards the object side. Furthermore, the photographing system lens assembly of the present disclosure can selectively include at least one image correcting element (such as a field flattener) inserted between the lens element closest to the image surface and the image surface, thus the effect of correcting image aberrations (such as field curvature) can be achieved. The optical properties of the aforementioned image correcting element, such as curvature, thickness, refractive index, position, surface shape (convex or concave, spherical or aspheric, diffraction surface and Fresnel surface, etc.) can be adjusted corresponding to the demands of the imaging apparatus. Generally, a preferred configuration of the image correcting element is to dispose a thin piano-concave element having a concave surface toward the object side on the position closed to the image surface.

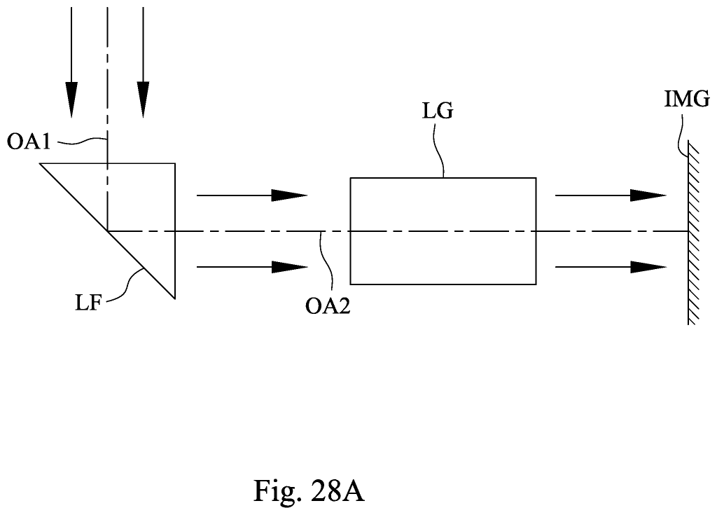

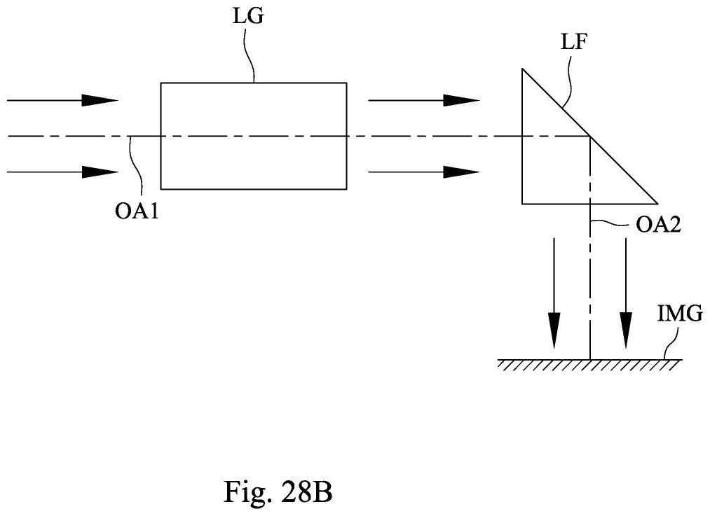

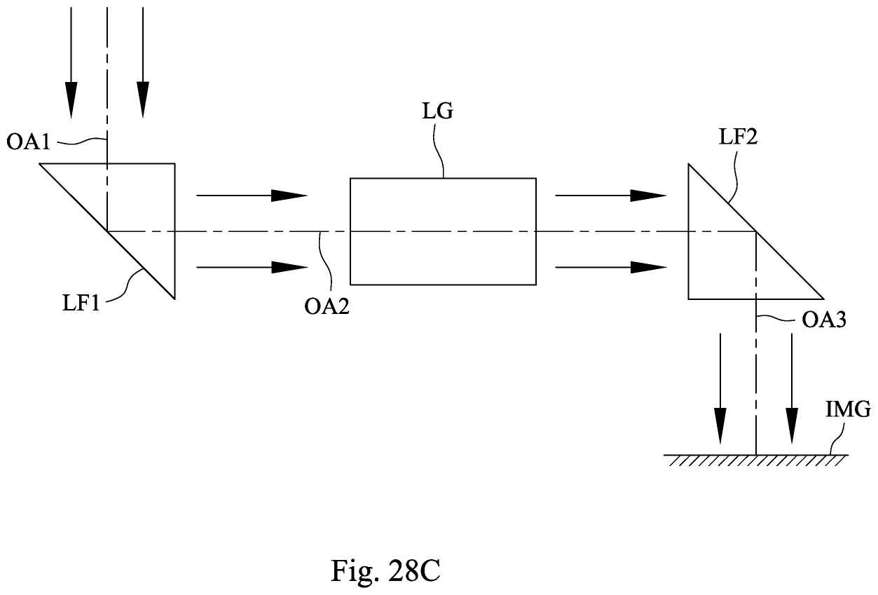

According to the photographing system lens assembly of the present disclosure, at least one element with light path folding function can be selectively disposed between the imaged object and the image surface, such as a prism or a mirror, etc. Therefore it is favorable for providing high flexible space arrangement of the photographing system lens assembly, so that the compactness of the electronic device would not be restricted by the optical total track length of the photographing system lens assembly. FIG. 28A is a schematic view of an arrangement of a light path folding element LF in the photographing system lens assembly of the present disclosure. FIG. 28B is a schematic view of another arrangement of the light path folding element LF in the photographing system lens assembly of the present disclosure. As shown in FIGS. 28A and 28B, the photographing system lens assembly includes, in order from an imaged object (not shown in drawings) to an image surface IMG, a first optical axis OA1, the light path folding element LF and a second optical axis OA2, wherein the light path folding element LF can be disposed between the imaged object and a lens group LG of the photographing system lens assembly as shown in FIG. 28A, or can be disposed between the lens group LG of the photographing system lens assembly and the image surface IMG as shown in FIG. 28B. Moreover, FIG. 28C is a schematic view of an arrangement of two light path folding elements LF1, LF2 in the photographing system lens assembly of the present disclosure. As shown in FIG. 28C, the photographing system lens assembly includes, in order from an imaged object (not shown in drawings) to an image surface IMG, a first optical axis OA1, the light path folding element LF1, a second optical axis OA2, the light path folding element LF2 and a third optical axis OA3, wherein the light path folding element LF1 is disposed between the imaged object and a lens group LG of the photographing system lens assembly, and the light path folding element LF2 is disposed between the lens group LG of the photographing system lens assembly and the image surface IMG. The photographing system lens assembly can also be selectively disposed with three or more light path folding element, the type, amount and location of the light path folding element will not be limited to the present disclosure.

Furthermore, according to the photographing system lens assembly of the present disclosure, the photographing system lens assembly can include at least one stop, such as an aperture stop, a glare stop or a field stop, for eliminating stray light and thereby improving image resolution thereof.

According to the photographing system lens assembly of the present disclosure, the aperture stop can be configured as a front stop or a middle stop, wherein the front stop indicates that the aperture stop is disposed between an object and the first lens element, and the middle stop indicates that the aperture stop is disposed between the first lens element and the image surface. When the aperture stop is a front stop, a longer distance between an exit pupil of the photographing system lens assembly and the image surface can be obtained, and thereby obtains a telecentric effect and improves the image-sensing efficiency of the image sensor, such as CCD or CMOS. The middle stop is favorable for enlarging the field of view of the photographing system lens assembly and thereby provides a wider field of view for the same.

According to the photographing system lens assembly of the present disclosure, an aperture control unit can be properly configured. The aperture control unit can be a mechanical element or a light controlling element, and the dimension and the shape of the aperture control unit can be electrically controlled. The mechanical element can include a moveable component such a blade group or a shielding plate. The light controlling element can include a screen component such as a light filter, an electrochromic material, a liquid crystal layer or the like. The amount of incoming light or the exposure time of the image can be controlled by the aperture control unit to enhance the image moderation ability. In addition, the aperture control unit can be the aperture stop of the photographing system lens assembly according to the present disclosure, so as to moderate the image quality by changing f-number such as changing the depth of field or the exposure speed.

The photographing system lens assembly according to the present disclosure can include at least one optical lens element, an optical element or a carrier. A low reflection layer is disposed on at least one surface of at least one optical lens element, the optical element or the carrier, wherein the low reflection layer is favorable for effectively reducing the stray light formed by the reflection of light on the interface. The low reflection layer can be disposed on the non-optically effective area of the object-side surface or the image-side surface of the optical lens element, or can be disposed on the connecting surface between the object-side surface or the image-side surface; wherein the optical element can be at least one of a light blocking element, an annular spacer element, a barrel element, a cover glass, a blue glass, a filter or a color filter, a light path folding element, a prism or a mirror, etc.; wherein the carrier can be a lens group lens mount, a micro lens disposed on the image sensor, the peripheral of the image sensor substrate or a glass sheet for protecting the image sensor, etc.

According to the photographing system lens assembly of the present disclosure, the photographing system lens assembly of the present disclosure can be applied to 3D (three-dimensional) image capturing applications, in products such as digital cameras, mobile devices, digital tablets, smart TVs, surveillance systems, motion sensing input devices, driving recording systems, rearview camera systems, wearable devices, unmanned aerial vehicles, and other electronic imaging products.

According to the present disclosure, an imaging apparatus including the aforementioned photographing system lens assembly and an image sensor is provided, wherein the image sensor is disposed on the image surface of the photographing system lens assembly. By the arrangement of the refractive power, thicknesses and distributions of the lens elements in the photographing system lens assembly, the light converging ability of the lens element on the image side can be enhanced, the total track length of the photographing system lens assembly can be reduced, and the efficiency of the space utilization can be increased. Moreover, the imaging apparatus can further include a barrel member, a holder member or a combination thereof.

According to the present disclosure, an electronic device including the aforementioned imaging apparatus is provided. Therefore, the image quality can be increased. Moreover, the electronic device can further include a control unit, a display, a storage unit, a random-access memory unit (RAM) or a combination thereof.

According to the above description of the present disclosure, the following specific embodiments are provided for further explanation.

### 1st Embodiment

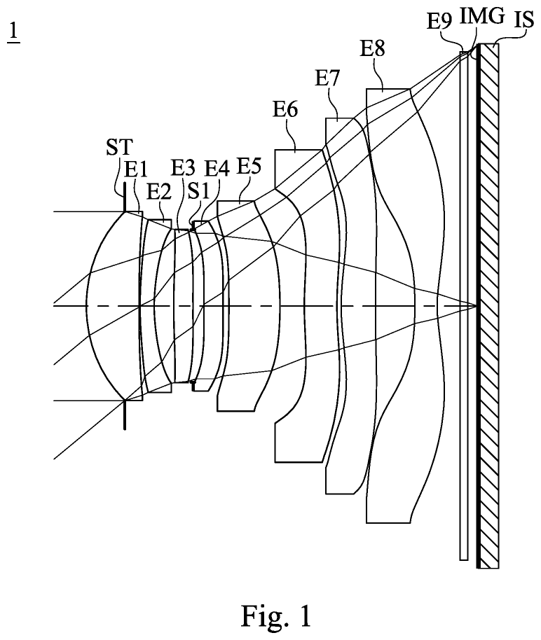

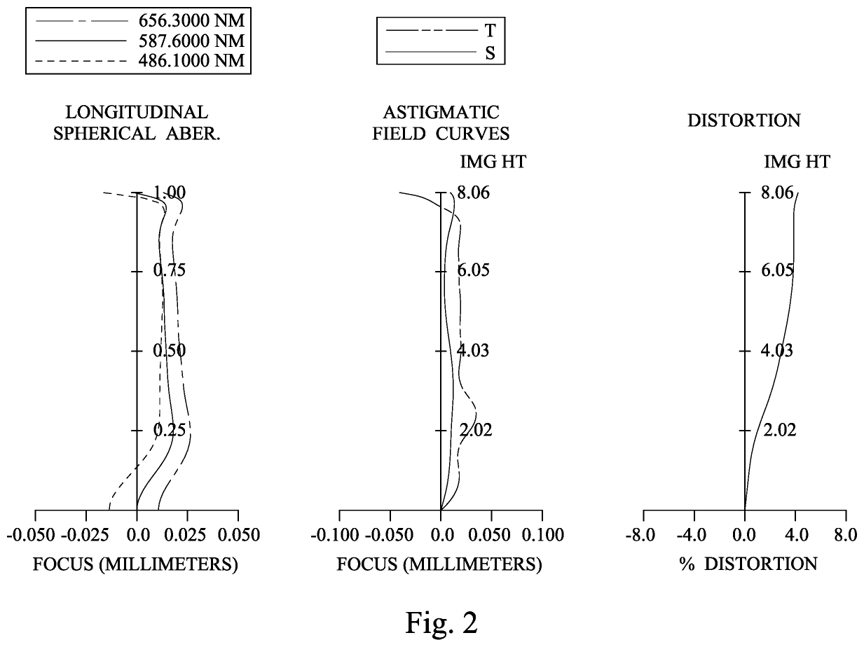

FIG. 1 is a schematic view of an imaging apparatus 1 according to the 1st embodiment of the present disclosure. FIG. 2 shows spherical aberration curves, astigmatic field curves and a distortion curve of the imaging apparatus 1 according to the 1st embodiment. In FIG. 1, the imaging apparatus 1 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

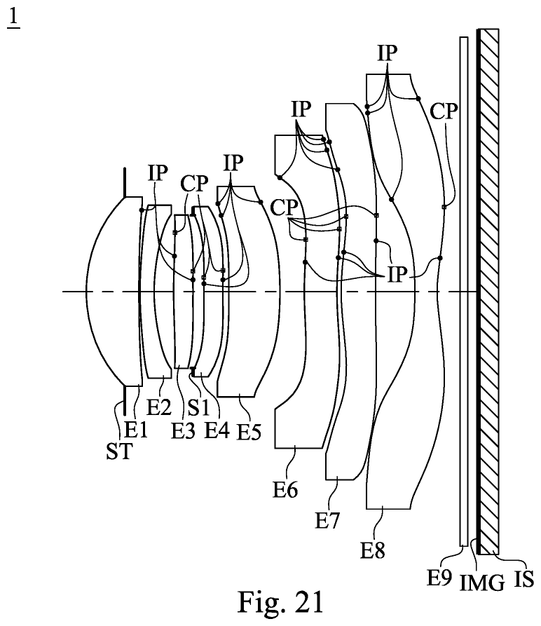

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, FIG. 21 is a schematic view of the inflection points IP and the critical points CP of each lens element according to the 1st embodiment. In FIG. 21, the image-side surface of the first lens element E1 includes one inflection point IP.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point IP (as shown in FIG. 21) and one critical point CP (as shown in FIG. 21), and the image-side surface of the third lens element E3 includes one inflection point IP (as shown in FIG. 21) and one critical point CP (as shown in FIG. 21).

The fourth lens element E4 with negative refractive power has an object-side surface being convex in a paraxial region thereof and an image-side surface being concave in a paraxial region thereof. The fourth lens element E4 is made of a plastic material, and has the object-side surface and the image-side surface being both aspheric. Furthermore, the object-side surface of the fourth lens element E4 includes one inflection point IP (as shown in FIG. 21) and one critical point CP (as shown in FIG. 21), and the image-side surface of the fourth lens element E4 includes one inflection point IP (as shown in FIG. 21) and one critical point CP (as shown in FIG. 21).

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the object-side surface of the fifth lens element E5 includes two inflection points IP (as shown in FIG. 21), and the image-side surface of the fifth lens element E5 includes one inflection point IP (as shown in FIG. 21).

The sixth lens element E6 with positive refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points IP (as shown in FIG. 21) and one critical point CP (as shown in FIG. 21), and the image-side surface of the sixth lens element E6 includes three inflection points IP (as shown in FIG. 21) and one critical point CP (as shown in FIG. 21).

The seventh lens element E7 with positive refractive power has an object-side surface being convex in a paraxial region thereof and an image-side surface being concave in a paraxial region thereof. The seventh lens element E7 is made of a plastic material, and has the object-side surface and the image-side surface being both aspheric. Furthermore, the object-side surface of the seventh lens element E7 includes three inflection points IP (as shown in FIG. 21) and one critical point CP (as shown in FIG. 21), and the image-side surface of the seventh lens element E7 includes one inflection point IP (as shown in FIG. 21) and one critical point CP (as shown in FIG. 21).

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes three inflection points IP (as shown in FIG. 21), and the image-side surface of the eighth lens element E8 includes two inflection points IP (as shown in FIG. 21) and one critical point CP (as shown in FIG. 21).

The filter E9 is made of a glass material, which is located between the eighth lens element E8 and the image surface IMG in order, and will not affect the focal length of the photographing system lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from the intersection point of the aspheric surface and the optical axis to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient.

In the photographing system lens assembly according to the 1st embodiment, when a focal length of the photographing system lens assembly is f, an f-number of the photographing system lens assembly is Fno, and half of a maximum field of view of the photographing system lens assembly is HFOV, these parameters have the following values: f=9.31 mm; Fno=1.60; and HFOV=41.1 degrees.

In the photographing system lens assembly according to the 1st embodiment, when an axial distance between the object-side surface of the first lens element E1 and the image surface IMG is TL, a maximum image height of the photographing system lens assembly is ImgH, the focal length of the photographing system lens assembly is f, and an axial distance between the image-side surface of the eighth lens element E8 and the image surface IMG is BL, the following conditions are satisfied: TL/ImgH=1.50; TL/f=1.30; and TL/BL=9.50.

In the photographing system lens assembly according to the 1 st embodiment, when a focal length of the first lens element E1 is f1, a focal length of the second lens element E2 is f2, and a focal length of the sixth lens element E6 is f6, the following conditions are satisfied: |f1/f2|=0.46; and |f2/f6|=0.07.

In the photographing system lens assembly according to the 1 st embodiment, when a focal length of the third lens element E3 is f3, a focal length of the seventh lens element E7 is f7, a focal length of the eighth lens element E8 is f8, the following conditions are satisfied: f3/f7=2.47; and f7/f8=−3.04.

In the photographing system lens assembly according to the 1st embodiment, when the focal length of the photographing system lens assembly is f, and a composite focal length of the sixth lens element E6 and the seventh lens element E7 is f67, the following condition is satisfied: f/f67=0.50.

In the photographing system lens assembly according to the 1st embodiment, when the focal length of the photographing system lens assembly is f, a focal length of the fourth lens element E4 is f4, the focal length of the fifth lens element E5 is f5, and the focal length of the sixth lens element E6 is f6, the following condition is satisfied: |f/f4|+|f/f5|+|f/f6|=0.48.

In the photographing system lens assembly according to the 1 st embodiment, when the focal length of the photographing system lens assembly is f, the focal length of the fifth lens element E5 is f5, the focal length of the sixth lens element E6 is f6, the focal length of the seventh lens element E7 is f7, and the focal length of the eighth lens element E8 is f8, the following condition is satisfied: (|f/f5|+|f/f6|)/(|f/f7|+|f/f8|)=0.20.

In the photographing system lens assembly according to the 1 st embodiment, when the focal length of the photographing system lens assembly is f, a curvature radius of the object-side surface of the fifth lens element E5 is R9, and a curvature radius of the image-side surface of the fifth lens element E5 is R10, the following condition is satisfied: |f/R9|+|f/R10|=0.70.

In the photographing system lens assembly according to the 1st embodiment, when the focal length of the photographing system lens assembly is f, a curvature radius of the object-side surface of the seventh lens element E7 is R13, and a curvature radius of the image-side surface of the seventh lens element E7 is R14, the following condition is satisfied: |f/R13|+|f/R14|=0.91.

In the photographing system lens assembly according to the 1 st embodiment, when the focal length of the first lens element E1 is f1, and a curvature radius of the image-side surface of the first lens element E1 is R2, the following condition is satisfied: f1/|R2|=0.20.

In the photographing system lens assembly according to the 1st embodiment, when the focal length of the first lens element E1 is f1, and a central thickness of the first lens element E1 is CT1, the following condition is satisfied: f1/CT1=5.49.

In the photographing system lens assembly according to the 1st embodiment, when a central thickness of the second lens element E2 is CT2, and the focal length of the second lens element E2 is f2, the following condition is satisfied: 10×CT2/f2=−0.22.

In the photographing system lens assembly according to the 1st embodiment, when a curvature radius of the object-side surface of the first lens element E1 is R1, and a curvature radius of the object-side surface of the sixth lens element E6 is R11, the following condition is satisfied: R1/R11=0.34.

In the photographing system lens assembly according to the 1st embodiment, when a curvature radius of the image-side surface of the second lens element E2 is R4, the curvature radius of the object-side surface of the seventh lens element E7 is R13, and the curvature radius of the image-side surface of the seventh lens element E7 is R14, the following conditions are satisfied: (R4+R14)/(R4−R14)=−1.04; and (R13+R14)/(R13−R14)=−1.08.

In the photographing system lens assembly according to the 1st embodiment, when a curvature radius of the image-side surface of the sixth lens element E6 is R12, the curvature radius of the image-side surface of the seventh lens element E7 is R14, and a curvature radius of the image-side surface of the eighth lens element E8 is R16, the following conditions are satisfied: (R12+R16)/(R12−R16)=2.04; and (R14+R16)/(R14−R16)=1.03.

In the photographing system lens assembly according to the 1 st embodiment, when the curvature radius of the image-side surface of the eighth lens element E8 is R16, a central thickness of the fourth lens element E4 is CT4, the following conditions is satisfied: R16/CT4=7.85.

In the photographing system lens assembly according to the 1st embodiment, when a central thickness of the first lens element E1 is CT1, and a central thickness of the fifth lens element E5 is CT5, the following condition is satisfied: CT1/CT5=1.03.

In the photographing system lens assembly according to the 1 st embodiment, when the central thickness of the fourth lens element E4 is CT4, and an axial distance between the third lens element E3 and the fourth lens element E4 is T34, the following condition is satisfied: CT4/T34=1.72.

In the photographing system lens assembly according to the 1st embodiment, when a central thickness of the third lens element E3 is CT3, the central thickness of the fourth lens element E4 is CT4, and the central thickness of the fifth lens element E5 is CT5, the following condition is satisfied: CT3/(CT4+CT5)=0.28.

In the photographing system lens assembly according to the 1st embodiment, when the central thickness of the fifth lens element E5 is CT5, a central thickness of the sixth lens element E6 is CT6, and a central thickness of the seventh lens element E7 is CT7, the following condition is satisfied: CT5/(CT6+CT7)=0.76.

$$CT 5 / ( CT 6 + CT 7 ) = 0.76 .$$

In the photographing system lens assembly according to the 1st embodiment, when an axial distance between the sixth lens element E6 and the seventh lens element E7 is T67, and an axial distance between the seventh lens element E7 and the eighth lens element E8 is T78, the following condition is satisfied: T67/T78=0.11.

In the photographing system lens assembly according to the 1st embodiment, when the central thickness of the first lens element E1 is CT1, a central thickness of the second lens element E2 is CT2, the central thickness of the third lens element E3 is CT3, the central thickness of the fourth lens element E4 is CT4, the central thickness of the fifth lens element E5 is CT5, the central thickness of the sixth lens element E6 is CT6, the central thickness of the seventh lens element E7 is CT7, a central thickness of the eighth lens element E8 is CT8, a sum of central thicknesses of the lens elements of the photographing system lens assembly is ΣCT, an axial distance between the first lens element E1 and the second lens element E2 is T12, an axial distance between the second lens element E2 and the third lens element E3 is T23, an axial distance between the third lens element E3 and the fourth lens element E4 is T34, an axial distance between the fourth lens element E4 and the fifth lens element E5 is T45, an axial distance between the fifth lens element E5 and the sixth lens element E6 is T56, the axial distance between the sixth lens element E6 and the seventh lens element E7 is T67, the axial distance between the seventh lens element E7 and the eighth lens element E8 is T78, and a sum of all axial distances between adjacent lens elements of the photographing system lens assembly is ΣAT, the following condition is satisfied: ΣCT/ΣAT=2.33. In the 1st embodiment, an axial distance between two adjacent lens elements indicates a distance along the optical axis between two adjacent lens surfaces of the adjacent lens elements; ΣCT=CT1+CT2+CT3+CT4+CT5+CT6+CT7+CT8; ΣAT=T12+T23+T34+T45+T56+T67+T78.

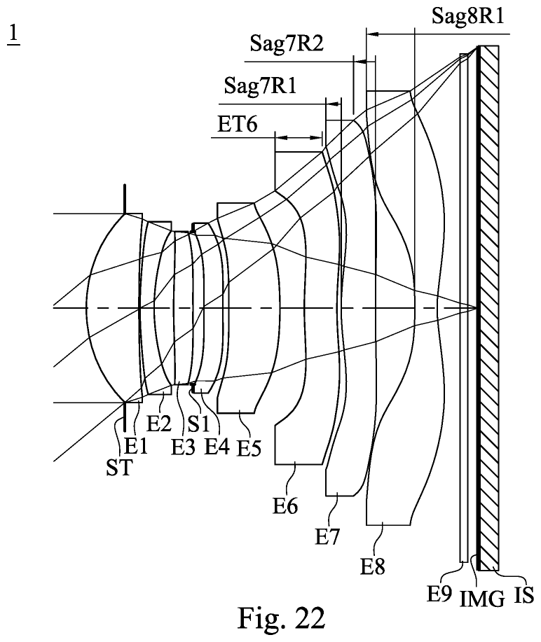

FIG. 22 is a schematic view of partial parameters according to the 1st embodiment. In the photographing system lens assembly according to the 1st embodiment, a distance in parallel with an optical axis between a maximum effective radius position on the object-side surface of the sixth lens element E6 and a maximum effective radius position on the image-side surface of the sixth lens element E6 is ET6 (as shown in FIG. 22), and the central thickness of the sixth lens element E6 is CT6, the following condition is satisfied: ET6/CT6=1.45.

In the photographing system lens assembly according to the 1st embodiment, when a displacement in parallel with the optical axis from an axial vertex on the object-side surface of the seventh lens element E7 to a maximum effective radius position on the object-side surface of the seventh lens element E7 is Sag7R1 (as shown in FIG. 22), the central thickness of the seventh lens element E7 is CT7, the following condition is satisfied: |Sag7R1|/CT7=0.45. It should be mentioned that when Sag7R1 points towards the object side, it is negative value; when Sag7R1 points towards the image side, it is positive value. In FIG. 22, according to the 1st embodiment, Sag7R1 is negative value.

In the photographing system lens assembly according to the 1 st embodiment, when the axial distance between the seventh lens element E7 and the eighth lens element E8 is T78, a displacement in parallel with the optical axis from an axial vertex on the image-side surface of the seventh lens element E7 to a maximum effective radius position on the image-side surface of the seventh lens element E7 is Sag7R2 (as shown in FIG. 22), and a displacement in parallel with the optical axis from an axial vertex on the object-side surface of the eighth lens element E8 to a maximum effective radius position on the object-side surface of the eighth lens element E8 is Sag8R1 (as shown in FIG. 22), the following condition is satisfied: (T78-Sag7R2+Sag8R1)/T78=0.32. It should be mentioned that when Sag7R2 points towards the object side, it is negative value; when Sag7R2 points towards the image side, it is positive value; when Sag8R1 points towards the object side, it is negative value; when Sag8R1 points towards the image side, it is positive value. In FIG. 22, according to the 1st embodiment, Sag7R2 is negative value, and Sag81 is negative value.

In the photographing system lens assembly according to the 1 st embodiment, when an Abbe number of the fourth lens element E4 is V4, and an Abbe number of the sixth lens element E6 is V6, the following condition is satisfied: V4+V6=39.0.

In the photographing system lens assembly according to the 1 st embodiment, when an Abbe number of the first lens element E1 is V1, and an Abbe number of the fifth lens element E5 is V5, the following condition is satisfied: V5/V1=1.0.

In the photographing system lens assembly according to the 1 st embodiment, when the Abbe number of the first lens element E1 is V1, an Abbe number of the second lens element E2 is V2, an Abbe number of the third lens element E3 is V3, the Abbe number of the fourth lens element E4 is V4, the Abbe number of the fifth lens element E5 is V5, an Abbe number of the sixth lens element E6 is V6, an Abbe number of the seventh lens element E7 is V7, an Abbe number of the eighth lens element E8 is V8, and a minimum among V1, V2, V3, V4, V5, V6, V7 and V8 is Vmin, the following condition is satisfied: Vmin=19.5.

In the photographing system lens assembly according to the 1st embodiment, when the Abbe number of the first lens element E1 is V1, the Abbe number of the second lens element E2 is V2, the Abbe number of the third lens element E3 is V3, the Abbe number of the fourth lens element E4 is V4, the Abbe number of the fifth lens element E5 is V5, the Abbe number of the sixth lens element E6 is V6, the Abbe number of the seventh lens element E7 is V7, the Abbe number of the eighth lens element E8 is V8, a refractive index of the first lens element E1 is N1, a refractive index of the second lens element E2 is N2, a refractive index of the third lens element E3 is N3, a refractive index of the fourth lens element E4 is N4, a refractive index of the fifth lens element E5 is N5, a refractive index of the sixth lens element E6 is N6, a refractive index of the seventh lens element E7 is N7, a refractive index of the eighth lens element E8 is N8, the following conditions are satisfied: V1/N1=36.5; V2/N2=12.3; V3/N3=36.3; V4/N4=11.7; V5/N5=36.5; V6/N6=11.7; V7/N7=23.9; and V8/N8=17.8.

The detailed optical data of the 1st embodiment are shown in Table 1A and the aspheric surface data are shown in Table 1B below.

TABLE 1A
1st Embodiment
f = 9.31 mm, Fno = 1.60, HFOV = 41.1 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.183 | | | | |
| 2 | Lens 1 | 4.3528 | ASP | 1.621 | Plastic | 1.534 | 56.0 | 8.90 |
| 3 | | 44.8281 | ASP | 0.030 | | | | |
| 4 | Lens 2 | 10.3809 | ASP | 0.436 | Plastic | 1.660 | 20.4 | −19.49 |
| 5 | | 5.6492 | ASP | 0.601 | | | | |
| 6 | Lens 3 | 22.2608 | ASP | 0.594 | Plastic | 1.544 | 56.0 | 48.12 |
| 7 | | 147.3114 | ASP | −0.004 | | | | |
| 8 | Stop | Plano | | 0.342 | | | | |
| 9 | Lens 4 | 112.5838 | ASP | 0.583 | Plastic | 1.669 | 19.5 | −87.59 |
| 10 | | 38.4615 | ASP | 0.183 | | | | |
| 11 | Lens 5 | −329.6141 | ASP | 1.571 | Plastic | 1.534 | 56.0 | 27.12 |
| 12 | | −13.9024 | ASP | 0.751 | | | | |
| 13 | Lens 6 | 12.8524 | ASP | 1.003 | Plastic | 1.669 | 19.5 | 271.99 |
| 14 | | 13.3965 | ASP | 0.135 | | | | |
| 15 | Lens 7 | 10.6249 | ASP | 1.053 | Plastic | 1.566 | 37.4 | 19.48 |
| 16 | | 280.4576 | ASP | 1.205 | | | | |
| 17 | Lens 8 | −22.3837 | ASP | 0.690 | Plastic | 1.587 | 28.3 | −6.41 |
| 18 | | 4.5756 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.330 | | | | |
| 21 | Image | Plano | — | | | | |

Reference wavelength is 587.6 nm (d-line).
Effective radius of Surface 8 (stop S1) is 2.350 mm

TABLE 1B
Aspheric Coefficients

| Surface # | 2 | 3 | 4 | 5 |
|---|---|---|---|---|
| k= | 4.15863000E−02 | 4.17463000E+01 | 3.58108000E+00 | −3.62439000E+00 |
| A4= | 4.06158955E−04 | −5.21685529E−03 | −1.11193634E−02 | −3.08344169E−03 |
| A6= | 1.40624219E−04 | 5.41140532E−03 | 5.16472116E−03 | −3.33717533E−04 |
| A8= | −7.96131643E−05 | −3.29894304E−03 | −2.87150630E−03 | 1.43756660E−03 |
| A10= | 3.87243150E−05 | 1.40940567E−03 | 1.27504335E−03 | −1.30353367E−03 |
| A12= | −1.07267667E−05 | −4.16819126E−04 | −3.96379772E−04 | 7.52893284E−04 |
| A14= | 1.76497874E−06 | 8.43173042E−05 | 8.51335422E−05 | −2.78066993E−04 |
| A16= | −1.52887112E−07 | −1.14213053E−05 | −1.23576467E−05 | 6.61950078E−05 |
| A18= | 3.27500784E−09 | 9.89973905E−07 | 1.16126963E−06 | −9.81421472E−06 |
| A20= | 4.48684110E−10 | −4.96721125E−08 | −6.41197970E−08 | 8.26819476E−07 |
| A22= | −2.60996434E−11 | 1.09728979E−09 | 1.58522349E−09 | −3.03145041E−08 |
| Surface # | 6 | 7 | 9 | 10 |
| k= | 1.15497000E+00 | −4.96110000E+01 | 9.90000000E+01 | −6.93532000E+01 |
| A4= | −9.64922806E−04 | −4.25186182E−03 | −1.25974837E−02 | −1.70921834E−02 |
| A6= | −1.27526485E−03 | 1.42599422E−04 | 3.53971708E−03 | 4.46924970E−03 |
| A8= | 9.17367970E−04 | −6.99821317E−04 | −3.45915227E−03 | −2.78573981E−03 |
| A10= | −8.76033341E−04 | 4.53929277E−04 | 2.31679683E−03 | 1.41364944E−03 |
| A12= | 5.28626138E−04 | −2.26976682E−04 | −1.09957713E−03 | −5.61974174E−04 |
| A14= | −2.00417800E−04 | 8.46728792E−05 | 3.54862077E−04 | 1.60002702E−04 |
| A16= | 4.90080460E−05 | −2.05919898E−05 | −7.46780946E−05 | −3.02238245E−05 |
| A18= | −7.49049331E−06 | 3.06280481E−06 | 9.75614715E−06 | 3.54609712E−06 |
| A20= | 6.51963644E−07 | −2.54267831E−07 | −7.17840448E−07 | −2.32378537E−07 |
| A22= | −2.47933135E−08 | 9.01773182E−09 | 2.27846343E−08 | 6.47434534E−09 |
| Surface # | 11 | 12 | 13 | 14 |
| k= | −9.90000000E+01 | −5.23173000E+01 | 1.01852000E+01 | 1.48070000E+00 |
| A4= | −1.29555323E−02 | −1.12350530E−02 | −6.94207760E−03 | 1.17820497E−02 |
| A6= | 3.87919627E−03 | −5.41809303E−04 | −1.64642227E−03 | −1.48293050E−02 |
| A8= | −2.36846184E−03 | 1.72714218E−03 | 6.76078554E−04 | 6.41272684E−03 |
| A10= | 1.22627548E−03 | −1.29590179E−03 | −6.26613504E−05 | −1.76455083E−03 |
| A12= | −4.56453796E−04 | 6.59552866E−04 | −4.52877768E−05 | 3.39989126E−04 |
| A14= | 1.02244471E−04 | −2.44518890E−04 | 2.25532655E−05 | −4.76833587E−05 |
| A16= | −8.02859614E−06 | 6.70675641E−05 | −5.50525176E−06 | 4.96569152E−06 |
| A18= | −2.04899973E−06 | −1.36455190E−05 | 8.66316408E−07 | −3.86740151E−07 |
| A20= | 6.84010439E−07 | 2.04751958E−06 | −9.34329984E−08 | 2.24323833E−08 |
| A22= | −8.77917459E−08 | −2.23061718E−07 | 6.91246651E−09 | −9.53704214E−10 |
| A24= | 5.53583722E−09 | 1.71215552E−08 | −3.36580102E−10 | 2.88055936E−11 |
| A26= | −1.41514251E−10 | −8.76272140E−10 | 9.72279714E−12 | −5.84165985E−13 |
| A28= | | 2.68016870E−11 | −1.26066003E−13 | 7.12075502E−15 |
| A30= | | −3.70170839E−13 | | −3.93834532E−17 |
| Surface # | 15 | 16 | 17 | 18 |
| k= | 5.23531000E−01 | −9.90000000E+01 | 6.39899000E+00 | −8.82333000E−01 |
| A4= | 1.65174881E−02 | 4.90558229E−03 | −2.64710467E−02 | −2.95459051E−02 |
| A6= | −1.56396121E−02 | −1.51091299E−03 | 6.85604328E−03 | 6.45255403E−03 |
| A8= | 6.06865527E−03 | 2.24025902E−04 | −1.46625714E−03 | −1.10770716E−03 |
| A10= | −1.54170061E−03 | −2.80462626E−05 | 2.20598254E−04 | 1.35289959E−04 |
| A12= | 2.77066069E−04 | 3.90485252E−06 | −2.22816392E−05 | −1.17757895E−05 |
| A14= | −3.64389933E−05 | −4.99178753E−07 | 1.56080236E−06 | 7.41270618E−07 |
| A16= | 3.56462168E−06 | 4.68324114E−08 | −7.76838080E−08 | −3.40540433E−08 |
| A18= | −2.60937144E−07 | −3.02202142E−09 | 2.73866576E−09 | 1.14110686E−09 |
| A20= | 1.42510054E−08 | 1.32369967E−10 | −6.55028081E−11 | −2.75532551E−11 |
| A22= | −5.72624710E−10 | −3.86923632E−12 | 9.26445039E−13 | 4.66283646E−13 |
| A24= | 1.64324318E−11 | 7.22877903E−14 | −3.29958970E−15 | −5.24190642E−15 |
| A26= | −3.18457434E−13 | −7.80964455E−16 | −1.26673126E−16 | 3.51275338E−17 |
| A28= | 3.73019139E−15 | 3.71255146E−18 | 2.17977457E−18 | −1.06123825E−19 |
| A30= | −1.99188775E−17 | | −1.15330595E−20 | |

In Table 1A, the curvature radius, the thickness and the focal length are shown in millimeters (mm). Surface numbers 0-21 represent the surfaces sequentially arranged from the object side to the image side along the optical axis. In Table 11B, k represents the conic coefficient of the equation of the aspheric surface profiles. A4-A30 represent the aspheric coefficients ranging from the 4th order to the 30th order. The tables presented below for each embodiment correspond to schematic parameter and aberration curves of each embodiment, and term definitions of the tables are the same as those in Table 1A and Table 1B of the 1st embodiment. Therefore, an explanation in this regard will not be provided again.

### 2nd Embodiment

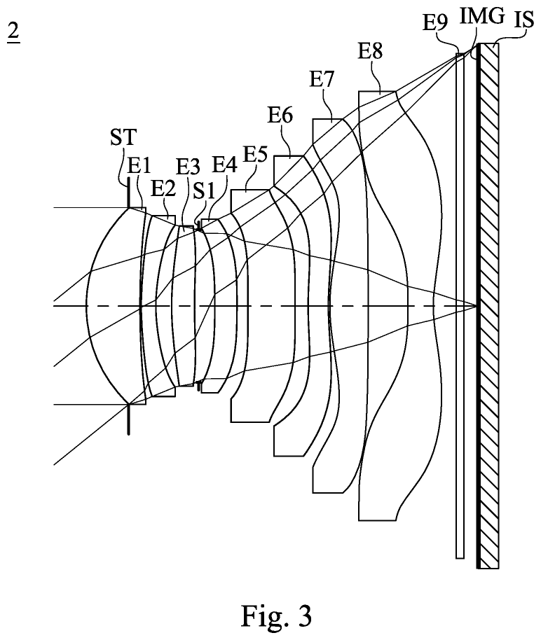

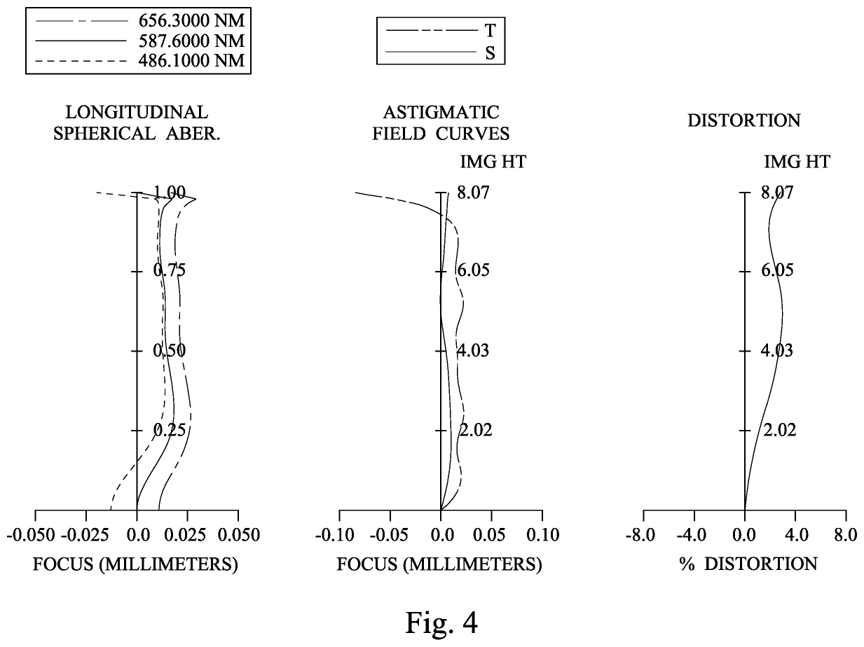

FIG. 3 is a schematic view of an imaging apparatus 2 according to the 2nd embodiment of the present disclosure. FIG. 4 shows spherical aberration curves, astigmatic field curves and a distortion curve of the imaging apparatus 2 according to the 2nd embodiment. In FIG. 3, the imaging apparatus 2 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the object-side surface of the first lens element E1 includes one inflection point, and the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point, and the image-side surface of the third lens element E3 includes one inflection point and one critical point.

The fourth lens element E4 with negative refractive power has an object-side surface being concave in a paraxial region thereof and an image-side surface being convex in a paraxial region thereof. The fourth lens element E4 is made of a plastic material, and has the object-side surface and the image-side surface being both aspheric. Furthermore, the image-side surface of the fourth lens element E4 includes one inflection point.

The fifth lens element E5 with negative refractive power has an object-side surface being convex in a paraxial region thereof and an image-side surface being concave in a paraxial region thereof. The fifth lens element E5 is made of a plastic material, and has the object-side surface and the image-side surface being both aspheric. Furthermore, the object-side surface of the fifth lens element E5 includes one inflection point and one critical point, and the image-side surface of the fifth lens element E5 includes two inflection points and one critical point.

The sixth lens element E6 with negative refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes one inflection point and one critical point.

The seventh lens element E7 with positive refractive power has an object-side surface being convex in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes two inflection points and one critical point, and the image-side surface of the seventh lens element E7 includes two inflection points.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points, and the image-side surface of the eighth lens element E8 includes two inflection points and one critical point.

The filter E9 is made of a glass material, which is located between the eighth lens element E8 and the image surface IMG in order, and will not affect the focal length of the photographing system lens assembly.

The detailed optical data of the 2nd embodiment are shown in Table 2A and the aspheric surface data are shown in Table 2B below.

TABLE 2A
2nd Embodiment
f = 9.70 mm, Fno = 1.60, HFOV = 38.9 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.306 | | | | |
| 2 | Lens 1 | 4.2009 | ASP | 1.653 | Plastic | 1.534 | 56.0 | 9.17 |
| 3 | | 25.3741 | ASP | 0.038 | | | | |
| 4 | Lens 2 | 9.6663 | ASP | 0.450 | Plastic | 1.669 | 19.5 | −19.19 |
| 5 | | 5.4118 | ASP | 0.484 | | | | |
| 6 | Lens 3 | 9.5535 | ASP | 0.708 | Plastic | 1.544 | 56.0 | 28.09 |
| 7 | | 24.8145 | ASP | 0.124 | | | | |
| 8 | Stop | Plano | | 0.499 | | | | |
| 9 | Lens 4 | −26.5019 | ASP | 0.681 | Plastic | 1.669 | 19.5 | −133.79 |
| 10 | | −38.0361 | ASP | 0.336 | | | | |
| 11 | Lens 5 | 90.9091 | ASP | 1.447 | Plastic | 1.534 | 56.0 | −75.47 |
| 12 | | 27.7778 | ASP | 0.408 | | | | |
| 13 | Lens 6 | 11.6517 | ASP | 0.620 | Plastic | 1.660 | 20.4 | −488.15 |
| 14 | | 11.0071 | ASP | 0.048 | | | | |
| 15 | Lens 7 | 6.3910 | ASP | 1.177 | Plastic | 1.534 | 56.0 | 11.44 |
| 16 | | −130.6385 | ASP | 1.222 | | | | |
| 17 | Lens 8 | −28.7348 | ASP | 0.782 | Plastic | 1.544 | 56.0 | −6.98 |
| 18 | | 4.4150 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.447 | | | | |
| 21 | Image | Plano | — | | | | |

Reference wavelength is 587.6 nm (d-line).
Effective radius of Surface 8 (stop S1) is 2.351 mm.

TABLE 2B
Aspheric Coefficients

| Surface # | 2 | 3 | 4 | 5 |
|---|---|---|---|---|
| k= | −5.86514000E−02 | −1.08040000E+01 | 3.68331000E+00 | −4.20659000E+00 |
| A4= | 4.01456948E−04 | −3.72450450E−03 | −9.05129872E−03 | −1.88494755E−03 |
| A6= | −8.30106105E−05 | 2.78200787E−03 | 2.81354011E−03 | −7.38118384E−04 |
| A8= | 1.18292816E−04 | −1.19136662E−03 | −1.00627613E−03 | 1.62162084E−03 |
| A10= | −6.99489329E−05 | 3.56254568E−04 | 3.15150259E−04 | −1.32911176E−03 |
| A12= | 2.51532696E−05 | −6.97994712E−05 | −6.89054731E−05 | 6.93518952E−04 |
| A14= | −5.68259843E−06 | 7.94639469E−06 | 9.63329443E−06 | −2.33294679E−04 |
| A16= | 8.15924592E−07 | −3.26018571E−07 | −7.26494871E−07 | 5.06955889E−05 |
| A18= | −7.25291784E−08 | −3.03935196E−08 | 1.29568511E−08 | −6.86371529E−06 |
| A20= | 3.64606438E−09 | 4.13472958E−09 | 1.78086217E−09 | 5.27510495E−07 |
| A22= | −7.96763954E−11 | −1.41968066E−10 | −9.10061613E−11 | −1.76109719E−08 |
| Surface # | 6 | 7 | 9 | 10 |
| k= | 3.46481000E+00 | 8.10194000E+01 | 2.29178000E+01 | 8.41212000E+01 |
| A4= | −1.73505216E−03 | −3.69851346E−03 | −9.28060289E−03 | −1.32543652E−02 |
| A6= | −8.08075644E−04 | 4.35223877E−04 | 1.68858676E−03 | 3.71742392E−03 |
| A8= | 5.32052143E−04 | −1.30909325E−03 | −1.93284844E−03 | −2.69261848E−03 |
| A10= | −4.97757625E−04 | 1.04103472E−03 | 1.21510390E−03 | 1.37455197E−03 |
| A12= | 2.96845561E−04 | −5.25272067E−04 | −5.28263613E−04 | −5.03007160E−04 |
| A14= | −1.11312796E−04 | 1.72034524E−04 | 1.59628935E−04 | 1.29217465E−04 |
| A16= | 2.67153669E−05 | −3.61855717E−05 | −3.24060602E−05 | −2.22794266E−05 |
| A18= | −3.96033174E−06 | 4.72925063E−06 | 4.22679884E−06 | 2.43781527E−06 |
| A20= | 3.30877765E−07 | −3.50145129E−07 | −3.21913958E−07 | −1.53017117E−07 |
| A22= | −1.19759151E−08 | 1.11799781E−08 | 1.09143238E−08 | 4.20910508E−09 |
| Surface # | 11 | 12 | 13 | 14 |
| k= | 9.90000000E+01 | −2.84605000E+01 | 6.58502000E+00 | −1.44376000E+01 |
| A4= | −1.35845937E−02 | −1.84868287E−02 | −1.25920255E−02 | −2.61609490E−04 |
| A6= | 6.24390792E−03 | 3.28284207E−03 | 6.77361995E−04 | −4.78049148E−03 |
| A8= | −4.61561708E−03 | −3.59797610E−04 | −3.01433016E−05 | 2.59932787E−03 |
| A10= | 2.72304072E−03 | −1.28945332E−04 | 9.27455304E−05 | −8.91468687E−04 |
| A12= | −1.20883720E−03 | 1.05770096E−04 | −7.11882446E−05 | 2.08158445E−04 |
| A14= | 3.87602141E−04 | −4.21028138E−05 | 2.55479481E−05 | −3.43293995E−05 |
| A16= | −8.83944393E−05 | 1.12256683E−05 | −5.64608802E−06 | 4.09795612E−06 |
| A18= | 1.41675019E−05 | −2.10554453E−06 | 8.37880048E−07 | −3.58145903E−07 |
| A20= | −1.55868922E−06 | 2.80885826E−07 | −8.55074576E−08 | 2.28909649E−08 |
| A22= | 1.11969119E−07 | −2.64999045E−08 | 5.92927518E−09 | −1.05550647E−09 |
| A24= | −4.72164112E−09 | 1.72750316E−09 | −2.66591190E−10 | 3.41019305E−11 |
| A26= | 8.84330911E−11 | −7.39735841E−11 | 6.99390647E−12 | −7.31017531E−13 |
| A28= | | 1.87031650E−12 | −8.10652064E−14 | 9.32495085E−15 |
| A30= | | −2.11343906E−14 | | −5.35260957E−17 |
| Surface # | 15 | 16 | 17 | 18 |
| k= | −2.05589000E+00 | −5.23149000E+01 | 5.83788000E+00 | −9.17156000E−01 |
| A4= | −1.68249157E−03 | 6.35018561E−04 | −2.50712867E−02 | −2.62503215E−02 |
| A6= | −3.70097986E−03 | 3.24233758E−04 | 5.38077288E−03 | 5.04429811E−03 |
| A8= | 1.94652990E−03 | −2.18297954E−04 | −1.06726704E−03 | −8.23471850E−04 |
| A10= | −6.43918429E−04 | 4.67432088E−05 | 1.68284106E−04 | 1.01192891E−04 |
| A12= | 1.44760943E−04 | −5.22325174E−06 | −1.90209004E−05 | −9.12721479E−06 |
| A14= | −2.28055685E−05 | 3.33006956E−07 | 1.56354635E−06 | 6.03572645E−07 |
| A16= | 2.57277039E−06 | −1.11037379E−08 | −9.53056186E−08 | −2.93022820E−08 |
| A18= | −2.10313262E−07 | 4.27322433E−11 | 4.32677339E−09 | 1.03924659E−09 |
| A20= | 1.24624001E−08 | 1.26433953E−11 | −1.45223668E−10 | −2.65282440E−11 |
| A22= | −5.28884342E−10 | −5.67892512E−13 | 3.54203122E−12 | 4.73152438E−13 |
| A24= | 1.56336614E−11 | 1.21465490E−14 | −6.08953217E−14 | −5.58121260E−15 |
| A26= | −3.05135241E−13 | −1.35972031E−16 | 6.98805842E−16 | 3.90286275E−17 |
| A28= | 3.52990705E−15 | 6.42009961E−19 | −4.80329677E−18 | −1.22263423E−19 |
| A30= | −1.83129535E−17 | | 1.49626933E−20 | |

In the 2nd embodiment, the equation of the aspheric surface profiles of the aforementioned lens elements is the same as the equation of the 1 st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions in Table 2C:

TABLE 2C
2nd Embodiment

| | | | |
|---|---|---|---|
| f [mm] | 9.70 | (R14 + R16)/(R14 − R16) | 0.93 |
| Fno | 1.60 | R16/CT4 | 6.48 |
| HFOV [degrees] | 38.9 | CT1/CT5 | 1.14 |
| TL/ImgH | 1.50 | CT4/T34 | 1.09 |
| TL/f | 1.24 | CT3/(CT4 + CT5) | 0.33 |
| TL/BL | 8.70 | CT5/(CT6 + CT7) | 0.81 |
| \|f1/f2\| | 0.48 | T67/T78 | 0.04 |
| \|f2/f6\| | 0.04 | ΣCT/ΣAT | 2.38 |
| f3/f7 | 2.46 | ET6/CT6 | 1.47 |
| f7/f8 | −1.64 | \|Sag7R1\|/CT7 | 0.45 |
| f/f67 | 0.81 | (T78 − Sag7R2 + | 0.41 |
| | | Sag8R1)/T78 | |
| \|f/f4\| + \|f/f5\| + \|f/f6\| | 0.22 | V4 + V6 | 39.9 |
| (\|f/f5\| + \|f/f6\|)/(\|f/f7\| + \|f/f8\|) | 0.07 | V5/V1 | 1.0 |
| \|f/R9\| + \|f/R10\| | 0.46 | Vmin | 19.5 |
| \|f/R13\| + \|f/R14\| | 1.59 | V1/N1 | 36.5 |
| f1/\|R2\| | 0.36 | V2/N2 | 11.7 |
| f1/CT1 | 5.55 | V3/N3 | 36.3 |
| 10 × CT2/f2 | −0.23 | V4/N4 | 11.7 |
| R1/R11 | 0.36 | V5/N5 | 36.5 |
| (R4 + R14)/(R4 − R14) | −0.92 | V6/N6 | 12.3 |
| (R13 + R14)/(R13 − R14) | −0.91 | V7/N7 | 36.5 |
| (R12 + R16)/(R12 − R16) | 2.34 | V8/N8 | 36.3 |

### 3rd Embodiment

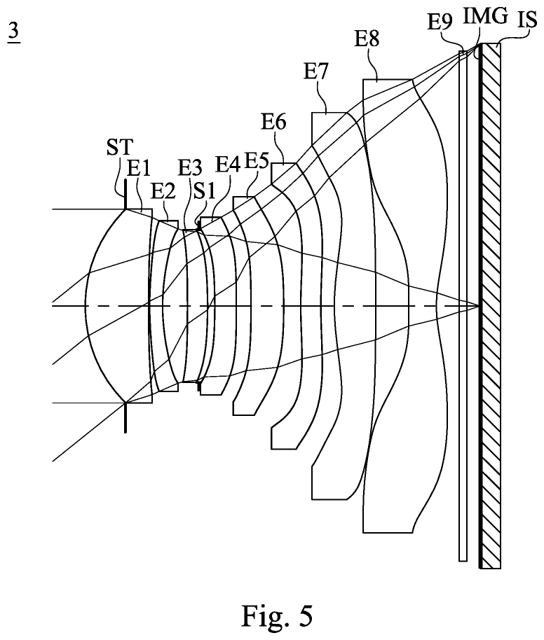

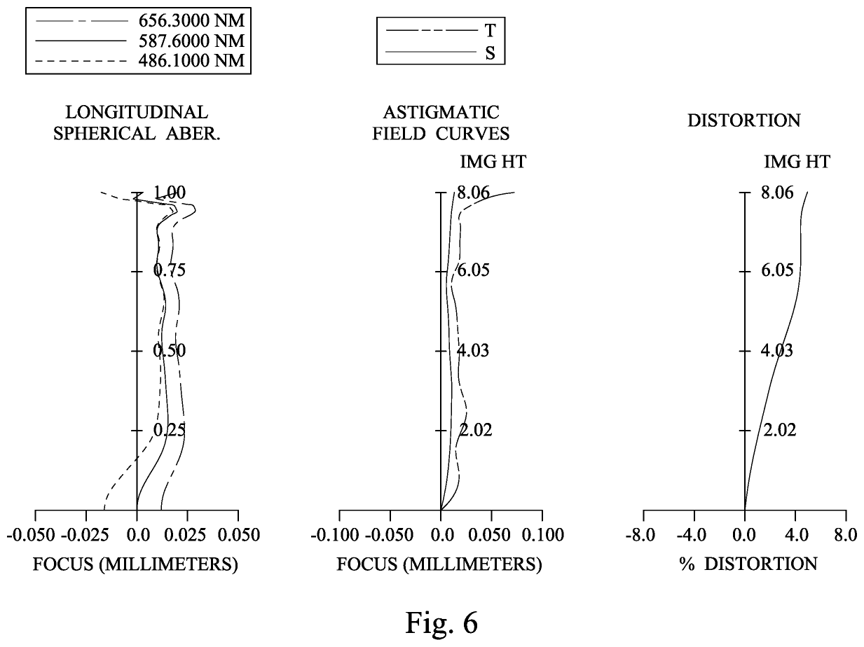

FIG. 5 is a schematic view of an imaging apparatus 3 according to the 3rd embodiment of the present disclosure. FIG. 6 shows spherical aberration curves, astigmatic field curves and a distortion curve of the imaging apparatus 3 according to the 3rd embodiment. In FIG. 5, the imaging apparatus 3 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being concave in a paraxial region thereof and an image-side surface being convex in a paraxial region thereof. The third lens element E3 is made of a plastic material, and has the object-side surface and the image-side surface being both aspheric.

The fourth lens element E4 with negative refractive power has an object-side surface being concave in a paraxial region thereof and an image-side surface being concave in a paraxial region thereof. The fourth lens element E4 is made of a plastic material, and has the object-side surface and the image-side surface being both aspheric. Furthermore, the object-side surface of the fourth lens element E4 includes one inflection point, and the image-side surface of the fourth lens element E4 includes two inflection points and one critical point.

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with positive refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes two inflection points and one critical point.

The seventh lens element E7 with positive refractive power has an object-side surface being convex in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes three inflection points and one critical point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes one inflection point and one critical point, and the image-side surface of the eighth lens element E8 includes two inflection points and one critical point.

The filter E9 is made of a glass material, which is located between the eighth lens element E8 and the image surface IMG in order, and will not affect the focal length of the photographing system lens assembly.

The detailed optical data of the 3rd embodiment are shown in Table 3A and the aspheric surface data are shown in Table 3B below.

TABLE 3A
3rd Embodiment
f = 9.55 mm, Fno = 1.60, HFOV = 38.8 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.237 | | | | |
| 2 | Lens 1 | 4.3068 | ASP | 1.949 | Plastic | 1.544 | 56.0 | 8.74 |
| 3 | | 38.4623 | ASP | 0.030 | | | | |
| 4 | Lens 2 | 9.8770 | ASP | 0.400 | Plastic | 1.686 | 18.4 | −23.43 |
| 5 | | 6.0169 | ASP | 0.765 | | | | |
| 6 | Lens 3 | −62.4998 | ASP | 0.620 | Plastic | 1.544 | 56.0 | 36.01 |
| 7 | | −14.9671 | ASP | −0.276 | | | | |
| 8 | Stop | Plano | | 0.496 | | | | |
| 9 | Lens 4 | −23.1819 | ASP | 0.661 | Plastic | 1.639 | 23.5 | −36.30 |
| 10 | | 2420272.0151 | ASP | 0.452 | | | | |
| 11 | Lens 5 | −152.9261 | ASP | 1.006 | Plastic | 1.534 | 56.0 | 85.91 |
| 12 | | −35.3864 | ASP | 0.525 | | | | |
| 13 | Lens 6 | 13.6327 | ASP | 0.620 | Plastic | 1.587 | 28.3 | 74.49 |
| 14 | | 19.4719 | ASP | 0.417 | | | | |
| 15 | Lens 7 | 8.4874 | ASP | 1.267 | Plastic | 1.544 | 56.0 | 14.79 |
| 16 | | −146.1737 | ASP | 1.019 | | | | |
| 17 | Lens 8 | −50.8999 | ASP | 0.849 | Plastic | 1.544 | 56.0 | −6.66 |
| 18 | | 3.9234 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.418 | | | | |
| 21 | Image | Plano | — | | | | |

Reference wavelength is 587.6 nm (d-line).
Effective radius of Surface 8 (stop S1) is 2.353 mm.

TABLE 3B
Aspheric Coefficients

| Surface # | 2 | 3 | 4 | 5 |
|---|---|---|---|---|
| k= | −2.47852000E−02 | −6.18958000E+01 | 4.50933000E+00 | −4.36830000E+00 |
| A4= | 3.83034526E−04 | −9.70760401E−03 | −1.51469638E−02 | −3.68398738E−03 |
| A6= | 3.24975227E−05 | 1.05424940E−02 | 9.72562489E−03 | 1.63897271E−04 |
| A8= | 9.42157063E−06 | −6.96941228E−03 | −6.22551485E−03 | 1.12646617E−03 |
| A10= | −8.05597091E−06 | 3.24277997E−03 | 3.07095728E−03 | −1.18396117E−03 |
| A12= | 3.55048780E−06 | −1.05264054E−03 | −1.07658522E−03 | 7.39084649E−04 |
| A14= | −8.97707167E−07 | 2.34954057E−04 | 2.62285104E−04 | −2.90570000E−04 |
| A16= | 1.41814277E−07 | −3.51815934E−05 | −4.31067005E−05 | 7.30428863E−05 |
| A18= | −1.39698226E−08 | 3.36666525E−06 | 4.54397843E−06 | −1.13672305E−05 |
| A20= | 7.82733422E−10 | −1.85698894E−07 | −2.76672507E−07 | 9.99264669E−07 |
| A22= | −1.92165939E−11 | 4.48370589E−09 | 7.37808038E−09 | −3.79571395E−08 |
| Surface # | 6 | 7 | 9 | 10 |
| k= | 3.20716000E+01 | −4.72950000E+01 | 5.56769000E+01 | −7.25753000E+12 |
| A4= | −4.39671045E−05 | −2.48094395E−03 | −8.60277546E−03 | −1.28741318E−02 |
| A6= | −3.55536403E−03 | −6.76039814E−04 | 2.67288488E−03 | 3.78897014E−03 |
| A8= | 7.30422640E−03 | 4.63600433E−05 | −3.44617760E−03 | −2.29663235E−03 |
| A10= | −1.20619304E−02 | −1.27339074E−03 | 2.16775987E−03 | 9.72032592E−04 |
| A12= | 1.29823341E−02 | 1.78262696E−03 | −9.25041689E−04 | −3.02696249E−04 |
| A14= | −9.53870282E−03 | −1.35897320E−03 | 2.81701709E−04 | 7.03505621E−05 |
| A16= | 4.94418594E−03 | 7.03243742E−04 | −5.89229991E−05 | −1.17369029E−05 |
| A18= | −1.83738647E−03 | −2.62086905E−04 | 7.89714521E−06 | 1.29876768E−06 |
| A20= | 4.91418676E−04 | 7.13274551E−05 | −6.05652669E−07 | −8.35731921E−08 |
| A22= | −9.37692238E−05 | −1.40582373E−05 | 2.02166932E−08 | 2.33716474E−09 |
| A24= | 1.24511124E−05 | 1.95118157E−06 | | |
| A26= | −1.09304896E−06 | −1.80402645E−07 | | |
| A28= | 5.70321369E−08 | 9.94609422E−09 | | |
| A30= | −1.33967126E−09 | −2.46698473E−10 | | |
| Surface # | 11 | 12 | 13 | 14 |
| k= | −7.77547000E+01 | 7.54659000E+01 | 1.02253000E+01 | −2.58934000E+01 |
| A4= | −1.52647742E−02 | −1.85970720E−02 | −9.77939558E−03 | 3.11189265E−03 |
| A6= | 5.59076918E−03 | 3.34485899E−03 | −2.56073749E−03 | −9.13746498E−03 |
| A8= | −2.70906768E−03 | 3.77146761E−04 | 3.09047582E−03 | 5.82985557E−03 |
| A10= | 1.11648162E−03 | −7.04539888E−04 | −1.41135757E−03 | −2.23709606E−03 |
| A12= | −3.74966212E−04 | 3.20452841E−04 | 3.77857124E−04 | 5.71932584E−04 |
| A14= | 9.31605792E−05 | −8.53195946E−05 | −6.41829226E−05 | −1.03016472E−04 |
| A16= | −1.56611457E−05 | 1.43372347E−05 | 6.75824630E−06 | 1.34955277E−05 |
| A18= | 1.57992975E−06 | −1.39382128E−06 | −3.56335290E−07 | −1.30436005E−06 |
| A20= | −6.48790230E−08 | 3.48170944E−08 | −6.86285474E−09 | 9.30187208E−08 |
| A22= | −3.35605151E−09 | 9.87923991E−09 | 2.56361025E−09 | −4.83040508E−09 |
| A24= | 4.69518143E−10 | −1.46525652E−09 | −1.83448598E−10 | 1.77402110E−10 |
| A26= | −1.45045206E−11 | 9.70379567E−11 | 6.16141845E−12 | −4.36162684E−12 |
| A28= | | −3.30788587E−12 | −8.36534177E−14 | 6.43451503E−14 |
| A30= | | 4.69854490E−14 | | −4.30346293E−16 |
| Surface # | 15 | 16 | 17 | 18 |
| k= | −1.80941000E+00 | 8.53217000E+01 | 2.85433000E+01 | −9.28542000E−01 |
| A4= | 3.54963666E−03 | 3.21858807E−03 | −2.48999947E−02 | −2.68970098E−02 |
| A6= | −6.16379898E−03 | −2.44170468E−03 | 3.27361752E−03 | 4.37475625E−03 |
| A8= | 2.80896608E−03 | 7.75164699E−04 | −2.82877486E−04 | −5.69693097E−04 |
| A10= | −8.19724609E−04 | −1.51340155E−04 | 2.99887881E−05 | 5.65119390E−05 |
| A12= | 1.64466986E−04 | 1.99491093E−05 | −3.94717509E−06 | −4.16340790E−06 |
| A14= | −2.38683679E−05 | −1.85456649E−06 | 4.38688001E−07 | 2.24694966E−07 |
| A16= | 2.57011036E−06 | 1.24072461E−07 | −3.50056323E−08 | −8.81942713E−09 |
| A18= | −2.06689340E−07 | −5.99784287E−09 | 1.94899019E−09 | 2.49413912E−10 |
| A20= | 1.23272231E−08 | 2.07342448E−10 | −7.55833677E−11 | −4.99227410E−12 |
| A22= | −5.35105844E−10 | −4.98778024E−12 | 2.03056357E−12 | 6.84324696E−14 |
| A24= | 1.63579062E−11 | 7.91407391E−14 | −3.70248943E−14 | −6.04834354E−16 |
| A26= | −3.32623905E−13 | −7.43206266E−16 | 4.36935870E−16 | 3.06080578E−18 |
| A28= | 4.02876101E−15 | 3.12409860E−18 | −3.00797870E−18 | −6.58437527E−21 |
| A30= | −2.19564898E−17 | | 9.16257238E−21 | |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions in Table 3C:

TABLE 3C
3rd Embodiment

| | | | |
|---|---|---|---|
| f [mm] | 9.55 | (R14 + R16)/(R14 − R16) | 0.95 |
| Fno | 1.60 | R16/CT4 | 5.94 |
| HFOV [degrees] | 38.8 | CT1/CT5 | 1.94 |
| TL/ImgH | 1.51 | CT4/T34 | 3.00 |
| TL/f | 1.27 | CT3/(CT4 + CT5) | 0.37 |
| TL/BL | 8.95 | CT5/(CT6 + CT7) | 0.53 |
| \|f1/f2\| | 0.37 | T67/T78 | 0.41 |
| \|f2/f6\| | 0.31 | ΣCT/ΣAT | 2.15 |
| f3/f7 | 2.44 | ET6/CT6 | 1.23 |
| f7/f8 | −2.22 | \|Sag7R1\|/CT7 | 0.55 |
| f/f67 | 0.76 | (T78 − Sag7R2 + | 0.50 |
| | | Sag8R1)/T78 | |
| \|f/f4\| + \|f/f5\| + \|f/f6\| | 0.50 | V4 + V6 | 51.8 |
| (\|f/f5\| + \|f/f6\|)/(\|f/f7\| + \|f/f8\|) | 0.12 | V5/V1 | 1.0 |
| \|f/R9\| + \|f/R10\| | 0.33 | Vmin | 18.4 |
| \|f/R13\| + \|f/R14\| | 1.19 | V1/N1 | 36.3 |
| f1/\|R2\| | 0.23 | V2/N2 | 10.9 |
| f1/CT1 | 4.48 | V3/N3 | 36.3 |
| 10 × CT2/f2 | −0.17 | V4/N4 | 14.3 |
| R1/R11 | 0.32 | V5/N5 | 36.5 |
| (R4 + R14)/(R4 − R14) | −0.92 | V6/N6 | 17.8 |
| (R13 + R14)/(R13 − R14) | −0.89 | V7/N7 | 36.3 |
| (R12 + R16)/(R12 − R16) | 1.50 | V8/N8 | 36.3 |

### 4th Embodiment

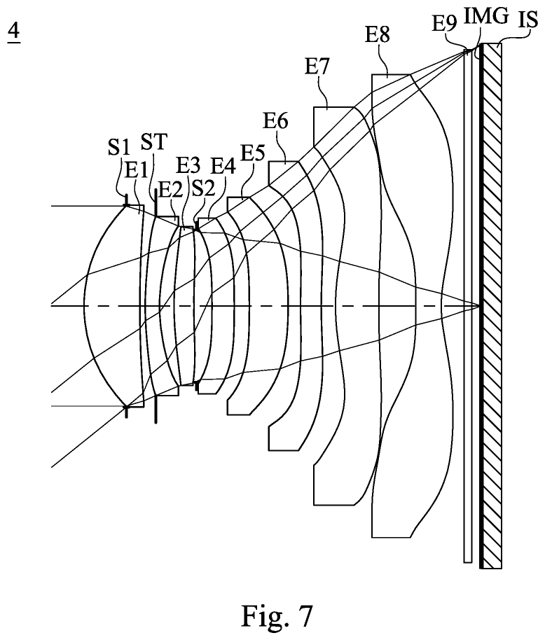

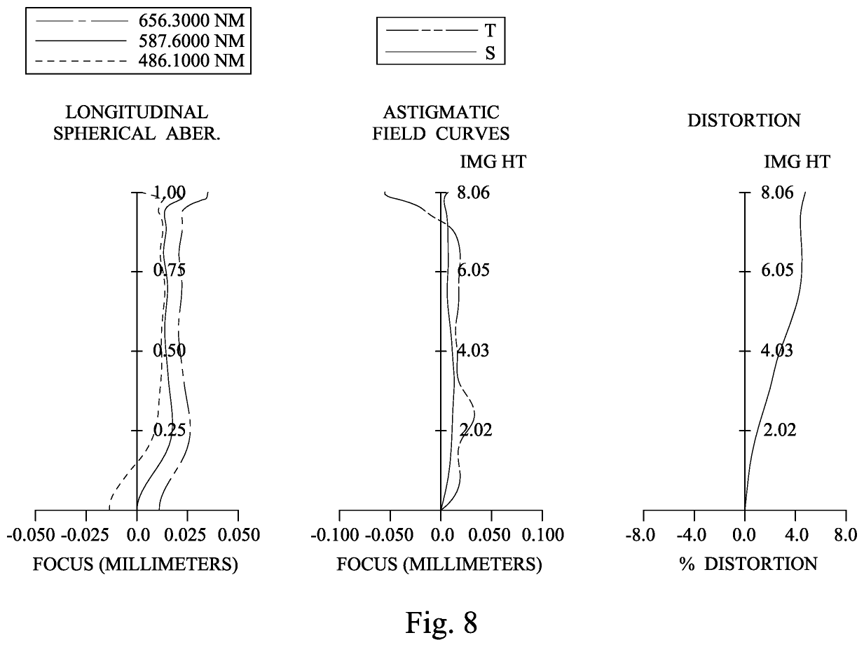

FIG. 7 is a schematic view of an imaging apparatus 4 according to the 4th embodiment of the present disclosure. FIG. 8 shows spherical aberration curves, astigmatic field curves and a distortion curve of the imaging apparatus 4 according to the 4th embodiment. In FIG. 7, the imaging apparatus 4 includes a photographing system lens assembly (its reference numeral is omitted) and an image sensor IS. The photographing system lens assembly includes, in order from an object side to an image side along an optical path, a stop S1, a first lens element E1, an aperture stop ST, a second lens element E2, a third lens element E3, a stop S2, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the object-side surface of the first lens element E1 includes one inflection point, and the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes three inflection points, and the image-side surface of the third lens element E3 includes one inflection point and one critical point.

The fourth lens element E4 with negative refractive power has an object-side surface being concave in a paraxial region thereof and an image-side surface being convex in a paraxial region thereof. The fourth lens element E4 is made of a plastic material, and has the object-side surface and the image-side surface being both aspheric.

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with negative refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes two inflection points and one critical point.

The seventh lens element E7 with positive refractive power has an object-side surface being convex in a paraxial region thereof and an image-side surface being concave in a paraxial region thereof. The seventh lens element E7 is made of a plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes five inflection points and one critical point, and the image-side surface of the eighth lens element E8 includes three inflection points and one critical point.

The filter E9 is made of a glass material, which is located between the eighth lens element E8 and the image surface IMG in order, and will not affect the focal length of the photographing system lens assembly.

The detailed optical data of the 4th embodiment are shown in Table 4A and the aspheric surface data are shown in Table 4B below.

TABLE 4A
4th Embodiment
f = 9.55 mm, Fno = 1.55, HFOV = 38.8 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −1.308 | | | | |
| 2 | Lens 1 | 4.3522 | ASP | 1.718 | Plastic | 1.534 | 56.0 | 9.20 |
| 3 | | 32.7441 | ASP | 0.491 | | | | |
| 4 | Ape. Stop | Plano | | −0.326 | | | | |
| 5 | Lens 2 | 9.3238 | ASP | 0.440 | Plastic | 1.669 | 19.5 | −18.11 |
| 6 | | 5.1692 | ASP | 0.449 | | | | |
| 7 | Lens 3 | 10.6363 | ASP | 0.613 | Plastic | 1.544 | 56.0 | 31.21 |
| 8 | | 27.8859 | ASP | 0.078 | | | | |
| 9 | Stop | Plano | | 0.478 | | | | |
| 10 | Lens 4 | −32.1180 | ASP | 0.683 | Plastic | 1.587 | 28.3 | −110.23 |
| 11 | | −64.2510 | ASP | 0.465 | | | | |
| 12 | Lens 5 | −34.7969 | ASP | 1.193 | Plastic | 1.544 | 56.0 | 49.82 |
| 13 | | −15.4196 | ASP | 0.383 | | | | |
| 14 | Lens 6 | 20.2463 | ASP | 0.637 | Plastic | 1.587 | 28.3 | −214.09 |
| 15 | | 17.2350 | ASP | 0.441 | | | | |
| 16 | Lens 7 | 7.3733 | ASP | 1.333 | Plastic | 1.544 | 56.0 | 15.58 |
| 17 | | 53.0073 | ASP | 1.134 | | | | |
| 18 | Lens 8 | 13283.9028 | ASP | 0.785 | Plastic | 1.534 | 56.0 | −7.15 |
| 19 | | 3.8200 | ASP | 0.700 | | | | |

| | | | | | | | |
|---|---|---|---|---|---|---|---|
| 20 | Filter | Plano | 0.240 | Glass | 1.517 | 64.2 | — |
| 21 | | Plano | 0.295 | | | | |
| 22 | Image | Plano | — | | | | |

Reference wavelength is 587.6 nm (d-line).
Effective radius of Surface 1 (stop S1) is 3.110 mm.
Effective radius of Surface 9 (stop S2) is 2.346 mm.

TABLE 4B
Aspheric Coefficients

| Surface # | 2 | 3 | 5 | 6 |
|---|---|---|---|---|
| k= | −8.54494000E−02 | −4.40822000E+01 | 2.10509000E+00 | −4.34060000E+00 |
| A4= | 3.19148095E−04 | −2.16634927E−03 | −9.36395880E−03 | −3.22012647E−03 |
| A6= | 1.51328246E−04 | 1.23422543E−03 | 2.22329307E−03 | 6.41776979E−04 |
| A8= | −1.01238935E−04 | −3.36223135E−04 | −4.59808845E−04 | 4.84707131E−04 |
| A10= | 4.74732995E−05 | 4.43031012E−05 | 8.33752221E−05 | −5.17677357E−04 |
| A12= | −1.38774229E−05 | 4.81078009E−06 | −9.28500005E−06 | 2.88013383E−04 |
| A14= | 2.61977105E−06 | −3.52634558E−06 | 1.53635759E−07 | −9.92576692E−05 |
| A16= | −3.20101355E−07 | 7.40687217E−07 | 1.42517940E−07 | 2.19487029E−05 |
| A18= | 2.44248330E−08 | −8.20566017E−08 | −2.34830112E−08 | −3.01960309E−06 |
| A20= | −1.06309771E−09 | 4.80894142E−09 | 1.63328031E−09 | 2.35874434E−07 |
| A22= | 2.00625155E−11 | −1.17526094E−10 | −4.37551749E−11 | −7.99489595E−09 |
| Surface # | 7 | 8 | 10 | 11 |
| k= | 6.21619000E+00 | 9.69449000E+01 | 8.93428000E+01 | −6.59626000E+01 |
| A4= | −1.03329961E−03 | −2.44245260E−03 | −9.63758117E−03 | −1.10108080E−02 |
| A6= | −2.24826751E−04 | −8.52554198E−05 | 1.14320862E−03 | 1.14491141E−03 |
| A8= | −3.40924590E−04 | −5.15651032E−04 | −1.37569560E−03 | −7.07098633E−04 |
| A10= | 2.23650343E−04 | 3.81788528E−04 | 9.01598265E−04 | 2.90477198E−04 |
| A12= | −8.95875931E−05 | −1.91864407E−04 | −4.08483057E−04 | −8.64402338E−05 |
| A14= | 2.28115091E−05 | 6.36560894E−05 | 1.26775735E−04 | 1.92602153E−05 |
| A16= | −3.35152321E−06 | −1.36645209E−05 | −2.62026843E−05 | −3.01211636E−06 |
| A18= | 2.32523394E−07 | 1.83421740E−06 | 3.44638279E−06 | 3.03144636E−07 |
| A20= | 1.74931437E−10 | −1.39986146E−07 | −2.60969353E−07 | −1.73986268E−08 |
| A22= | −6.70525047E−10 | 4.61497637E−09 | 8.65360656E−09 | 4.28053414E−10 |
| Surface # | 12 | 13 | 14 | 15 |
| k= | −9.90000000E+01 | 1.60060000E+01 | 2.39592000E+01 | −4.10966000E+01 |
| A4= | −9.53763926E−03 | −1.34060266E−02 | −1.05978728E−02 | 1.54454749E−04 |
| A6= | 2.04889797E−03 | −1.74688773E−05 | −2.93117511E−03 | −6.87901391E−03 |
| A8= | −1.35253465E−03 | 2.78662696E−03 | 3.86643249E−03 | 4.75393551E−03 |
| A10= | 7.56402625E−04 | −2.11574546E−03 | −1.90083272E−03 | −1.91916472E−03 |
| A12= | −3.43274525E−04 | 9.36620606E−04 | 5.59253893E−04 | 5.12778213E−04 |
| A14= | 1.15019545E−04 | −2.84459571E−04 | −1.08277919E−04 | −9.59203965E−05 |
| A16= | −2.72175070E−05 | 6.22307418E−05 | 1.41215189E−05 | 1.29516021E−05 |
| A18= | 4.46192782E−06 | −9.96477076E−06 | −1.21666852E−06 | −1.27929168E−06 |
| A20= | −4.95670861E−07 | 1.16704257E−06 | 6.33910544E−08 | 9.24186900E−08 |
| A22= | 3.56069172E−08 | −9.85922465E−08 | −1.36387672E−09 | −4.82005250E−09 |
| A24= | −1.49038299E−09 | 5.83289552E−09 | −4.02167217E−11 | 1.76342870E−10 |
| A26= | 2.75091991E−11 | −2.28600197E−10 | 3.08894634E−12 | −4.28598177E−12 |
| A28= | | 5.31172419E−12 | −5.41812696E−14 | 6.20584802E−14 |
| A30= | | −5.51236444E−14 | | −4.04627434E−16 |
| Surface # | 16 | 17 | 18 | 19 |
| k= | −1.94657000E+00 | −2.96514000E+01 | 3.86517000E+06 | −9.61716000E−01 |
| A4= | 1.60233406E−03 | 4.01151504E−03 | −2.55452588E−02 | −2.83954680E−02 |
| A6= | −3.78908536E−03 | −1.41706577E−03 | 5.20098001E−03 | 5.26449004E−03 |
| A8= | 1.62195564E−03 | 3.55774178E−04 | −9.36919553E−04 | −7.72953930E−04 |
| A10= | −4.62846985E−04 | −8.04178471E−05 | 1.29264467E−04 | 8.14358714E−05 |
| A12= | 8.87085269E−05 | 1.28364637E−05 | −1.23194614E−05 | −6.07248432E−06 |
| A14= | −1.17689807E−05 | −1.36500046E−06 | 8.27186738E−07 | 3.23339542E−07 |
| A16= | 1.10190143E−06 | 9.84682303E−08 | −4.03964865E−08 | −1.23895307E−08 |
| A18= | −7.28775319E−08 | −4.90686034E−09 | 1.45622199E−09 | 3.41167680E−10 |
| A20= | 3.32787324E−09 | 1.69310730E−10 | −3.85827695E−11 | −6.66132843E−12 |
| A22= | −9.83386921E−11 | −3.97426581E−12 | 7.35290598E−13 | 8.95163542E−14 |
| A24= | 1.55187704E−12 | 6.05747240E−14 | −9.67451292E−15 | −7.82435357E−16 |
| A26= | −9.33488009E−16 | −5.40628950E−16 | 8.17967824E−17 | 3.97466044E−18 |
| A28= | −3.76436537E−16 | 2.14442789E−18 | −3.87072021E−19 | −8.81756294E−21 |
| A30= | 4.28238227E−18 | | 7.26998214E−22 | |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 4A and Table 4B as the following values and satisfy the following conditions in Table 4C:

TABLE 4C
4th Embodiment

| | | | |
|---|---|---|---|
| f [mm] | 9.55 | (R14 + R16)/(R14 − R16) | 1.16 |
| Fno | 1.55 | R16/CT4 | 5.59 |
| HFOV [degrees] | 38.8 | CT1/CT5 | 1.44 |
| TL/ImgH | 1.52 | CT4/T34 | 1.23 |
| TL/f | 1.28 | CT3/(CT4 + CT5) | 0.33 |
| TL/BL | 9.90 | CT5/(CT6 + CT7) | 0.61 |
| \|f1/f2\| | 0.51 | T67/T78 | 0.39 |
| \|f2/f6\| | 0.08 | ΣCT/ΣAT | 2.06 |
| f3/f7 | 2.00 | ET6/CT6 | 1.43 |
| f7/f8 | −2.18 | \|Sag7R1\|/CT7 | 0.50 |
| f/f67 | 0.56 | (T78 − Sag7R2 + | 0.48 |
| | | Sag8R1)/T78 | |
| \|f/f4\| + \|f/f5\| + \|f/f6\| | 0.32 | V4 + V6 | 56.6 |
| (\|f/f5\| + \|f/f6\|)/ | 0.12 | V5/V1 | 1.0 |
| (\|f/f7\| + \|f/f8\|) | | | |
| \|f/R9\| + \|f/R10\| | 0.89 | Vmin | 19.5 |
| \|f/R13\| + \|f/R14\| | 1.47 | V1/N1 | 36.5 |
| f1/\|R2\| | 0.28 | V2/N2 | 11.7 |
| f1/CT1 | 5.36 | V3/N3 | 36.3 |
| 10 × CT2/f2 | −0.24 | V4/N4 | 17.8 |
| R1/R11 | 0.21 | V5/N5 | 36.3 |
| (R4 + R14)/(R4 − R14) | −1.22 | V6/N6 | 17.8 |
| (R13 + R14)/(R13 − R14) | −1.32 | V7/N7 | 36.3 |
| (R12 + R16)/(R12 − R16) | 1.57 | V8/N8 | 36.5 |

### 5th Embodiment

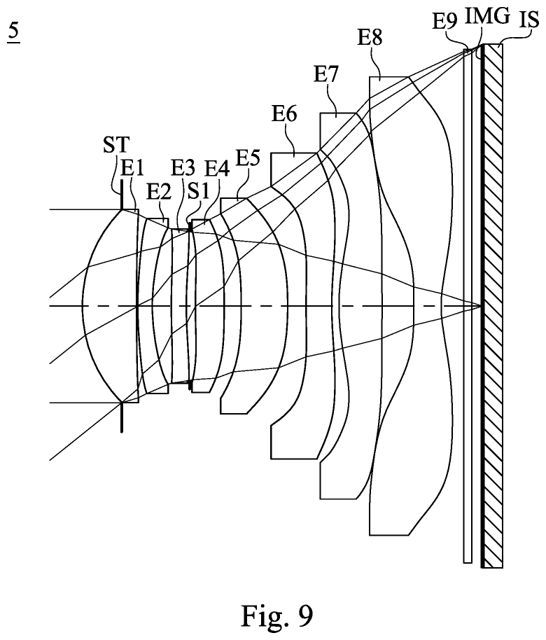

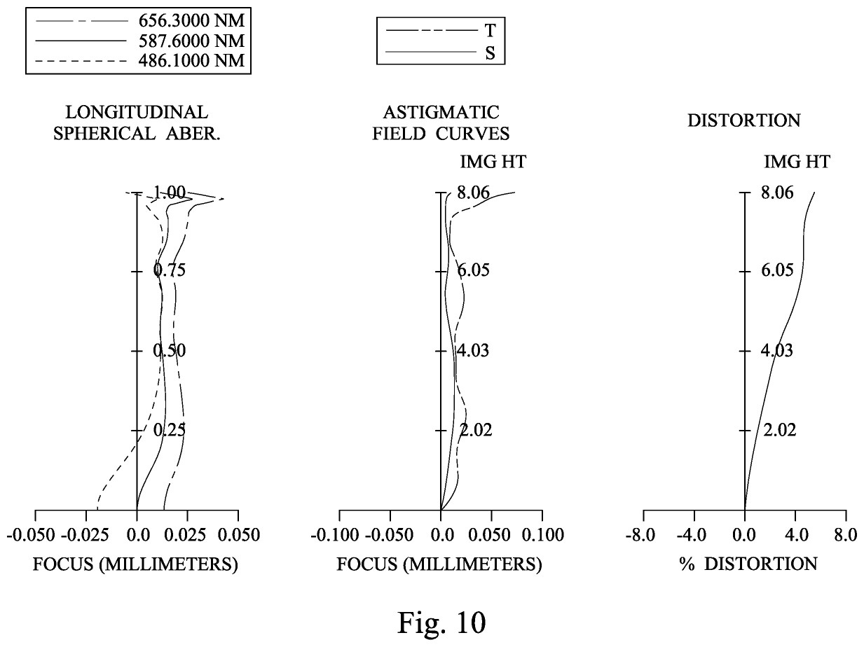

FIG. 9 is a schematic view of an imaging apparatus 5 according to the 5th embodiment of the present disclosure. FIG. 10 shows spherical aberration curves, astigmatic field curves and a distortion curve of the imaging apparatus 5 according to the 5th embodiment. In FIG. 9, the imaging apparatus 5 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with negative refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point and one critical point, and the image-side surface of the third lens element E3 includes two inflection points.

The fourth lens element E4 with positive refractive power has an object-side surface being convex in a paraxial region thereof and an image-side surface being convex in a paraxial region thereof. The fourth lens element E4 is made of a plastic material, and has the object-side surface and the image-side surface being both aspheric. Furthermore, the object-side surface of the fourth lens element E4 includes two inflection points and one critical point.

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with negative refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes two inflection points and one critical point.

The seventh lens element E7 with positive refractive power has an object-side surface being convex in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes two inflection points and one critical point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes three inflection points, and the image-side surface of the eighth lens element E8 includes three inflection points and one critical point.

The filter E9 is made of a glass material, which is located between the eighth lens element E8 and the image surface IMG in order, and will not affect the focal length of the photographing system lens assembly.

The detailed optical data of the 5th embodiment are shown in Table 5A and the aspheric surface data are shown in Table 5B below.

TABLE 5A
5th Embodiment
f = 9.52 mm, Fno = 1.60, HFOV = 38.7 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.210 | | | | |
| 2 | Lens 1 | 4.3908 | ASP | 1.668 | Plastic | 1.544 | 56.0 | 8.68 |
| 3 | | 54.0747 | ASP | 0.035 | | | | |
| 4 | Lens 2 | 10.2201 | ASP | 0.450 | Plastic | 1.686 | 18.4 | −23.23 |
| 5 | | 6.1159 | ASP | 0.587 | | | | |
| 6 | Lens 3 | 25.1612 | ASP | 0.460 | Plastic | 1.587 | 28.3 | −46.64 |
| 7 | | 13.0256 | ASP | 0.105 | | | | |
| 8 | Stop | Plano | | 0.177 | | | | |
| 9 | Lens 4 | 21.3320 | ASP | 0.885 | Plastic | 1.559 | 40.4 | 26.77 |
| 10 | | −49.3152 | ASP | 0.523 | | | | |
| 11 | Lens 5 | −22.7223 | ASP | 1.432 | Plastic | 1.534 | 56.0 | 62.45 |
| 12 | | −13.8138 | ASP | 0.568 | | | | |
| 13 | Lens 6 | 21.3329 | ASP | 0.792 | Plastic | 1.587 | 28.3 | −66.49 |
| 14 | | 13.6060 | ASP | 0.222 | | | | |
| 15 | Lens 7 | 7.7038 | ASP | 1.327 | Plastic | 1.544 | 56.0 | 13.72 |
| 16 | | −223.9782 | ASP | 0.977 | | | | |
| 17 | Lens 8 | −53.4682 | ASP | 0.843 | Plastic | 1.545 | 56.1 | −6.65 |
| 18 | | 3.9061 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.335 | | | | |
| 21 | Image | Plano | — | | | | |

Reference wavelength is 587.6 nm (d-line).
Effective radius of Surface 8 (stop S1) is 2.317 mm.

TABLE 5B
Aspheric Coefficients

| Surface # | 2 | 3 | 4 | 5 |
|---|---|---|---|---|
| k= | 5.49485000E−03 | −9.70821000E+01 | 3.56718000E+00 | −4.11926000E+00 |
| A4= | 4.62073023E−04 | −6.96379048E−03 | −1.05467581E−02 | −1.26513042E−03 |
| A6= | 2.17913679E−05 | 5.23022224E−03 | 4.23751968E−03 | −1.00219744E−03 |
| A8= | 2.57544370E−05 | −2.81108164E−03 | −2.28355435E−03 | 1.31840845E−03 |
| A10= | −1.70078509E−05 | 1.16876566E−03 | 1.09941367E−03 | −1.03399475E−03 |
| A12= | 7.10712231E−06 | −3.48965553E−04 | −3.76128560E−04 | 5.94490819E−04 |
| A14= | −1.83769691E−06 | 7.18970995E−05 | 8.81211946E−05 | −2.25927736E−04 |
| A16= | 3.00594353E−07 | −9.91479688E−06 | −1.37730213E−05 | 5.54787421E−05 |
| A18= | −3.03264638E−08 | 8.70946249E−07 | 1.37086788E−06 | −8.45444803E−06 |
| A20= | 1.71681089E−09 | −4.39652861E−08 | −7.84300466E−08 | 7.27968774E−07 |
| A22= | −4.21022025E−11 | 9.69062770E−10 | 1.95911718E−09 | −2.70865832E−08 |
| Surface # | 6 | 7 | 9 | 10 |
| k= | −1.33709000E+00 | 1.59925000E+01 | 6.04621000E+01 | −9.90000000E+01 |
| A4= | −1.48477804E−03 | −4.95975644E−03 | −9.45267544E−03 | −1.07404257E−02 |
| A6= | −2.20186545E−03 | −1.69346354E−03 | 2.05479351E−03 | 1.89070366E−03 |
| A8= | 3.23885046E−03 | 5.40345566E−03 | −1.93511764E−03 | −1.35682645E−03 |
| A10= | −3.46037312E−03 | −9.50305564E−03 | 1.25865626E−03 | 8.30516632E−04 |
| A12= | 1.90974139E−03 | 1.06297618E−02 | −5.98059752E−04 | −3.61750827E−04 |
| A14= | −1.73149328E−04 | −8.20308839E−03 | 1.92218980E−04 | 1.05007694E−04 |
| A16= | −5.08819224E−04 | 4.50573247E−03 | −4.03929567E−05 | −1.98054390E−05 |
| A18= | 4.02754758E−04 | −1.78356547E−03 | 5.27770697E−06 | 2.32697640E−06 |
| A20= | −1.63743297E−04 | 5.09290920E−04 | −3.83648279E−07 | −1.53475604E−07 |
| A22= | 4.18934286E−05 | −1.03797390E−04 | 1.17181357E−08 | 4.29980287E−09 |
| A24= | −6.98782044E−06 | 1.47087953E−05 | | |
| A26= | 7.40480111E−07 | −1.37554901E−06 | | |
| A28= | −4.53929325E−08 | 7.62633582E−08 | | |
| A30= | 1.22790545E−09 | −1.89723188E−09 | | |
| Surface # | 11 | 12 | 13 | 14 |
| k= | −3.50630000E+01 | 1.31003000E+01 | 2.58295000E+01 | 6.30542000E−01 |
| A4= | −1.25954331E−02 | −1.47086229E−02 | −9.40520920E−03 | 7.25694504E−03 |
| A6= | 2.13128613E−03 | 4.55933908E−04 | −1.90445906E−03 | −1.03336482E−02 |
| A8= | −1.17916498E−03 | 1.06532223E−03 | 8.77064230E−04 | 4.86463975E−03 |
| A10= | 6.03669674E−04 | −7.34317152E−04 | 3.41422197E−05 | −1.48872540E−03 |
| A12= | −1.98070719E−04 | 3.50160889E−04 | −1.19270276E−04 | 3.21202254E−04 |
| A14= | 3.58837331E−05 | −1.24612445E−04 | 4.62258758E−05 | −5.01307779E−05 |
| A16= | −1.34538006E−06 | 3.25916708E−05 | −1.02827660E−05 | 5.73679901E−06 |
| A18= | −9.39001429E−07 | −6.22150013E−06 | 1.51396810E−06 | −4.84653469E−07 |
| A20= | 2.36154945E−07 | 8.60710290E−07 | −1.52212457E−07 | 3.01734864E−08 |
| A22= | −2.68067997E−08 | −8.50104261E−08 | 1.03544288E−08 | −1.36647185E−09 |
| A24= | 1.55295147E−09 | 5.82152907E−09 | −4.55985858E−10 | 4.37436568E−11 |
| A26= | −3.71998305E−11 | −2.61642837E−10 | 1.17241535E−11 | −9.37355738E−13 |
| A28= | | 6.91232508E−12 | −1.33471926E−13 | 1.20544737E−14 |
| A30= | | −8.09444596E−14 | | −7.03050693E−17 |
| Surface # | 15 | 16 | 17 | 18 |
| k= | −1.35254000E+00 | −9.88647000E+01 | 3.83160000E+01 | −9.31919000E−01 |
| A4= | 7.50941345E−03 | 8.61696207E−04 | −2.69785103E−02 | −2.84171614E−02 |
| A6= | −8.03914072E−03 | −1.05086747E−03 | 3.86013462E−03 | 5.02780076E−03 |
| A8= | 3.61092103E−03 | 5.33268569E−04 | −1.02108891E−04 | −6.91899499E−04 |
| A10= | −1.09847791E−03 | −1.43660738E−04 | −7.72644218E−05 | 6.98168419E−05 |
| A12= | 2.35571979E−04 | 2.27396086E−05 | 1.84117870E−05 | −5.12308338E−06 |
| A14= | −3.69789187E−05 | −2.30580954E−06 | −2.22916716E−06 | 2.75276893E−07 |
| A16= | 4.33385118E−06 | 1.57528910E−07 | 1.71151049E−07 | −1.09016291E−08 |
| A18= | −3.80629080E−07 | −7.43440278E−09 | −8.92329125E−09 | 3.17574987E−10 |
| A20= | 2.48404060E−08 | 2.43598387E−10 | 3.24492797E−10 | −6.71040982E−12 |
| A22= | −1.18162880E−09 | −5.45609227E−12 | −8.25972677E−12 | 9.97690442E−14 |
| A24= | 3.96437913E−11 | 7.98732730E−14 | 1.44585541E−13 | −9.86143856E−16 |
| A26= | −8.86241901E−13 | −6.90050381E−16 | −1.66095417E−15 | 5.79570911E−18 |
| A28= | 1.18228910E−14 | 2.67203418E−18 | 1.12881435E−17 | −1.52698894E−20 |
| A30= | −7.10981702E−17 | | −3.44309652E−20 | |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 5A and Table 5B as the following values and satisfy the following conditions in Table 5C:

TABLE 5C
5th Embodiment

| | | | |
|---|---|---|---|
| f [mm] | 9.52 | (R14 + R16)/(R14 − R16) | 0.97 |
| Fno | 1.60 | R16/CT4 | 4.41 |
| HFOV [degrees] | 38.7 | CT1/CT5 | 1.16 |
| TL/ImgH | 1.53 | CT4/T34 | 3.14 |
| TL/f | 1.29 | CT3/(CT4 + CT5) | 0.20 |
| TL/BL | 9.67 | CT5/(CT6 + CT7) | 0.68 |
| \|f1/f2\| | 0.37 | T67/T78 | 0.23 |
| \|f2/f6\| | 0.35 | ΣCT/ΣAT | 2.46 |
| f3/f7 | −3.40 | ET6/CT6 | 1.79 |
| f7/f8 | −2.06 | \|Sag7R1\|/CT7 | 0.43 |
| f/f67 | 0.54 | (T78 − Sag7R2 + | 0.42 |
| | | Sag8R1)/T78 | |
| \|f/f4\| + \|f/f5\| + \|f/f6\| | 0.65 | V4 + V6 | 68.7 |
| (\|f/f5\| + \|f/f6\|)/ | 0.14 | V5/V1 | 1.0 |
| (\|f/f7\| + \|f/f8\|) | | | |
| \|f/R9\| + \|f/R10\| | 1.11 | Vmin | 18.4 |
| \|f/R13\| + \|f/R14\| | 1.28 | V1/N1 | 36.3 |
| f1/\|R2\| | 0.16 | V2/N2 | 10.9 |
| f1/CT1 | 5.20 | V3/N3 | 17.8 |
| 10 × CT2/f2 | −0.19 | V4/N4 | 25.9 |
| R1/R11 | 0.21 | V5/N5 | 36.5 |
| (R4 + R14)/(R4 − R14) | −0.95 | V6/N6 | 17.8 |
| (R13 + R14)/(R13 − R14) | −0.93 | V7/N7 | 36.3 |
| (R12 + R16)/(R12 − R16) | 1.81 | V8/N8 | 36.3 |

### 6th Embodiment

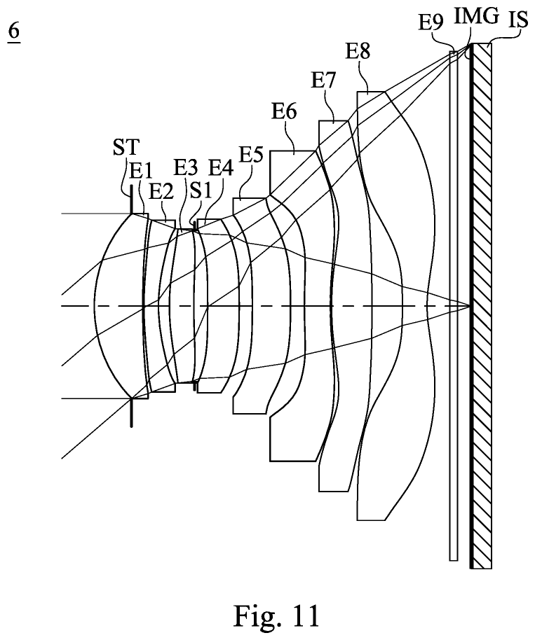

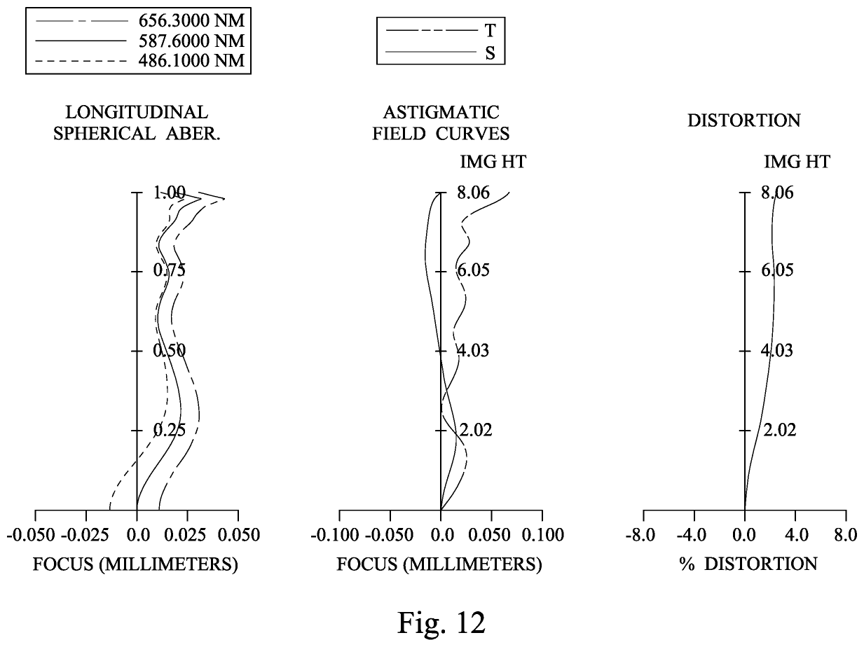

FIG. 11 is a schematic view of an imaging apparatus 6 according to the 6th embodiment of the present disclosure. FIG. 12 shows spherical aberration curves, astigmatic field curves and a distortion curve of the imaging apparatus 6 according to the 6th embodiment. In FIG. 11, the imaging apparatus 6 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point, and the image-side surface of the third lens element E3 includes one inflection point and one critical point.

The fourth lens element E4 with positive refractive power has an object-side surface being concave in a paraxial region thereof and an image-side surface being convex in a paraxial region thereof. The fourth lens element E4 is made of a plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with negative refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes three inflection points and one critical point.

The seventh lens element E7 with positive refractive power has an object-side surface being convex in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes three inflection points and one critical point, and the image-side surface of the seventh lens element E7 includes two inflection points.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points, and the image-side surface of the eighth lens element E8 includes three inflection points and one critical point.

The filter E9 is made of a glass material, which is located between the eighth lens element E8 and the image surface IMG in order, and will not affect the focal length of the photographing system lens assembly.

The detailed optical data of the 6th embodiment are shown in Table 6A and the aspheric surface data are shown in Table 6B below.

TABLE 6A
6th Embodiment
f = 9.13 mm, Fno = 1.60, HFOV = 40.7 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.144 | | | | |
| 2 | Lens 1 | 4.2413 | ASP | 1.488 | Plastic | 1.545 | 56.1 | 9.16 |
| 3 | | 24.7691 | ASP | 0.035 | | | | |
| 4 | Lens 2 | 9.5097 | ASP | 0.450 | Plastic | 1.669 | 19.5 | −16.20 |
| 5 | | 4.9698 | ASP | 0.337 | | | | |
| 6 | Lens 3 | 7.4973 | ASP | 0.748 | Plastic | 1.544 | 56.0 | 22.59 |
| 7 | | 18.5468 | ASP | 0.026 | | | | |
| 8 | Stop | Plano | | 0.401 | | | | |
| 9 | Lens 4 | −91.8675 | ASP | 0.970 | Plastic | 1.669 | 19.5 | 72.27 |
| 10 | | −31.8132 | ASP | 0.404 | | | | |
| 11 | Lens 5 | −45.6636 | ASP | 1.174 | Plastic | 1.544 | 56.0 | 304.93 |
| 12 | | −36.1318 | ASP | 0.426 | | | | |
| 13 | Lens 6 | 15.0230 | ASP | 0.802 | Plastic | 1.669 | 19.5 | −162.72 |
| 14 | | 12.9188 | ASP | 0.037 | | | | |
| 15 | Lens 7 | 9.3610 | ASP | 1.239 | Plastic | 1.544 | 56.0 | 15.38 |
| 16 | | −75.1889 | ASP | 0.935 | | | | |
| 17 | Lens 8 | −26.3038 | ASP | 0.760 | Plastic | 1.545 | 56.1 | −6.43 |
| 18 | | 4.0830 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.428 | | | | |
| 21 | Image | Plano | — | | | | |

Reference wavelength is 587.6 nm (d-line).
Effective radius of Surface 8 (stop S1) is 2.345 mm

TABLE 6B
Aspheric Coefficients

| Surface # | 2 | 3 | 4 | 5 |
|---|---|---|---|---|
| k= | 0.00000000E+00 | 0.00000000E+00 | 0.00000000E+00 | −5.59566000E+00 |
| A4= | 4.68231385E−04 | −2.04264714E−03 | −8.71652323E−03 | −1.44102847E−03 |
| A6= | −2.95754989E−04 | 2.45599137E−03 | 2.61950701E−03 | −8.58498529E−04 |
| A8= | 4.23543985E−04 | −2.59116153E−03 | −2.63993034E−03 | 6.23236334E−04 |
| A10= | −2.92704784E−04 | 1.76618445E−03 | 2.01806866E−03 | −2.87128407E−04 |
| A12= | 1.22681357E−04 | −7.35318477E−04 | −9.05845469E−04 | 1.25840551E−04 |
| A14= | −3.23432382E−05 | 1.93659045E−04 | 2.52691277E−04 | −4.34285451E−05 |
| A16= | 5.40829829E−06 | −3.25523413E−05 | −4.45856871E−05 | 1.06633379E−05 |
| A18= | −5.56476166E−07 | 3.38852933E−06 | 4.84945729E−06 | −1.67863036E−06 |
| A20= | 3.21370052E−08 | −1.98777088E−07 | −2.96538957E−07 | 1.52528615E−07 |
| A22= | −7.98158840E−10 | 5.00803256E−09 | 7.78110240E−09 | −6.04770104E−09 |
| Surface # | 6 | 7 | 9 | 10 |
| k= | 0.00000000E+00 | 0.00000000E+00 | 0.00000000E+00 | 0.00000000E+00 |
| A4= | −9.35670434E−04 | −3.11670117E−03 | −7.66167483E−03 | −1.06485686E−02 |
| A6= | −3.10085847E−04 | −6.49673874E−04 | −6.24120774E−04 | 2.71681342E−03 |
| A8= | −6.46045539E−04 | 1.21198908E−04 | 2.41265926E−04 | −3.35135627E−03 |
| A10= | 5.00031760E−04 | −1.01313078E−04 | −2.38839483E−04 | 2.25945691E−03 |
| A12= | −2.34711776E−04 | 2.77885201E−05 | 1.50527595E−04 | −9.59020420E−04 |
| A14= | 6.95679455E−05 | −2.84333442E−07 | −5.72985277E−05 | 2.66248718E−04 |
| A16= | −1.26286374E−05 | −1.79349684E−06 | 1.35179509E−05 | −4.79282806E−05 |
| A18= | 1.33116865E−06 | 5.36130607E−07 | −1.87079824E−06 | 5.37907966E−06 |
| A20= | −6.81843825E−08 | −7.04361812E−08 | 1.35189869E−07 | −3.41960292E−07 |
| A22= | 8.19011470E−10 | 3.53007528E−09 | −3.75205729E−09 | 9.41327146E−09 |
| Surface # | 11 | 12 | 13 | 14 |
| k= | 0.00000000E+00 | 0.00000000E+00 | 0.00000000E+00 | 0.00000000E+00 |
| A4= | −1.39669428E−02 | −1.75322588E−02 | −1.36631822E−02 | −1.14561510E−02 |
| A6= | 1.04327349E−02 | 4.11512617E−03 | 4.51267046E−03 | 1.45376737E−02 |
| A8= | −1.18617719E−02 | −1.91497137E−03 | −3.20192504E−03 | −8.10858584E−03 |
| A10= | 8.71189756E−03 | 7.43639618E−04 | 1.37691690E−03 | 2.36596499E−03 |
| A12= | −4.38642789E−03 | −2.41905823E−04 | −4.64098676E−04 | −4.30288302E−04 |
| A14= | 1.55070529E−03 | 7.86423481E−05 | 1.34816661E−04 | 5.28391014E−05 |
| A16= | −3.86807966E−04 | −2.21040505E−05 | −3.07012164E−05 | −4.54824102E−06 |
| A18= | 6.76053498E−05 | 4.50328765E−06 | 5.01914957E−06 | 2.77942908E−07 |
| A20= | −8.09376531E−06 | −6.20269837E−07 | −5.66519666E−07 | −1.19877644E−08 |
| A22= | 6.31817671E−07 | 5.56423905E−08 | 4.29274815E−08 | 3.55764353E−10 |
| A24= | −2.89449489E−08 | −3.05137558E−09 | −2.08345969E−09 | −6.87808153E−12 |
| A26= | 5.89518941E−10 | 8.67872283E−11 | 5.85447120E−11 | 7.70414288E−14 |
| A28= | | −5.43983951E−13 | −7.25020947E−13 | −3.57765491E−16 |
| A30= | | −1.92031115E−14 | | −3.73224585E−19 |
| Surface # | 15 | 16 | 17 | 18 |
| k= | 0.00000000E+00 | 0.00000000E+00 | 0.00000000E+00 | −1.00000000E+00 |
| A4= | −1.11527443E−02 | 2.51486681E−03 | −2.48123978E−02 | −2.92713105E−02 |
| A6= | 1.20789593E−02 | −3.19759303E−03 | 2.65178245E−03 | 5.15218392E−03 |
| A8= | −6.18550826E−03 | 1.20477720E−03 | −6.31031145E−05 | −7.71046145E−04 |
| A10= | 1.73258609E−03 | −2.44951038E−04 | −1.59429214E−05 | 9.13254689E−05 |
| A12= | −3.11082589E−04 | 3.17231406E−05 | 3.18762057E−06 | −8.22717351E−06 |
| A14= | 3.82019195E−05 | −2.85555995E−06 | −3.47567876E−07 | 5.50409461E−07 |
| A16= | −3.31266391E−06 | 1.85849833E−07 | 2.46494598E−08 | −2.69906099E−08 |
| A18= | 2.05350625E−07 | −8.82295397E−09 | −1.17191503E−09 | 9.60131264E−10 |
| A20= | −9.05569644E−09 | 3.01977994E−10 | 3.75571464E−11 | −2.44020574E−11 |
| A22= | 2.77278335E−10 | −7.23303606E−12 | −7.96525185E−13 | 4.30896308E−13 |
| A24= | −5.58944432E−12 | 1.14699989E−13 | 1.05365717E−14 | −5.01446831E−15 |
| A26= | 6.62482657E−14 | −1.07931721E−15 | −7.38712489E−17 | 3.45368083E−17 |
| A28= | −3.38674044E−16 | 4.55513320E−18 | 1.18780009E−19 | −1.06531065E−19 |
| A30= | −2.06270241E−19 | | 1.02749516E−21 | |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 6A and Table 6B as the following values and satisfy the following conditions in Table 6C:

TABLE 6C
6th Embodiment

| | | | |
|---|---|---|---|
| f [mm] | 9.13 | (R14 + R16)/(R14 − R16) | 0.90 |
| Fno | 1.60 | R16/CT4 | 4.21 |
| HFOV [degrees] | 40.7 | CT1/CT5 | 1.27 |
| TL/ImgH | 1.44 | CT4/T34 | 2.27 |
| TL/f | 1.27 | CT3/(CT4 + CT5) | 0.35 |
| TL/BL | 8.48 | CT5/(CT6 + CT7) | 0.58 |
| \|f1/f2\| | 0.57 | T67/T78 | 0.04 |
| \|f2/f6\| | 0.10 | ΣCT/ΣAT | 2.93 |
| f3/f7 | 1.47 | ET6/CT6 | 1.75 |
| f7/f8 | −2.39 | \|Sag7R1\|/CT7 | 0.32 |
| f/f67 | 0.53 | (T78 − Sag7R2 + | 0.31 |
| | | Sag8R1)/T78 | |
| \|f/f4\| + \|f/f5\| + \|f/f6\| | 0.21 | V4 + V6 | 39.0 |
| (\|f/f5\| + \|f/f6\|)/ | 0.04 | V5/V1 | 1.0 |
| (\|f/f7\| + \|f/f8\|) | | | |
| \|f/R9\| + \|f/R10\| | 0.45 | Vmin | 19.5 |
| \|f/R13\| + \|f/R14\| | 1.10 | V1/N1 | 36.3 |
| f1/\|R2\| | 0.37 | V2/N2 | 11.7 |
| f1/CT1 | 6.15 | V3/N3 | 36.3 |
| 10 × CT2/f2 | −0.28 | V4/N4 | 11.7 |
| R1/R11 | 0.28 | V5/N5 | 36.3 |
| (R4 + R14)/(R4 − R14) | −0.88 | V6/N6 | 11.7 |
| (R13 + R14)/(R13 − R14) | −0.78 | V7/N7 | 36.3 |
| (R12 + R16)/(R12 − R16) | 1.92 | V8/N8 | 36.3 |

### 7th Embodiment

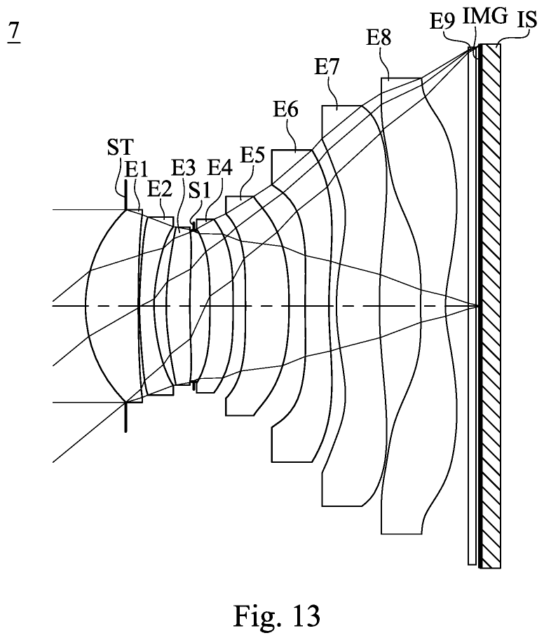

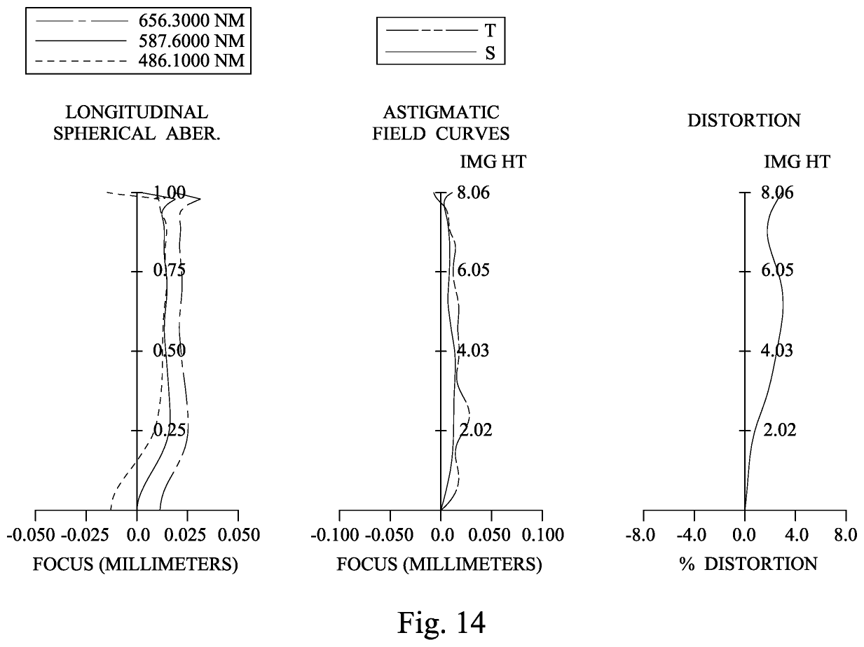

FIG. 13 is a schematic view of an imaging apparatus 7 according to the 7th embodiment of the present disclosure. FIG. 14 shows spherical aberration curves, astigmatic field curves and a distortion curve of the imaging apparatus 7 according to the 7th embodiment. In FIG. 13, the imaging apparatus 7 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a glass material, and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point, and the image-side surface of the third lens element E3 includes one inflection point and one critical point.

The fourth lens element E4 with negative refractive power has an object-side surface being concave in a paraxial region thereof and an image-side surface being convex in a paraxial region thereof. The fourth lens element E4 is made of a plastic material, and has the object-side surface and the image-side surface being both aspheric.

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with negative refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes two inflection points and one critical point.

The seventh lens element E7 with positive refractive power has an object-side surface being convex in a paraxial region thereof and an image-side surface being concave in a paraxial region thereof. The seventh lens element E7 is made of a plastic material, and has the object-side surface and the image-side surface being both aspheric. Furthermore, the object-side surface of the seventh lens element E7 includes five inflection points and one critical point, and the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes six inflection points and one critical point, and the image-side surface of the eighth lens element E8 includes two inflection points and one critical point.

The filter E9 is made of a glass material, which is located between the eighth lens element E8 and the image surface IMG in order, and will not affect the focal length of the photographing system lens assembly.

The detailed optical data of the 7th embodiment are shown in Table 7A and the aspheric surface data are shown in Table 7B below.

TABLE 7A
7th Embodiment
f = 9.49 mm, Fno = 1.60, HFOV = 39.5 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.237 | | | | |
| 2 | Lens 1 | 4.2467 | ASP | 1.625 | Glass | 1.523 | 58.7 | 9.00 |
| 3 | | 37.8344 | ASP | 0.035 | | | | |
| 4 | Lens 2 | 10.4911 | ASP | 0.450 | Plastic | 1.639 | 23.5 | −15.41 |
| 5 | | 4.9925 | ASP | 0.374 | | | | |
| 6 | Lens 3 | 8.2161 | ASP | 0.726 | Plastic | 1.544 | 56.0 | 25.38 |
| 7 | | 19.6612 | ASP | 0.122 | | | | |
| 8 | Stop | Plano | | 0.497 | | | | |
| 9 | Lens 4 | −29.7253 | ASP | 0.713 | Plastic | 1.587 | 28.3 | −227.61 |
| 10 | | −38.5661 | ASP | 0.380 | | | | |
| 11 | Lens 5 | −120.9061 | ASP | 1.340 | Plastic | 1.544 | 56.0 | 36.18 |
| 12 | | −16.9945 | ASP | 0.493 | | | | |
| 13 | Lens 6 | 20.0830 | ASP | 0.732 | Plastic | 1.614 | 25.6 | −93.72 |
| 14 | | 14.6788 | ASP | 0.233 | | | | |
| 15 | Lens 7 | 7.9043 | ASP | 1.321 | Plastic | 1.534 | 56.0 | 27.13 |
| 16 | | 16.3706 | ASP | 1.270 | | | | |
| 17 | Lens 8 | 26.3158 | ASP | 0.760 | Plastic | 1.534 | 56.0 | −7.96 |
| 18 | | 3.6253 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.133 | | | | |
| 21 | Image | Plano | — | | | | |

Reference wavelength is 587.6 nm (d-line).
Effective radius of Surface 8 (stop S1) 2.329 mm.

TABLE 7B
Aspheric Coefficients

| Surface # | 2 | 3 | 4 | 5 |
|---|---|---|---|---|
| k= | −3.70724000E−02 | −2.19300000E+01 | 2.01457000E+00 | −4.20909000E+00 |
| A4= | 3.75680863E−04 | −4.02569269E−03 | −1.03080805E−02 | −2.12718210E−03 |
| A6= | 1.06066682E−04 | 2.63924928E−03 | 2.73974220E−03 | −4.06261279E−04 |
| A8= | −5.83592301E−05 | −8.96476436E−04 | −5.90505057E−04 | 1.04950991E−03 |
| A10= | 2.58465485E−05 | 1.57666089E−04 | 5.33447151E−05 | −7.55459408E−04 |
| A12= | −6.78250736E−06 | 8.77512301E−06 | 2.98688860E−05 | 3.71253335E−04 |
| A14= | 1.12467940E−06 | −1.21151144E−05 | −1.51361058E−05 | −1.21788637E−04 |
| A16= | −1.17698682E−07 | 3.01418563E−06 | 3.40269993E−06 | 2.63087207E−05 |
| A18= | 7.51662757E−09 | −3.80988676E−07 | −4.27454640E−07 | −3.57189694E−06 |
| A20= | −2.78542079E−10 | 2.51754882E−08 | 2.89634070E−08 | 2.76312913E−07 |
| A22= | 4.76047848E−12 | −6.90022453E−10 | −8.25243189E−10 | −9.28704367E−09 |
| Surface # | 6 | 7 | 9 | 10 |
| k= | 2.98425000E+00 | 4.06249000E+01 | 9.73334000E+01 | 9.90000000E+01 |
| A4= | −1.03701488E−03 | −3.10514907E−03 | −9.59283306E−03 | −1.23415282E−02 |
| A6= | −6.76016036E−04 | 8.60170704E−05 | 1.53296635E−03 | 1.78405543E−03 |
| A8= | 1.25853327E−04 | −7.28387721E−04 | −1.79092182E−03 | −1.10684898E−03 |
| A10= | −9.62099258E−05 | 5.96312093E−04 | 1.20914015E−03 | 5.11300670E−04 |
| A12= | 6.54822384E−05 | −3.19863556E−04 | −5.60905610E−04 | −1.74419861E−04 |
| A14= | −2.77673088E−05 | 1.11215825E−04 | 1.78179084E−04 | 4.35755189E−05 |
| A16= | 7.47401261E−06 | −2.48309789E−05 | −3.76796913E−05 | −7.47245733E−06 |
| A18= | −1.22116412E−06 | 3.44832814E−06 | 5.07847656E−06 | 8.21627302E−07 |
| A20= | 1.11045691E−07 | −2.71183467E−07 | −3.95035712E−07 | −5.21958526E−08 |
| A22= | −4.35097678E−09 | 9.17719869E−09 | 1.34728304E−08 | 1.46022345E−09 |
| Surface # | 11 | 12 | 13 | 14 |
| k= | −9.90000000E+01 | 1.57380000E+01 | 1.80777000E+01 | 9.36876000E−01 |
| A4= | −1.04320766E−02 | −1.29209242E−02 | −9.85031587E−03 | 4.46235381E−03 |
| A6= | 2.34718789E−03 | 8.30836524E−04 | −1.48533909E−03 | −7.28924617E−03 |
| A8= | −1.49301545E−03 | 1.11706969E−03 | 1.20770701E−03 | 3.47000365E−03 |
| A10= | 8.15571822E−04 | −8.07281701E−04 | −2.21339288E−04 | −1.08407854E−03 |
| A12= | −3.56410423E−04 | 3.25959997E−04 | −4.68467964E−05 | 2.37325452E−04 |
| A14= | 1.14000922E−04 | −9.11078215E−05 | 3.54424274E−05 | −3.71963402E−05 |
| A16= | −2.56649108E−05 | 1.83298000E−05 | −9.50732680E−06 | 4.23298914E−06 |
| A18= | 3.98093058E−06 | −2.66477207E−06 | 1.52349707E−06 | −3.52476604E−07 |
| A20= | −4.13962649E−07 | 2.76327696E−07 | −1.59640358E−07 | 2.14516138E−08 |
| A22= | 2.73172856E−08 | −1.98266368E−08 | 1.10609473E−08 | −9.42427275E−10 |
| A24= | −1.01815679E−09 | 9.27665289E−10 | −4.89362194E−10 | 2.90632248E−11 |
| A26= | 1.58746437E−11 | −2.49356562E−11 | 1.25298644E−11 | −5.96184326E−13 |
| A28= | | 2.61118463E−13 | −1.41200335E−13 | 7.29809906E−15 |
| A30= | | 1.31615444E−15 | | −4.03095276E−17 |
| Surface # | 15 | 16 | 17 | 18 |
| k= | −8.07756000E−01 | −4.43339000E+01 | −9.90000000E+01 | −1.00696000E+00 |
| A4= | 3.58438133E−03 | −1.19707126E−03 | −3.41067224E−02 | −3.57226414E−02 |
| A6= | −4.21145328E−03 | 1.23826563E−03 | 8.68852542E−03 | 7.78850892E−03 |
| A8= | 1.58583448E−03 | −4.04865509E−04 | −1.63912613E−03 | −1.25448353E−03 |
| A10= | −4.39129408E−04 | 6.52907304E−05 | 2.11364694E−04 | 1.42587621E−04 |
| A12= | 8.58989163E−05 | −6.32859063E−06 | −1.78211067E−05 | −1.16310118E−05 |
| A14= | −1.19076862E−05 | 3.95877440E−07 | 9.73098090E−07 | 6.92855938E−07 |
| A16= | 1.18869663E−06 | −1.62149447E−08 | −3.25159670E−08 | −3.03618010E−08 |
| A18= | −8.64822759E−08 | 4.15930456E−10 | 4.77521580E−10 | 9.74979602E−10 |
| A20= | 4.59788990E−09 | −5.39388100E−12 | 9.83039361E−12 | −2.25925704E−11 |
| A22= | −1.76887138E−10 | −1.81078525E−14 | −7.06515407E−13 | 3.66484530E−13 |
| A24= | 4.79444101E−12 | 1.86175362E−15 | 1.79052011E−14 | −3.93700864E−15 |
| A26= | −8.67805968E−14 | −2.73320757E−17 | −2.51405896E−16 | 2.50992944E−17 |
| A28= | 9.40688253E−16 | 1.42568757E−19 | 1.93731347E−18 | −7.17487163E−20 |
| A30= | −4.61441025E−18 | | −6.42974129E−21 | |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 7A and Table 7B as the following values and satisfy the following conditions in Table 7C:

TABLE 7C
7th Embodiment

| | | | |
|---|---|---|---|
| f [mm] | 9.49 | (R14 + R16)/(R14 − R16) | 1.57 |
| Fno | 1.60 | R16/CT4 | 5.08 |
| HFOV [degrees] | 39.5 | CT1/CT5 | 1.21 |
| TL/ImgH | 1.51 | CT4/T34 | 1.15 |
| TL/f | 1.28 | CT3/(CT4 + CT5) | 0.35 |
| TL/BL | 11.32 | CT5/(CT6 + CT7) | 0.65 |
| \|f1/f2\| | 0.58 | T67/T78 | 0.18 |
| \|f2/f6\| | 0.16 | ΣCT/ΣAT | 2.25 |
| f3/f7 | 0.94 | ET6/CT6 | 1.69 |
| f7/f8 | −3.41 | \|Sag7R1\|/CT7 | 0.34 |
| f/f67 | 0.24 | (T78 − Sag7R2 + | 0.47 |
| | | Sag8R1)/T78 | |
| \|f/f4\| + \|f/f5\| + \|f/f6\| | 0.41 | V4 + V6 | 53.9 |
| (\|f/f5\| + \|f/f6\|)/ | 0.24 | V5/V1 | 1.0 |
| (\|f/f7\| + \|f/f8\|) | | | |
| \|f/R9\| + \|f/R10\| | 0.64 | Vmin | 23.5 |
| \|f/R13\| + \|f/R14\| | 1.78 | V1/N1 | 38.5 |
| f1/\|R2\| | 0.24 | V2/N2 | 14.3 |
| f1/CT1 | 5.54 | V3/N3 | 36.3 |
| 10 × CT2/f2 | −0.29 | V4/N4 | 17.8 |
| R1/R11 | 0.21 | V5/N5 | 36.3 |
| (R4 + R14)/(R4 − R14) | −1.88 | V6/N6 | 15.9 |
| (R13 + R14)/(R13 − R14) | −2.87 | V7/N7 | 36.5 |
| (R12 + R16)/(R12 − R16) | 1.66 | V8/N8 | 36.5 |

### 8th Embodiment

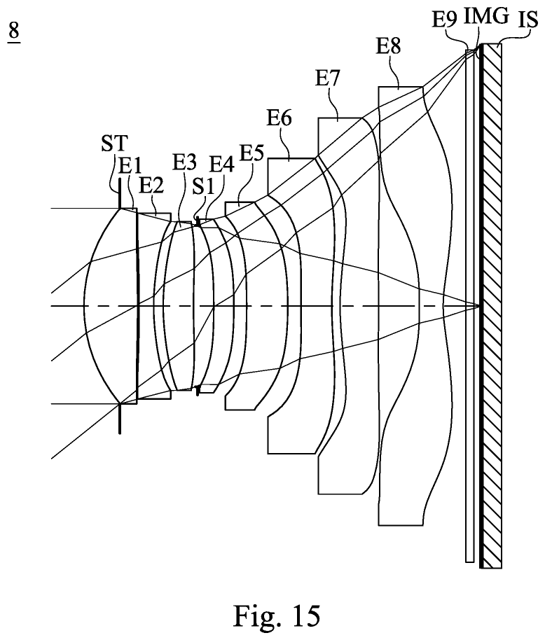

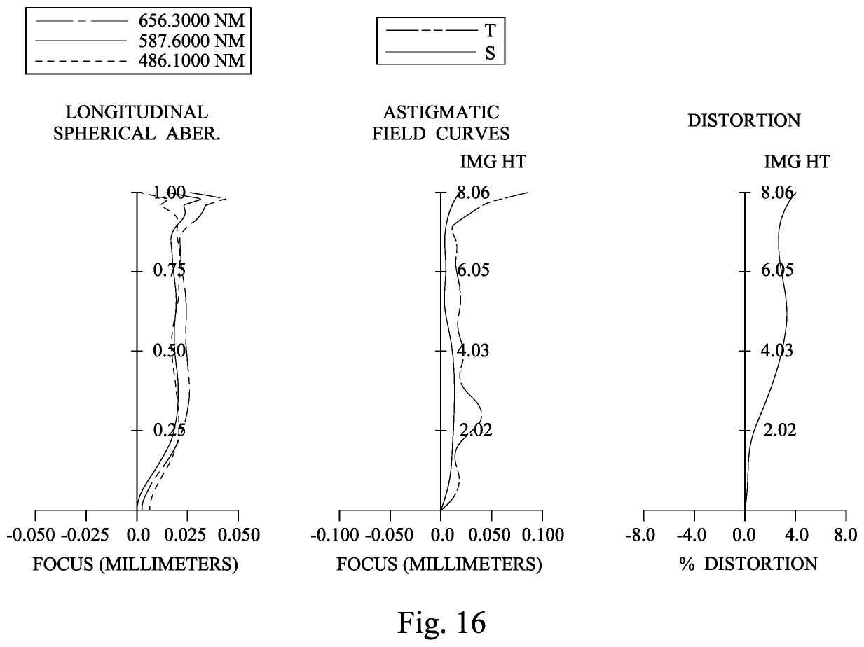

FIG. 15 is a schematic view of an imaging apparatus 8 according to the 8th embodiment of the present disclosure. FIG. 16 shows spherical aberration curves, astigmatic field curves and a distortion curve of the imaging apparatus 8 according to the 8th embodiment. In FIG. 15, the imaging apparatus 8 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being convex in a paraxial region thereof. The first lens element E1 is made of a plastic material, and has the object-side surface and the image-side surface being both aspheric. Furthermore, the image-side surface of the first lens element E1 includes two inflection points and two critical points.

The second lens element E2 with negative refractive power has an object-side surface being concave in a paraxial region thereof and an image-side surface being concave in a paraxial region thereof. The second lens element E2 is made of a plastic material, and has the object-side surface and the image-side surface being both aspheric. Furthermore, the object-side surface of the second lens element E2 includes two inflection points and one critical point.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point, and the image-side surface of the third lens element E3 includes one inflection point and one critical point.

The fourth lens element E4 with positive refractive power has an object-side surface being concave in a paraxial region thereof and an image-side surface being convex in a paraxial region thereof. The fourth lens element E4 is made of a plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with negative refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes two inflection points and one critical point.

The seventh lens element E7 with positive refractive power has an object-side surface being convex in a paraxial region thereof and an image-side surface being planar in a paraxial region thereof. The seventh lens element E7 is made of a plastic material, and has the object-side surface and the image-side surface being both aspheric. Furthermore, the object-side surface of the seventh lens element E7 includes three inflection points and one critical point, and the image-side surface of the seventh lens element E7 includes two inflection points and two critical points.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points and two critical points, and the image-side surface of the eighth lens element E8 includes three inflection points and one critical point.

The filter E9 is made of a glass material, which is located between the eighth lens element E8 and the image surface IMG in order, and will not affect the focal length of the photographing system lens assembly.

The detailed optical data of the 8th embodiment are shown in Table 8A and the aspheric surface data are shown in Table 8B below.

TABLE 8A
8th Embodiment
f = 9.63 mm, Fno = 1.60, HFOV = 38.8 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.106 | | | | |
| 2 | Lens 1 | 4.5854 | ASP | 1.651 | Plastic | 1.534 | 56.0 | 7.73 |
| 3 | | −36.2583 | ASP | 0.045 | | | | |
| 4 | Lens 2 | −66.6667 | ASP | 0.450 | Plastic | 1.614 | 25.6 | −10.19 |
| 5 | | 6.9193 | ASP | 0.294 | | | | |
| 6 | Lens 3 | 7.3560 | ASP | 0.934 | Plastic | 1.544 | 56.0 | 18.10 |
| 7 | | 27.7967 | ASP | 0.123 | | | | |
| 8 | Stop | Plano | | 0.498 | | | | |
| 9 | Lens 4 | −30.0546 | ASP | 0.619 | Plastic | 1.686 | 18.4 | 72.50 |
| 10 | | −18.8921 | ASP | 0.394 | | | | |
| 11 | Lens 5 | −37.6618 | ASP | 1.265 | Plastic | 1.544 | 56.0 | 44.37 |
| 12 | | −14.8841 | ASP | 0.407 | | | | |
| 13 | Lens 6 | 36.8056 | ASP | 0.949 | Plastic | 1.660 | 20.4 | −31.30 |
| 14 | | 13.0959 | ASP | 0.258 | | | | |
| 15 | Lens 7 | 10.6421 | ASP | 1.178 | Plastic | 1.534 | 56.0 | 19.92 |
| 16 | | Plano | ASP | 1.254 | | | | |
| 17 | Lens 8 | −44.2613 | ASP | 0.739 | Plastic | 1.544 | 56.0 | −6.93 |
| 18 | | 4.1447 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.235 | | | | |
| 21 | Image | Plano | — | | | | |

Reference wavelength is 587.6 nm (d-line).
Effective radius of Surface 8 (stop S1) is 2.486 mm.

TABLE 8B
Aspheric Coefficients

| Surface # | 2 | 3 | 4 | 5 |
|---|---|---|---|---|
| k= | −1.89412000E−01 | −9.90000000E+01 | −9.90000000E+01 | −5.47161000E+00 |
| A4= | 2.40703675E−04 | 3.49460102E−03 | −1.59255147E−03 | −5.05179664E−03 |
| A6= | −3.91427279E−05 | 1.30299492E−03 | 3.45591955E−03 | 2.49348184E−03 |
| A8= | 6.33222927E−05 | −2.58467071E−03 | −4.05397452E−03 | −1.17322484E−03 |
| A10= | −3.94531145E−05 | 1.48944640E−03 | 2.43449246E−03 | 2.62965596E−04 |
| A12= | 1.45926144E−05 | −4.90194923E−04 | −9.26240257E−04 | 1.51980548E−04 |
| A14= | −3.39272980E−06 | 1.03351094E−04 | 2.52122764E−04 | −1.46111762E−04 |
| A16= | 5.01491016E−07 | −1.41990151E−05 | −5.42850599E−05 | 5.87914185E−05 |
| A18= | −4.58509497E−08 | 1.22959267E−06 | 1.02397997E−05 | −1.42804979E−05 |
| A20= | 2.35946500E−09 | −6.08196166E−08 | −1.75785050E−06 | 2.22217172E−06 |
| A22= | −5.21007952E−11 | 1.30490209E−09 | 2.55228934E−07 | −2.17373208E−07 |
| A24= | | | −2.78857508E−08 | 1.21997057E−08 |
| A26= | | | 2.05657968E−09 | −2.99824274E−10 |
| A28= | | | −8.98061067E−11 | |
| A30= | | | 1.74404671E−12 | |
| Surface # | 6 | 7 | 9 | 10 |
| k= | 3.00430000E+00 | 9.87996000E+01 | −4.35686000E+01 | −2.32963000E+00 |
| A4= | −4.80610664E−03 | −4.24029067E−03 | −1.11295310E−02 | −1.33742509E−02 |
| A6= | 9.47538174E−04 | −1.17086080E−04 | 1.67732095E−03 | 2.41365058E−03 |
| A8= | −7.21027847E−04 | 3.72069673E−05 | −1.39296240E−03 | −1.41111916E−03 |
| A10= | 3.82724742E−04 | −6.97439717E−05 | 8.23316141E−04 | 7.30193676E−04 |
| A12= | −1.39352730E−04 | 2.45369575E−05 | −3.45245946E−04 | −2.81282259E−04 |
| A14= | 3.82165848E−05 | −9.37525531E−07 | 1.01465978E−04 | 7.62702363E−05 |
| A16= | −7.38570186E−06 | −1.33354459E−06 | −1.98725582E−05 | −1.37372264E−05 |
| A18= | 9.25960477E−07 | 3.57138433E−07 | 2.46196431E−06 | 1.55127340E−06 |
| A20= | −6.70713790E−08 | −3.88248552E−08 | −1.75245355E−07 | −9.93881771E−08 |
| A22= | 2.11119282E−09 | 1.60034563E−09 | 5.48853765E−09 | 2.76412718E−09 |
| Surface # | 11 | 12 | 13 | 14 |
| k= | 4.33905000E+01 | 1.00294000E+01 | 5.54727000E+01 | −1.15493000E+00 |
| A4= | −1.05447369E−02 | −1.08421238E−02 | −1.01113407E−02 | 2.36830391E−03 |
| A6= | 1.47325234E−03 | −2.07146261E−03 | −1.25883330E−03 | −7.77649598E−03 |
| A8= | −1.39138091E−04 | 4.33165248E−03 | 4.10814007E−04 | 4.24948989E−03 |
| A10= | −3.23904379E−04 | −3.43262172E−03 | 6.37035619E−04 | −1.44593037E−03 |
| A12= | 2.82085465E−04 | 1.84592000E−03 | −5.65690318E−04 | 3.36904694E−04 |
| A14= | −1.36509268E−04 | −7.23480848E−04 | 2.31546995E−04 | −5.58240763E−05 |
| A16= | 4.34901734E−05 | 2.08527012E−04 | −5.88470746E−05 | 6.72330809E−06 |
| A18= | −9.33771383E−06 | −4.41291703E−05 | 1.00380142E−05 | −5.94945168E−07 |
| A20= | 1.33342083E−06 | 6.81230982E−06 | −1.17330407E−06 | 3.86899458E−08 |
| A22= | −1.21285989E−07 | −7.56191255E−07 | 9.29417106E−08 | −1.82797255E−09 |
| A24= | 6.35921081E−09 | 5.86893424E−08 | −4.77349311E−09 | 6.10725388E−11 |
| A26= | −1.46313407E−10 | −3.02002071E−09 | 1.43402198E−10 | −1.36856053E−12 |
| A28= | | 9.25102178E−11 | −1.91113754E−12 | 1.84692021E−14 |
| A30= | | −1.27628181E−12 | | −1.13574424E−16 |
| Surface # | 15 | 16 | 17 | 18 |
| k= | −8.41388000E−01 | 1.41802000E+06 | 2.12484000E+01 | −8.99145000E−01 |
| A4= | 3.54172189E−03 | −2.19432857E−03 | −3.58713778E−02 | −3.63087943E−02 |
| A6= | −6.09908522E−03 | 1.26966115E−03 | 1.06841228E−02 | 8.84480429E−03 |
| A8= | 3.12083591E−03 | −2.75740681E−04 | −2.30536421E−03 | −1.55294634E−03 |
| A10= | −1.04878442E−03 | 2.74168752E−05 | 3.47861998E−04 | 1.89702463E−04 |
| A12= | 2.44822474E−04 | −8.23883620E−08 | −3.68955967E−05 | −1.64882589E−05 |
| A14= | −4.12674723E−05 | −3.09339240E−07 | 2.84459366E−06 | 1.03791434E−06 |
| A16= | 5.13123856E−06 | 3.99817958E−08 | −1.62880754E−07 | −4.77035385E−08 |
| A18= | −4.74075654E−07 | −2.73585685E−09 | 6.96627099E−09 | 1.59752029E−09 |
| A20= | 3.23778445E−08 | 1.17513991E−10 | −2.21095588E−10 | −3.84676955E−11 |
| A22= | −1.60731303E−09 | −3.27160733E−12 | 5.11712974E−12 | 6.47468413E−13 |
| A24= | 5.62152330E−11 | 5.75710129E−14 | −8.36780131E−14 | −7.21948883E−15 |
| A26= | −1.31040826E−12 | −5.84031498E−16 | 9.13976388E−16 | 4.78592866E−17 |
| A28= | 1.82546979E−14 | 2.60961761E−18 | −5.97266163E−18 | −1.42676071E−19 |
| A30= | −1.14913230E−16 | | 1.76361219E−20 | |

In the 8th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from Table 8A and Table 8B as the following values and satisfy the following conditions in Table 8C:

TABLE 8C
8th Embodiment

| | | | |
|---|---|---|---|
| f [mm] | 9.63 | (R14 + R16)/(R14 − R16) | 1.00 |
| Fno | 1.60 | R16/CT4 | 6.70 |
| HFOV [degrees] | 38.8 | CT1/CT5 | 1.31 |
| TL/ImgH | 1.52 | CT4/T34 | 1.00 |
| TL/f | 1.27 | CT3/(CT4 + CT5) | 0.50 |
| TL/BL | 10.41 | CT5/(CT6 + CT7) | 0.59 |
| \|f1/f2\| | 0.76 | T67/T78 | 0.21 |
| \|f2/f6\| | 0.33 | ΣCT/ΣAT | 2.38 |
| f3/f7 | 0.91 | ET6/CT6 | 1.53 |
| f7/f8 | −2.87 | \|Sag7R1\|/CT7 | 0.57 |
| f/f67 | 0.17 | (T78 − Sag7R2 + | 0.40 |
| | | Sag8R1)/T78 | |
| \|f/f4\| + \|f/f5\| + \|f/f6\| | 0.66 | V4 + V6 | 38.8 |
| (\|f/f5\| + \|f/f6\|)/ | 0.28 | V5/V1 | 1.0 |
| (\|f/f7\| + \|f/f8\|) | | | |
| \|f/R9\| + \|f/R10\| | 0.90 | Vmin | 18.4 |
| \|f/R13\| + \|f/R14\| | 0.91 | V1/N1 | 36.5 |
| f1/\|R2\| | 0.21 | V2/N2 | 15.9 |
| f1/CT1 | 4.68 | V3/N3 | 36.3 |
| 10 × CT2/f2 | −0.44 | V4/N4 | 10.9 |
| R1/R11 | 0.12 | V5/N5 | 36.3 |
| (R4 + R14)/(R4 − R14) | −1.00 | V6/N6 | 15.9 |
| (R13 + R14)/(R13 − R14) | −1.00 | V7/N7 | 36.5 |
| (R12 + R16)/(R12 − R16) | 1.93 | V8/N8 | 36.3 |

### 9th Embodiment

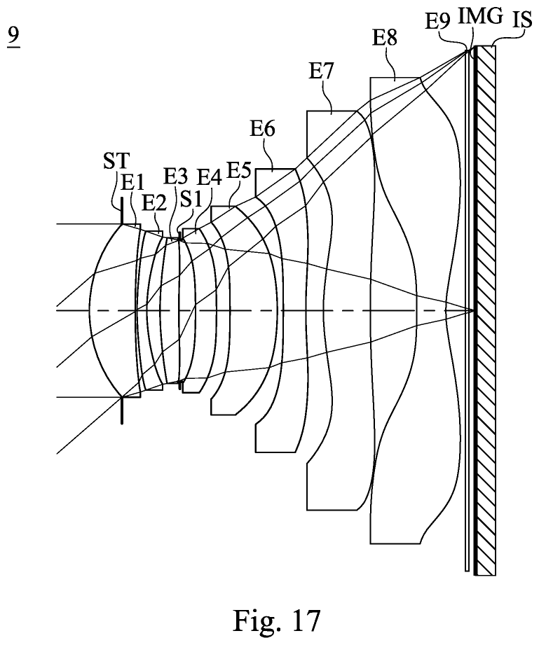

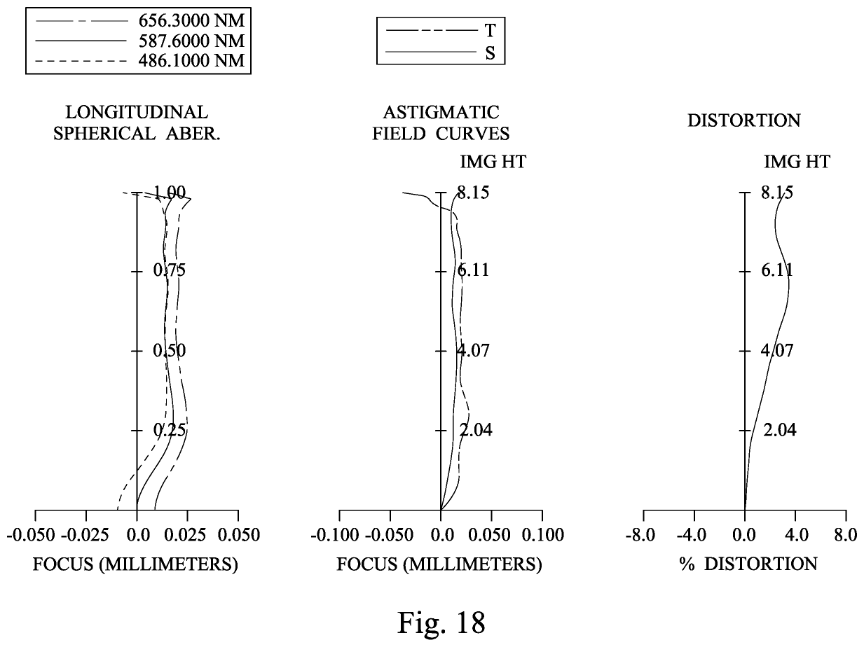

FIG. 17 is a schematic view of an imaging apparatus 9 according to the 9th embodiment of the present disclosure. FIG. 18 shows spherical aberration curves, astigmatic field curves and a distortion curve of the imaging apparatus 9 according to the 9th embodiment. In FIG. 17, the imaging apparatus 9 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the image-side surface of the third lens element E3 includes one inflection point and one critical point.

The fourth lens element E4 with negative refractive power has an object-side surface being concave in a paraxial region thereof and an image-side surface being convex in a paraxial region thereof. The fourth lens element E4 is made of a plastic material, and has the object-side surface and the image-side surface being both aspheric.

The fifth lens element E5 with positive refractive power has an object-side surface being concave in a paraxial region thereof and an image-side surface being convex in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with negative refractive power has an object-side surface being concave in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes one inflection point, and the image-side surface of the sixth lens element E6 includes two inflection points and one critical point.

The seventh lens element E7 with positive refractive power has an object-side surface being convex in a paraxial region thereof and an image-side surface being concave in a paraxial region thereof. The seventh lens element E7 is made of a plastic material, and has the object-side surface and the image-side surface being both aspheric. Furthermore, the object-side surface of the seventh lens element E7 includes two inflection points and one critical point, and the image-side surface of the seventh lens element E7 includes one inflection point and one critical point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes three inflection points, and the image-side surface of the eighth lens element E8 includes two inflection points and one critical point.

The filter E9 is made of a glass material, which is located between the eighth lens element E8 and the image surface IMG in order, and will not affect the focal length of the photographing system lens assembly.

The detailed optical data of the 9th embodiment are shown in Table 9A and the aspheric surface data are shown in Table 9B below.

TABLE 9A
9th Embodiment
f = 9.07 mm, Fno = 1.70, HFOV = 41.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −0.999 | | | | |
| 2 | Lens 1 | 4.1846 | ASP | 1.409 | Plastic | 1.534 | 56.0 | 9.29 |
| 3 | | 23.5900 | ASP | 0.057 | | | | |
| 4 | Lens 2 | 8.8034 | ASP | 0.300 | Plastic | 1.660 | 20.4 | −19.24 |
| 5 | | 5.1283 | ASP | 0.407 | | | | |
| 6 | Lens 3 | 10.3481 | ASP | 0.579 | Plastic | 1.544 | 56.0 | 30.63 |
| 7 | | 26.7652 | ASP | 0.031 | | | | |
| 8 | Stop | Plano | | 0.482 | | | | |
| 9 | Lens 4 | −24.5765 | ASP | 0.645 | Plastic | 1.566 | 37.4 | −345.54 |
| 10 | | −28.3750 | ASP | 0.416 | | | | |
| 11 | Lens 5 | −40.8210 | ASP | 1.454 | Plastic | 1.544 | 56.0 | 19.60 |
| 12 | | −8.5606 | ASP | 0.184 | | | | |
| 13 | Lens 6 | −90.9091 | ASP | 0.694 | Plastic | 1.587 | 28.3 | −25.23 |
| 14 | | 17.7486 | ASP | 0.542 | | | | |
| 15 | Lens 7 | 7.9359 | ASP | 1.443 | Plastic | 1.544 | 56.0 | 17.46 |
| 16 | | 45.0847 | ASP | 1.423 | | | | |
| 17 | Lens 8 | −75.0481 | ASP | 0.899 | Plastic | 1.534 | 56.0 | −6.93 |
| 18 | | 3.9116 | ASP | 0.600 | | | | |

| | | | | | | | |
|---|---|---|---|---|---|---|---|
| 19 | Filter | Plano | 0.110 | Glass | 1.517 | 64.2 | — |
| 20 | | Plano | 0.205 | | | | |
| 21 | Image | Plano | — | | | | |

Reference wavelength is 587.6 nm (d-line).
Effective radius of Surface 8 (stop S1) is 2.184 mm.

TABLE 9B
Aspheric Coefficients

| Surface # | 2 | 3 | 4 | 5 |
|---|---|---|---|---|
| k= | 2.66933000E−02 | 2.35099000E+01 | 3.14873000E+00 | −3.79420000E+00 |
| A4= | 4.29409654E−04 | −3.41875435E−03 | −1.15505376E−02 | −4.03822102E−03 |
| A6= | 1.97774680E−04 | 2.59893419E−03 | 3.46785199E−03 | 7.09379891E−04 |
| A8= | −1.28533586E−04 | −8.80270910E−04 | −8.67661678E−04 | 6.39814713E−04 |
| A10= | 6.10977317E−05 | −7.34001889E−06 | −9.73887958E−06 | −7.33284360E−04 |
| A12= | −1.54028444E−05 | 1.62882184E−04 | 1.61270523E−04 | 4.64688461E−04 |
| A14= | 1.61614472E−06 | −8.03349649E−05 | −8.17036730E−05 | −1.81441679E−04 |
| A16= | 1.31833658E−07 | 2.02515636E−05 | 2.13517244E−05 | 4.50651538E−05 |
| A18= | −5.59222809E−08 | −2.92970774E−06 | −3.21479427E−06 | −6.92034775E−06 |
| A20= | 5.75103313E−09 | 2.30944964E−07 | 2.64415664E−07 | 6.00436565E−07 |
| A22= | −2.07410880E−10 | −7.70142829E−09 | −9.21411940E−09 | −2.25374880E−08 |
| Surface # | 6 | 7 | 9 | 10 |
| k= | 8.14921000E+00 | 9.65089000E+01 | 9.04992000E+01 | 7.24811000E+01 |
| A4= | −9.16156077E−04 | −2.91150628E−03 | −9.95199866E−03 | −1.16654838E−02 |
| A6= | −6.27401947E−04 | −6.31156987E−04 | 9.43468387E−04 | 1.12342081E−03 |
| A8= | 8.47384437E−05 | 2.22545300E−04 | −1.11672529E−03 | −8.41493221E−04 |
| A10= | −9.86653095E−05 | −2.54059531E−04 | 5.60363203E−04 | 4.23000222E−04 |
| A12= | 7.97735864E−05 | 1.63827520E−04 | −1.52039001E−04 | −1.53877796E−04 |
| A14= | −3.58076373E−05 | −6.77558030E−05 | 9.89960469E−06 | 4.17966315E−05 |
| A16= | 1.04119675E−05 | 1.87051686E−05 | 7.34615984E−06 | −7.79494299E−06 |
| A18= | −1.89295180E−06 | −3.29594502E−06 | −2.46372191E−06 | 9.16184864E−07 |
| A20= | 1.95691598E−07 | 3.34011678E−07 | 3.23038439E−07 | −6.02566921E−08 |
| A22= | −8.81942615E−09 | −1.48756147E−08 | −1.62003315E−08 | 1.66716409E−09 |
| Surface # | 11 | 12 | 13 | 14 |
| k= | 9.62016000E+01 | −1.60097000E+01 | −9.90000000E+01 | 7.33868000E−01 |
| A4= | −8.93757893E−03 | −1.08955600E−02 | −3.02979962E−03 | 9.06989907E−04 |
| A6= | 1.91085458E−03 | −6.00830850E−04 | −1.22944556E−03 | −2.14655562E−03 |
| A8= | −1.72426313E−03 | 2.08658052E−03 | 3.37473661E−04 | 3.12164613E−04 |
| A10= | 1.08209719E−03 | −1.90277131E−03 | −1.04957368E−04 | 7.07204868E−05 |
| A12= | −5.09371556E−04 | 1.09821398E−03 | 8.79343564E−05 | −4.43645644E−05 |
| A14= | 1.75341544E−04 | −4.34167814E−04 | −4.82260621E−05 | 1.12798115E−05 |
| A16= | −4.33546882E−05 | 1.21210795E−04 | 1.57773030E−05 | −1.83529748E−06 |
| A18= | 7.60858473E−06 | −2.42743034E−05 | −3.36559035E−06 | 2.08459622E−07 |
| A20= | −9.27935666E−07 | 3.49924886E−06 | 4.89317333E−07 | −1.69230749E−08 |
| A22= | 7.49224369E−08 | −3.59734998E−07 | −4.90618975E−08 | 9.79868864E−10 |
| A24= | −3.59639626E−09 | 2.57008367E−08 | 3.34511092E−09 | −3.95674411E−11 |
| A26= | 7.73348208E−11 | −1.21068328E−09 | −1.48204956E−10 | 1.05956496E−12 |
| A28= | | 3.37448916E−11 | 3.84702902E−12 | −1.69188021E−14 |
| A30= | | −4.20499210E−13 | −4.43552048E−14 | 1.21968601E−16 |
| Surface # | 15 | 16 | 17 | 18 |
| k= | −9.52326000E−01 | 5.01519000E+01 | 8.95007000E+01 | −9.31234000E−01 |
| A4= | −1.91959465E−03 | −5.17650521E−04 | −2.65487027E−02 | −2.76257026E−02 |
| A6= | −1.71719053E−04 | 8.26548323E−04 | 6.30049775E−03 | 5.41150210E−03 |
| A8= | −2.05242600E−04 | −3.00332417E−04 | −1.22335777E−03 | −8.11840490E−04 |
| A10= | 1.03824581E−04 | 5.36807738E−05 | 1.74984318E−04 | 8.71532314E−05 |
| A12= | −2.87811984E−05 | −5.83877386E−06 | −1.76274504E−05 | −6.72359285E−06 |
| A14= | 5.49691230E−06 | 4.16616522E−07 | 1.27829671E−06 | 3.76811145E−07 |
| A16= | −7.58619039E−07 | −2.00748981E−08 | −6.81844092E−08 | −1.54197809E−08 |
| A18= | 7.63964193E−08 | 6.52123163E−10 | 2.69838334E−09 | 4.59139080E−10 |
| A20= | −5.60544563E−09 | −1.37507938E−11 | −7.89517071E−11 | −9.80948375E−12 |
| A22= | 2.96401471E−10 | 1.67688939E−13 | 1.68196916E−12 | 1.46100300E−13 |
| A24= | −1.10040782E−11 | −7.09184338E−16 | −2.53094146E−14 | −1.43677362E−15 |
| A26= | 2.72091048E−13 | −6.97692311E−18 | 2.54432569E−16 | 8.36768605E−18 |
| A28= | −4.01956090E−15 | 7.16067773E−20 | −1.53059088E−18 | −2.18193497E−20 |
| A30= | 2.68002052E−17 | | 4.15989944E−21 | |

In the 9th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 9th embodiment, so an explanation in this regard will not be provided again.

Moreover, these parameters can be calculated from Table 9A and Table 9B as the following values and satisfy the following conditions in Table 9C:

TABLE 9C
9th Embodiment

| | | | |
|---|---|---|---|
| f [mm] | 9.07 | (R14 + R16)/(R14 − R16) | 1.19 |
| Fno | 1.70 | R16/CT4 | 6.06 |
| HFOV [degrees] | 41.0 | CT1/CT5 | 0.97 |
| TL/ImgH | 1.46 | CT4/T34 | 1.26 |
| TL/f | 1.31 | CT3/(CT4 + CT5) | 0.28 |
| TL/BL | 12.98 | CT5/(CT6 + CT7) | 0.68 |
| \|f1/f2\| | 0.48 | T67/T78 | 0.38 |
| \|f2/f6\| | 0.76 | ΣCT/ΣAT | 2.10 |
| f3/f7 | 1.75 | ET6/CT6 | 1.76 |
| f7/f8 | −2.52 | \|Sag7R1\|/CT7 | 0.35 |
| f/f67 | 0.17 | (T78 − Sag7R2 + | 0.29 |
| | | Sag8R1)/T78 | |
| \|f/f4\| + \|f/f5\| + \|f/f6\| | 0.85 | V4 + V6 | 65.7 |
| (\|f/f5\| + \|f/f6\|)/ | 0.45 | V5/V1 | 1.0 |
| (\|f/f7\| + \|f/f8\|) | | | |
| \|f/R9\| + \|f/R10\| | 1.28 | Vmin | 20.4 |
| \|f/R13\| + \|f/R14\| | 1.34 | V1/N1 | 36.5 |
| f1/\|R2\| | 0.39 | V2/N2 | 12.3 |
| f1/CT1 | 6.59 | V3/N3 | 36.3 |
| 10 × CT2/f2 | −0.16 | V4/N4 | 23.9 |
| R1/R11 | −0.05 | V5/N5 | 36.3 |
| (R4 + R14)/(R4 − R14) | −1.26 | V6/N6 | 17.8 |
| (R13 + R14)/(R13 − R14) | −1.43 | V7/N7 | 36.3 |
| (R12 + R16)/(R12 − R16) | 1.57 | V8/N8 | 36.5 |

### 10th Embodiment

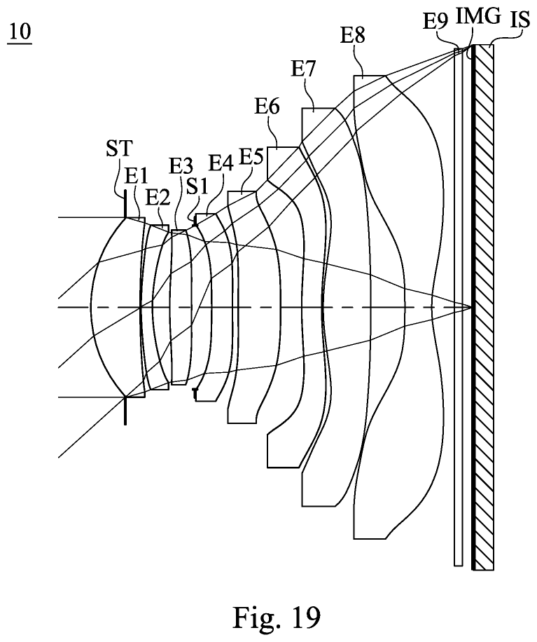

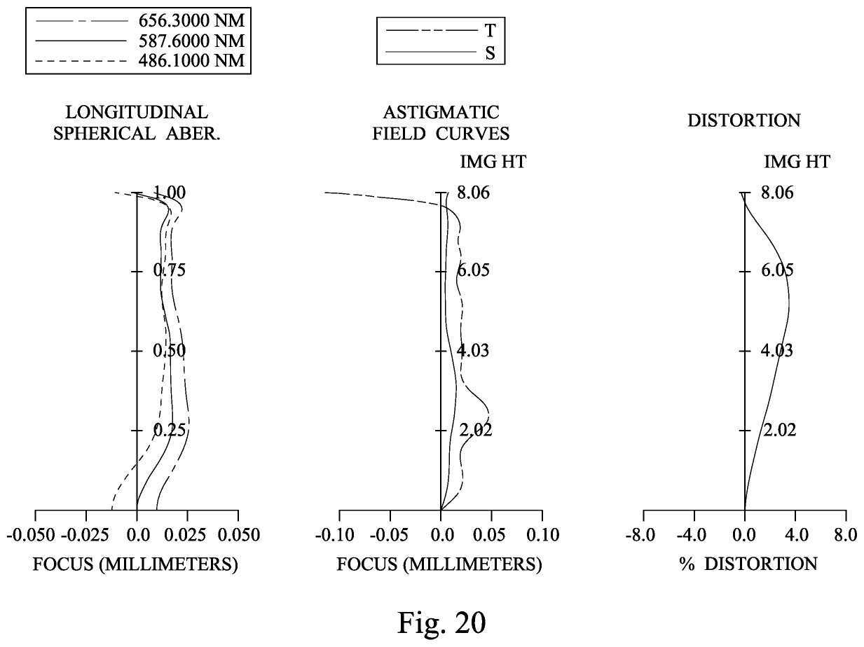

FIG. 19 is a schematic view of an imaging apparatus 10 according to the 10th embodiment of the present disclosure. FIG. 20 shows spherical aberration curves, astigmatic field curves and a distortion curve of the imaging apparatus 10 according to the 10th embodiment. In FIG. 19, the imaging apparatus 10 includes a photographing system lens assembly (its reference numeral is omitted) and an image sensor IS. The photographing system lens assembly includes, in order from an object side to an image side along an optical path, an aperture stop ST, a first lens element E1, a second lens element E2, a third lens element E3, a stop S1, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the photographing system lens assembly. The photographing system lens assembly includes eight lens elements (E1, E2, E3, E4, E5, E6, E7, E8) without additional one or more lens elements inserted between the first lens element E1 and the eighth lens element E8.

The first lens element E1 with positive refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of a plastic material, and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point and one critical point, and the image-side surface of the third lens element E3 includes one inflection point and one critical point.

The fourth lens element E4 with negative refractive power has an object-side surface being concave in a paraxial region thereof and an image-side surface being concave in a paraxial region thereof. The fourth lens element E4 is made of a plastic material, and has the object-side surface and the image-side surface being both aspheric. Furthermore, the object-side surface of the fourth lens element E4 includes one inflection point, and the image-side surface of the fourth lens element E4 includes two inflection points and one critical point.

The fifth lens element E5 with positive refractive power has an object-side surface being convex in a paraxial region thereof and an image-side surface being convex in a paraxial region thereof. The fifth lens element E5 is made of a plastic material, and has the object-side surface and the image-side surface being both aspheric. Furthermore, the object-side surface of the fifth lens element E5 includes three inflection points and one critical point, and the image-side surface of the fifth lens element E5 includes one inflection point and one critical point.

The sixth lens element E6 with positive refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes three inflection points and one critical point.

The seventh lens element E7 with positive refractive power has an object-side surface being convex in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes four inflection points and one critical point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes four inflection points and two critical points, and the image-side surface of the eighth lens element E8 includes two inflection points and one critical point.

The filter E9 is made of a glass material, which is located between the eighth lens element E8 and the image surface IMG in order, and will not affect the focal length of the photographing system lens assembly.

The detailed optical data of the 10th embodiment are shown in Table 10A and the aspheric surface data are shown in Table 10B below.

TABLE 10A
10th Embodiment
f = 8.95 mm, Fno = 1.62, HFOV = 42.1 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −1.061 | | | | |
| 2 | Lens 1 | 4.1864 | ASP | 1.515 | Plastic | 1.534 | 56.0 | 9.21 |
| 3 | | 24.4694 | ASP | 0.030 | | | | |
| 4 | Lens 2 | 8.6514 | ASP | 0.350 | Plastic | 1.660 | 20.4 | −21.33 |
| 5 | | 5.2718 | ASP | 0.534 | | | | |
| 6 | Lens 3 | 15.3950 | ASP | 0.671 | Plastic | 1.544 | 56.0 | 30.19 |
| 7 | | 241.7606 | ASP | 0.109 | | | | |
| 8 | Stop | Plano | | 0.511 | | | | |
| 9 | Lens 4 | −41.9802 | ASP | 0.640 | Plastic | 1.639 | 23.5 | −30.12 |
| 10 | | 35.7143 | ASP | 0.176 | | | | |
| 11 | Lens 5 | 30.5380 | ASP | 1.307 | Plastic | 1.544 | 56.0 | 38.53 |
| 12 | | −65.8363 | ASP | 0.648 | | | | |
| 13 | Lens 6 | 11.5757 | ASP | 0.620 | Plastic | 1.639 | 23.5 | 145.65 |
| 14 | | 12.9451 | ASP | 0.044 | | | | |
| 15 | Lens 7 | 7.5339 | ASP | 1.461 | Plastic | 1.544 | 56.0 | 12.21 |
| 16 | | −52.4025 | ASP | 1.053 | | | | |
| 17 | Lens 8 | −33.3613 | ASP | 0.827 | Plastic | 1.545 | 56.1 | −6.41 |
| 18 | | 3.9340 | ASP | 0.700 | | | | |

| | | | | | | | |
|---|---|---|---|---|---|---|---|
| 19 | Filter | Plano | 0.240 | Glass | 1.517 | 64.2 | — |
| 20 | | Plano | 0.344 | | | | |
| 21 | Image | Plano | — | | | | |

Reference wavelength is 587.6 nm (d-line).
Effective radius of Surface 8 (stop S1) is 2.521 mm.

TABLE 10B
Aspheric Coefficients

| Surface # | 2 | 3 | 4 | 5 |
|---|---|---|---|---|
| k= | −1.38546000E−02 | −1.22806000E+01 | 2.47101000E+00 | −4.14471000E+00 |
| A4= | 4.56825165E−04 | −4.40202833E−03 | −1.15238238E−02 | −3.45115161E−03 |
| A6= | 2.59730817E−04 | 4.17718471E−03 | 3.93414279E−03 | 1.23291393E−04 |
| A8= | −1.83656393E−04 | −2.50403569E−03 | −1.69372431E−03 | 7.80891497E−04 |
| A10= | 9.28698609E−05 | 1.13943421E−03 | 7.06364872E−04 | −6.03212684E−04 |
| A12= | −2.94306749E−05 | −3.74731905E−04 | −2.21274339E−04 | 3.11019974E−04 |
| A14= | 6.06787726E−06 | 8.51038586E−05 | 4.84802031E−05 | −1.07492338E−04 |
| A16= | −8.09052860E−07 | −1.28463771E−05 | −7.02836515E−06 | 2.47923443E−05 |
| A18= | 6.67844598E−08 | 1.22111959E−06 | 6.39154181E−07 | −3.62704104E−06 |
| A20= | −3.11277789E−09 | −6.57020909E−08 | −3.28519001E−08 | 3.05286450E−07 |
| A22= | 6.20523739E−11 | 1.51384754E−09 | 7.23420480E−10 | −1.12400667E−08 |
| Surface # | 6 | 7 | 9 | 10 |
| k= | −4.95614000E+00 | −9.90000000E+01 | 9.90000000E+01 | −9.90000000E+01 |
| A4= | −1.64237092E−03 | −2.73113079E−03 | −9.22821907E−03 | −1.67978512E−02 |
| A6= | −7.47825373E−04 | −1.76198613E−03 | 1.92941937E−03 | 7.35890690E−03 |
| A8= | 3.37801947E−04 | 1.58602599E−03 | −2.27565062E−03 | −4.80499513E−03 |
| A10= | −4.71366641E−04 | −1.32219937E−03 | 1.36052825E−03 | 2.21363634E−03 |
| A12= | 3.59486712E−04 | 6.89564239E−04 | −5.46609067E−04 | −7.23960577E−04 |
| A14= | −1.61329916E−04 | −2.30325291E−04 | 1.48369689E−04 | 1.64140015E−04 |
| A16= | 4.45136922E−05 | 4.96777509E−05 | −2.63069650E−05 | −2.48048977E−05 |
| A18= | −7.40321937E−06 | −6.69283171E−06 | 2.89782331E−06 | 2.35892672E−06 |
| A20= | 6.83225332E−07 | 5.12850143E−07 | −1.79618774E−07 | −1.26908064E−07 |
| A22= | −2.69592438E−08 | −1.71387511E−08 | 4.80506176E−09 | 2.93786712E−09 |
| Surface # | 11 | 12 | 13 | 14 |
| k= | 8.59495000E+01 | 4.61566000E+01 | 6.84770000E+00 | −3.63592000E+00 |
| A4= | −1.81995596E−02 | −1.71420834E−02 | −1.02848049E−02 | 8.31025534E−03 |
| A6= | 8.07844927E−03 | 4.47498571E−03 | 2.84620783E−03 | −1.23817458E−02 |
| A8= | −3.87101235E−03 | −2.05345505E−03 | −1.34919099E−03 | 7.00858044E−03 |
| A10= | 1.32346244E−03 | 9.67680863E−04 | 4.81539617E−04 | −2.37904156E−03 |
| A12= | −2.74214828E−04 | −3.62899408E−04 | −1.35933488E−04 | 5.22748432E−04 |
| A14= | 1.60601018E−05 | 1.02431922E−04 | 2.90406109E−05 | −7.85588127E−05 |
| A16= | 8.18369204E−06 | −2.13386060E−05 | −4.46164908E−06 | 8.36325756E−06 |
| A18= | −2.66668638E−06 | 3.23255349E−06 | 4.78312600E−07 | −6.42580126E−07 |
| A20= | 3.93070186E−07 | −3.49940060E−07 | −3.50026587E−08 | 3.57988446E−08 |
| A22= | −3.23891591E−08 | 2.63614347E−08 | 1.69230301E−09 | −1.43317620E−09 |
| A24= | 1.43888800E−09 | −1.32139686E−09 | −5.08863719E−11 | 4.01863930E−11 |
| A26= | −2.69229262E−11 | 4.06603948E−11 | 8.43194280E−13 | −7.49194307E−13 |
| A28= | | −6.50481034E−13 | −5.67786346E−15 | 8.34234920E−15 |
| A30= | | 3.38736495E−15 | | −4.19962420E−17 |
| Surface # | 15 | 16 | 17 | 18 |
| k= | −1.87036000E+00 | −9.90000000E+01 | 9.01602000E+00 | −9.67626000E−01 |
| A4= | 1.01539241E−02 | 4.16640312E−03 | −2.15638276E−02 | −2.38985404E−02 |
| A6= | −1.50910084E−02 | −2.66215903E−03 | 2.63028222E−03 | 3.47246073E−03 |
| A8= | 7.60928129E−03 | 6.81139599E−04 | −4.14615899E−04 | −4.02780188E−04 |
| A10= | −2.30949847E−03 | −1.05557565E−04 | 9.17866315E−05 | 3.44861048E−05 |
| A12= | 4.61543976E−04 | 1.17115692E−05 | −1.39992340E−05 | −2.05327979E−06 |
| A14= | −6.39676949E−05 | −1.00328082E−06 | 1.38133981E−06 | 7.91300514E−08 |
| A16= | 6.33328365E−06 | 6.64798707E−08 | −9.23454209E−08 | −1.63610136E−09 |
| A18= | −4.54609725E−07 | −3.29273604E−09 | 4.31431519E−09 | −2.69510082E−12 |
| A20= | 2.37223121E−08 | 1.17105915E−10 | −1.42658932E−10 | 1.22697346E−12 |
| A22= | −8.91051575E−10 | −2.86681279E−12 | 3.32768090E−12 | −3.67105094E−14 |
| A24= | 2.34711815E−11 | 4.55662237E−14 | −5.35995580E−14 | 5.52897418E−16 |
| A26= | −4.11401687E−13 | −4.21969241E−16 | 5.67747352E−16 | −4.40596137E−18 |
| A28= | 4.30862459E−15 | 1.72525022E−18 | −3.56127093E−18 | 1.47822348E−20 |
| A30= | −2.03973217E−17 | | 1.00298570E−20 | |

In the 10th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 10th embodiment, so an explanation in this regard will not be provided again.

Moreover, these parameters can be calculated from Table 10A and Table 10B as the following values and satisfy the following conditions in Table 10C:

TABLE 10C
10th Embodiment

| | | | |
|---|---|---|---|
| f [mm] | 8.95 | (R14 + R16)/(R14 − R16) | 0.86 |
| Fno | 1.62 | R16/CT4 | 6.15 |
| HFOV [degrees] | 42.1 | CT1/CT5 | 1.16 |
| TL/ImgH | 1.46 | CT4/T34 | 1.03 |
| TL/f | 1.32 | CT3/(CT4 + CT5) | 0.34 |
| TL/BL | 9.17 | CT5/(CT6 + CT7) | 0.63 |
| \|f1/f2\| | 0.43 | T67/T78 | 0.04 |
| \|f2/f6\| | 0.15 | ΣCT/ΣAT | 2.38 |
| f3/f7 | 2.47 | ET6/CT6 | 1.57 |
| f7/f8 | −1.91 | \|Sag7R1\|/CT7 | 0.44 |
| f/f67 | 0.78 | (T78 − Sag7R2 + | 0.55 |
| | | Sag8R1)/T78 | |
| \|f/f4\| + \|f/f5\| + \|f/f6\| | 0.59 | V4 + V6 | 47.0 |
| (\|f/f5\| + \|f/f6\|)/ | 0.14 | V5/V1 | 1.0 |
| (\|f/f7\| + \|f/f8\|) | | | |
| \|f/R9\| + \|f/R10\| | 0.43 | Vmin | 20.4 |
| \|f/R13\| + \|f/R14\| | 1.36 | V1/N1 | 36.5 |
| f1/\|R2\| | 0.38 | V2/N2 | 12.3 |
| f1/CT1 | 6.08 | V3/N3 | 36.3 |
| 10 × CT2/f2 | −0.16 | V4/N4 | 14.3 |
| R1/R11 | 0.36 | V5/N5 | 36.3 |
| (R4 + R14)/(R4 − R14) | −0.82 | V6/N6 | 14.3 |
| (R13 + R14)/(R13 − R14) | −0.75 | V7/N7 | 36.3 |
| (R12 + R16)/(R12 − R16) | 1.87 | V8/N8 | 36.3 |

### 11th Embodiment

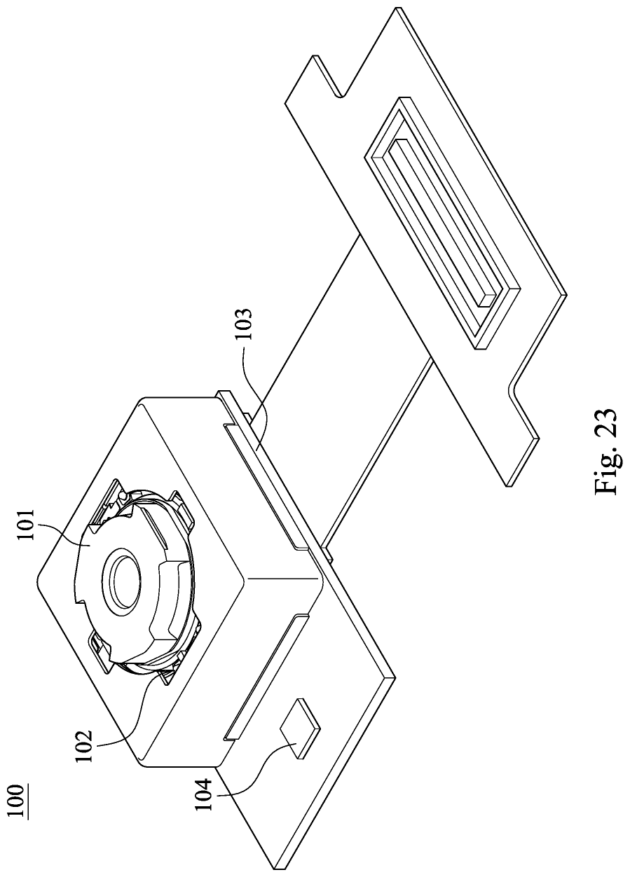

FIG. 23 is a schematic view of an imaging apparatus 100 according to the 11th embodiment of the present disclosure. In FIG. 23, the imaging apparatus 100 of the 11th embodiment is a camera module, the imaging apparatus 100 includes an imaging lens assembly 101, a driving apparatus 102 and an image sensor 103, wherein the imaging lens assembly 101 includes the photographing system lens assembly of the present disclosure and a lens barrel (not shown in drawings) for carrying the photographing system lens assembly. The imaging apparatus 100 can focus light from an imaged object via the imaging lens assembly 101, perform image focusing by the driving apparatus 102, and generate an image on the image sensor 103, and the imaging information can be transmitted.

The driving apparatus 102 can be an auto-focus module, which can be driven by driving systems, such as voice coil motors (VCM), micro electro-mechanical systems (MEMS), piezoelectric systems, and shape memory alloys etc. The photographing system lens assembly can obtain a favorable imaging position by the driving apparatus 102 so as to capture clear images when the imaged object is disposed at different object distances.

The imaging apparatus 100 can include the image sensor 103 located on the image surface of the photographing system lens assembly, such as CMOS and CCD, with superior photosensitivity and low noise. Thus, it is favorable for providing realistic images with high definition image quality thereof. Moreover, the imaging apparatus 100 can further include an image stabilization module 104, which can be a kinetic energy sensor, such as an accelerometer, a gyro sensor, and a Hall Effect sensor. In the 11th embodiment, the image stabilization module 104 is a gyro sensor, but is not limited thereto. Therefore, the variation of different axial directions of the photographing system lens assembly can adjusted so as to compensate the image blur generated by motion at the moment of exposure, and it is further favorable for enhancing the image quality while photographing in motion and low light situation. Furthermore, advanced image compensation functions, such as optical image stabilizations (OIS) and electronic image stabilizations (EIS) etc., can be provided.

### 12th Embodiment

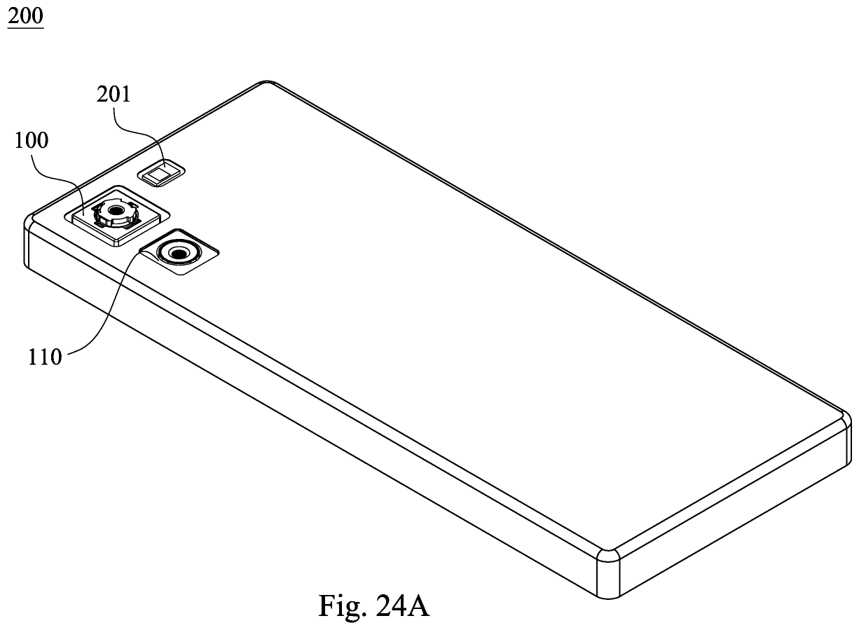

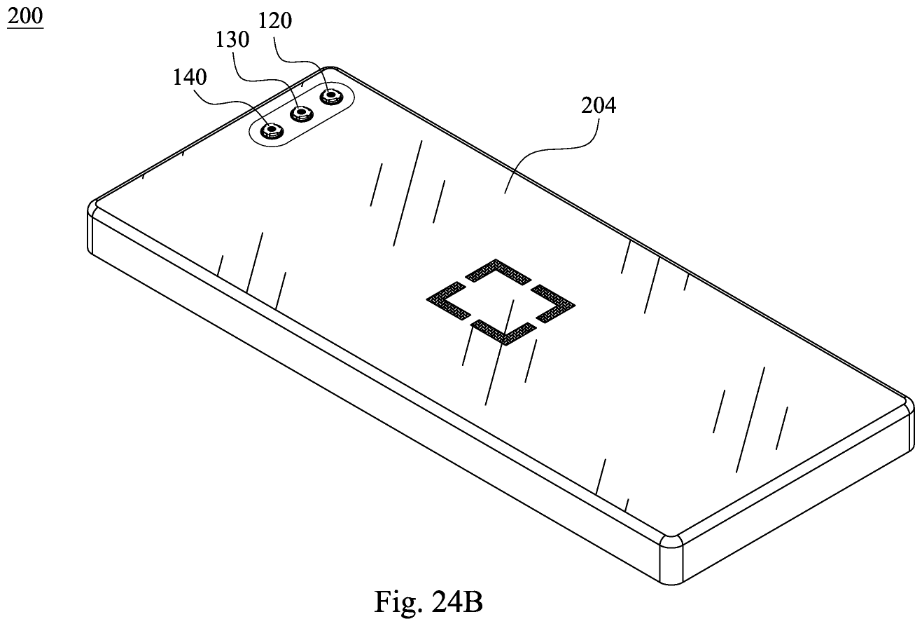

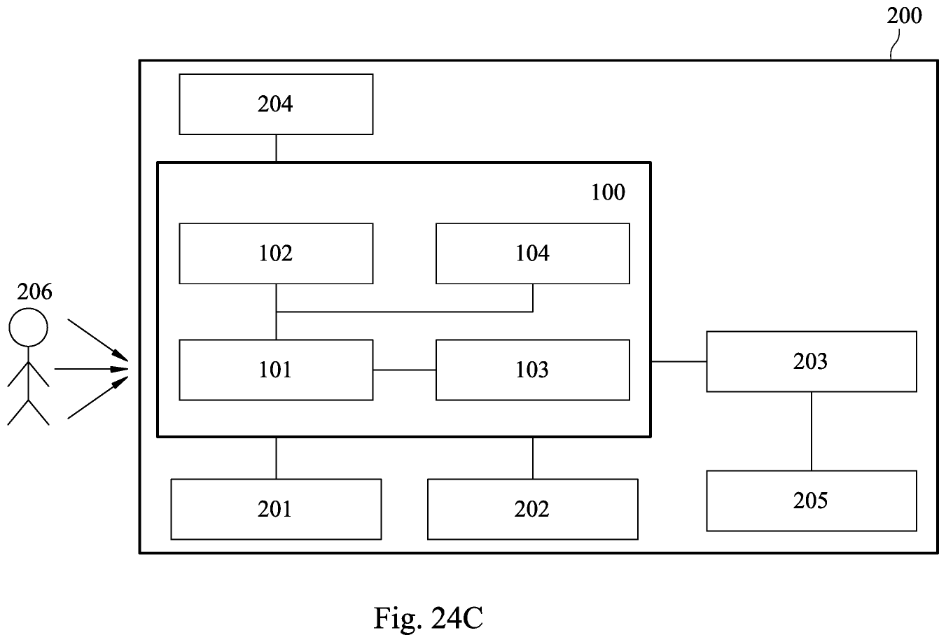

FIG. 24A is a schematic view of one side of an electronic device 200 according to the 12th embodiment of the present disclosure. FIG. 24B is a schematic view of another side of the electronic device 200 of FIG. 24A. FIG. 24C is a system schematic view of the electronic device 200 of FIG. 24A. In FIGS. 24A, 24B and 24C, the electronic device 200 according to the 12th embodiment is a smartphone, which include imaging apparatuses 100, 110, 120, 130, 140, a flash module 201, a focusing assisting module 202, an image signal processor (ISP) 203, a user interface 204 and an image software processor 205, wherein each of the imaging apparatuses 120, 130, 140 is a front camera. When the user captures images of an imaged object 206 via the user interface 204, the electronic device 200 focuses and generates an image via at least one of the imaging apparatuses 100, 110, 120, 130, 140, while compensating for low illumination via the flash module 201 when necessary. Then, the electronic device 200 quickly focuses on the imaged object 206 according to its object distance information provided by the focusing assisting module 202, and optimizes the image via the image signal processor 203 and the image software processor 205. Thus, the image quality can be further enhanced. The focusing assisting module 202 can adopt conventional infrared or laser for obtaining quick focusing, and the user interface 204 can utilize a touch screen or a physical button for capturing and processing the image with various functions of the image processing software.

Each of the imaging apparatuses 100, 110, 120, 130, 140 according to the 12th embodiment can include the photographing system lens assembly of the present disclosure, and can be the same or similar to the imaging apparatus 100 according to the aforementioned 11th embodiment, and will not describe again herein. In detail, according to the 12th embodiment, the imaging apparatuses 100, 110 can be wide angle imaging apparatus and ultra-wide angle imaging apparatus, respectively. The imaging apparatuses 120, 130, 140 can be wide angle imaging apparatus, ultra-wide angle imaging apparatus and TOF (Time-Of-Flight) module, respectively, or can be others imaging apparatuses, which will not be limited thereto. Further, the connecting relationships between each of the imaging apparatuses 110, 120, 130, 140 and other elements can be the same as the imaging apparatus 100 in FIG. 24C, or can be adaptively adjusted according to the type of the imaging apparatuses, which will not be shown and detailed descripted again.

### 13th Embodiment

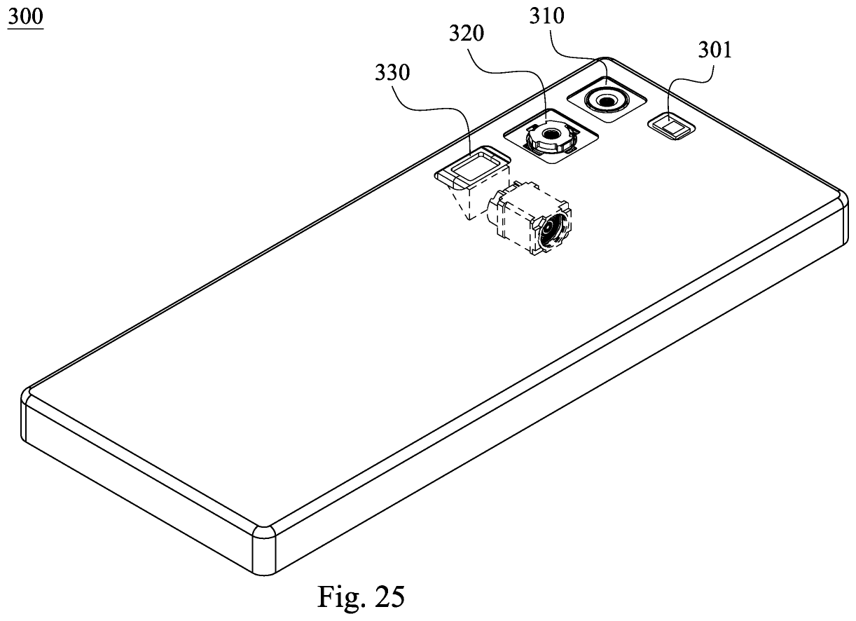

FIG. 25 is a schematic view of one side of an electronic device 300 according to the 13th embodiment of the present disclosure. According to the 13th embodiment, the electronic device 300 is a smartphone, which include imaging apparatuses 310, 320, 330 and a flash module 301.

The electronic device 300 according to the 13th embodiment can include the same or similar elements to that according to the 12th embodiment, and each of the imaging apparatuses 310, 320, 330 according to the 13th embodiment can have a configuration which is the same or similar to that according to the 12th embodiment, and will not describe again herein. In detail, according to the 13th embodiment, each of the imaging apparatuses 310, 320, 330 can include the photographing system lens assembly of the present disclosure, and can be the same or similar to the imaging apparatus 100 according to the aforementioned 11th embodiment, and will not describe again herein. In detail, the imaging apparatus 310 can be ultra-wide angle imaging apparatus, the imaging apparatus 320 can be wide angle imaging apparatus, the imaging apparatus 330 can be telephoto imaging apparatus (which can include light path folding element), or can be adaptively adjusted according to the type of the imaging apparatuses, which will not be limited to the arrangement.

### 14th Embodiment

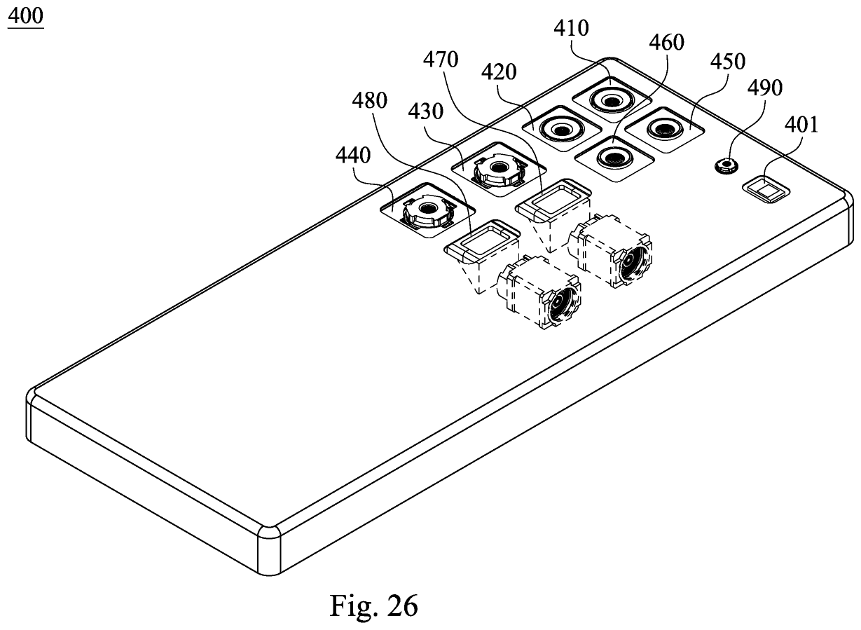

FIG. 26 is a schematic view of one side of an electronic device 400 according to the 14th embodiment of the present disclosure. According to the 14th embodiment, the electronic device 400 is a smartphone, which include imaging apparatuses 410, 420, 430, 440, 450, 460, 470, 480, 490 and a flash module 401.

The electronic device 400 according to the 14th embodiment can include the same or similar elements to that according to the 12th embodiment, and each of the imaging apparatuses 410, 420, 430, 440, 450, 460, 470, 480, 490 and the flash module 401 can have a configuration which is the same or similar to that according to the 12th embodiment, and will not describe again herein. In detail, according to the 14th embodiment, each of the imaging apparatuses 410, 420, 430, 440, 450, 460, 470, 480, 490 can include the image capturing system lens assembly of the present disclosure, and can be the same or similar to the imaging apparatus 100 according to the aforementioned 11th embodiment, and will not describe again herein.

In detail, each of the imaging apparatuses 410, 420 can be ultra-wide angle imaging apparatus, each of the imaging apparatuses 430, 440 can be wide angle imaging apparatus, each of the imaging apparatuses 450, 460 can be telephoto imaging apparatus, each of the imaging apparatuses 470, 480 can be telephoto imaging apparatus (which can include light path folding element), the imaging apparatus 490 can be TOF module, or can be adaptively adjusted according to the type of the imaging apparatuses, which will not be limited to the arrangement.

### 15th Embodiment

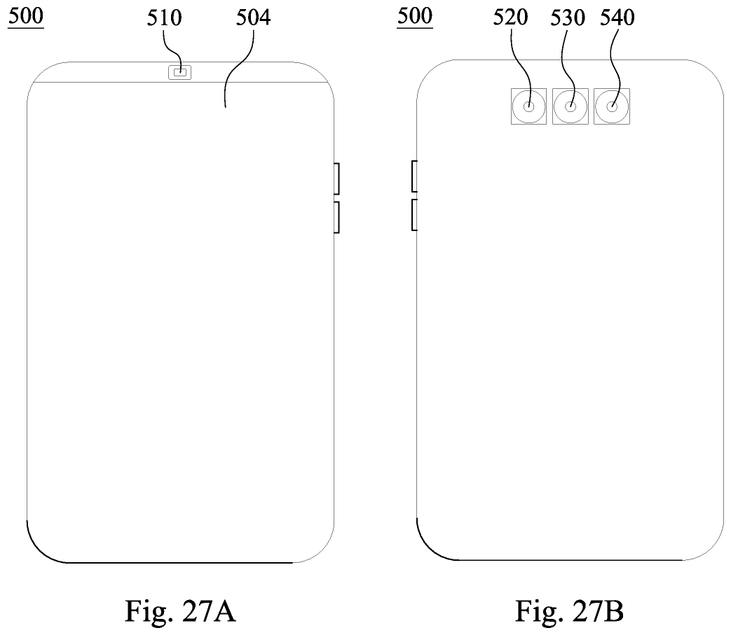

FIG. 27A is a schematic view of one side of an electronic device 500 according to the 15th embodiment of the present disclosure. FIG. 27B is a schematic view of another side of the electronic device 500 according to the 15th embodiment of FIG. 27A. In FIG. 27A and FIG. 27B, according to the 15th embodiment, the electronic device 500 is a smartphone, which include imaging apparatuses 510, 520, 530, 540 and a user interface 504.

The electronic device 500 according to the 15th embodiment can include the same or similar elements to that according to the 12th embodiment, and each of the imaging apparatuses 510, 520, 530, 540 and the user interface 504 can have a configuration which is the same or similar to that according to the 12th embodiment, and will not describe again herein. In detail, according to the 15th embodiment, the imaging apparatus 510 corresponds to a non-circular opening located on an outer side of the electronic device 500 for capturing the image, and the imaging apparatuses 520, 530, 540 can be telephoto imaging apparatus, wide angle imaging apparatus and ultra-wide angle imaging apparatus, respectively, or can be adaptively adjusted according to the type of the imaging apparatuses, which will not be limited to the arrangement.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing system lens assembly comprising eight lens elements, the eight lens elements being, in order from an object side to an image side:
a first lens element, a second lens element, a third lens element, a fourth lens element, a fifth lens element, a sixth lens element, a seventh lens element and an eighth lens element; each of the eight lens elements has an object-side surface towards the object side and an image-side surface towards the image side;
wherein a focal length of the photographing system lens assembly is f, a focal length of the fifth lens element is f5, a focal length of the sixth lens element is f6, a focal length of the seventh lens element is f7, a focal length of the eighth lens element is f8, a sum of central thicknesses of the lens elements of the photographing system lens assembly is ΣCT, a sum of all axial distances between adjacent lens elements of the photographing system lens assembly is ΣAT, a curvature radius of the image-side surface of the second lens element is R4, a curvature radius of the image-side surface of the sixth lens element is R12, a curvature radius of the image-side surface of the seventh lens element is R14, a curvature radius of the image-side surface of the eighth lens element is R16, and the following conditions are satisfied:
$$0 < ( \vert f / f 5 \vert + \vert f / f 6 \vert ) / ( \vert f / f 7 \vert + \vert f / f 8 \vert ) < 0 \text{.50} ; \\ 2. < \sum CT / \sum AT < 5. ; \\ - 10. 0 < f 7 / f 8 < - 1.5 ; \\ 0.9 < ( R 12 + R 16 ) / ( R 12 - R 16 ) < 3. ; and \\ - 1.95 < ( R 4 + R 14 ) / ( R 4 - R 14 ) < - 0.51 .$$

2. The photographing system lens assembly of claim 1, wherein the first lens element has positive refractive power; the object-side surface of the first lens element is convex in a paraxial region thereof; an axial distance between the object-side surface of the first lens element and an image surface is TL, an axial distance between the image-side surface of the eighth lens element and the image surface is BL, and the following condition is satisfied:
$$7.5 < TL / BL < 13.5 .$$

3. The photographing system lens assembly of claim 1, wherein the second lens element has negative refractive power; the image-side surface of the second lens element is concave in a paraxial region thereof; the focal length of the photographing system lens assembly is f, a curvature radius of the object-side surface of the fifth lens element is R9, a curvature radius of the image-side surface of the fifth lens element is R10, and the following condition is satisfied:
$$0.10 < \vert f / R 9 \vert + \vert f / R 10 \vert < 0.9 .$$

4. The photographing system lens assembly of claim 1, wherein the image-side surface of the fourth lens element is convex in a paraxial region thereof; a central thickness of the first lens element is CT1, a central thickness of the fifth lens element is CT5, and the following condition is satisfied:
$$0.5 < CT 1 / CT 5 < 2.0 .$$

5. The photographing system lens assembly of claim 1, wherein the object-side surface of the sixth lens element is convex in a paraxial region thereof; a central thickness of the fourth lens element is CT4, an axial distance between the third lens element and the fourth lens element is T34, and the following condition is satisfied:
$$1.1 < CT 4 / T 34 < 5.0 .$$

6. The photographing system lens assembly of claim 1, wherein an f-number of the photographing system lens assembly is Fno, the focal length of the photographing system lens assembly is f, a composite focal length of the sixth lens element and the seventh lens element is f67, and the following conditions are satisfied:
$$1 \text{.0} < Fno < 2. ; and \\ 0.1 < f / f 67 < 0.65 .$$

7. The photographing system lens assembly of claim 1, wherein an axial distance between the object-side surface of the first lens element and an image surface is TL, a maximum image height of the photographing system lens assembly is ImgH, a central thickness of the third lens element is CT3, a central thickness of the fourth lens element is CT4, a central thickness of the fifth lens element is CT5, and the following conditions are satisfied:
$$0.5 < TL / ImgH < 2. ; and \\ 0.05 < CT 3 / ( CT 4 + CT 5 ) < 0.45 .$$

8. The photographing system lens assembly of claim 1, wherein a central thickness of the second lens element is CT2, a focal length of the second lens element is f2, and the following condition is satisfied:
$$- 1.0 < 10 \times CT 2 / f 2 < - 0.15 .$$

9. The photographing system lens assembly of claim 1, wherein an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the sixth lens element is V6, an Abbe number of the seventh lens element is V7, an Abbe number of the eighth lens element is V8, a minimum among V1, V2, V3, V4, V5, V6, V7 and V8 is Vmin, a curvature radius of the object-side surface of the first lens element is R1, a curvature radius of the object-side surface of the sixth lens element is R11, and the following conditions are satisfied:
$$5. < V min < 20. ; and \\ - 0.2 < R 1 / R 11 < 0.5 .$$

10. The photographing system lens assembly of claim 1, wherein an Abbe number of one of the lens elements is V, a refractive index of the lens element is N, and at least one of the eight lens elements satisfies the following condition:
$$5.0 < V / N < 1 2. ;$$
wherein an Abbe number of the first lens element is V1, an Abbe number of the fifth lens element is V5, and the following condition is satisfied:
$$0.6 < V 5 / V 1 < 1.5 .$$

11. The photographing system lens assembly of claim 1, wherein a distance in parallel with an optical axis between a maximum effective radius position on the object-side surface of the sixth lens element and a maximum effective radius position on the image-side surface of the sixth lens element is ET6, a central thickness of the sixth lens element is CT6, and the following condition is satisfied:
$$1.15 < ET 6 / CT 6 < 2.5 .$$

12. The photographing system lens assembly of claim 1, wherein an axial distance between the seventh lens element and the eighth lens element is T78, a displacement in parallel with an optical axis from an axial vertex on the image-side surface of the seventh lens element to a maximum effective radius position on the image-side surface of the seventh lens element is Sag7R2, a displacement in parallel with the optical axis from an axial vertex on the object-side surface of the eighth lens element to a maximum effective radius position on the object-side surface of the eighth lens element is Sag8R1, and the following condition is satisfied:
$$0 < ( T78 - Sag 7 R 2 + Sag 8 R 1 ) / T 78 < 0.70 .$$

13. The photographing system lens assembly of claim 1, wherein a displacement in parallel with an optical axis from an axial vertex on the object-side surface of the seventh lens element to a maximum effective radius position on the object-side surface of the seventh lens element is Sag7R1, a central thickness of the seventh lens element is CT7, and the following condition is satisfied:
$$0 < \vert Sag 7 R1 \vert / CT 7 < 0.60 .$$

14. An imaging apparatus, comprising:
the photographing system lens assembly of claim 1; and
an image sensor disposed on an image surface of the photographing system lens assembly.

15. An electronic device, comprising:
the imaging apparatus of claim 14.

16. A photographing system lens assembly comprising eight lens elements, the eight lens elements being, in order from an object side to an image side:
a first lens element, a second lens element, a third lens element, a fourth lens element, a fifth lens element, a sixth lens element, a seventh lens element and an eighth lens element; each of the eight lens elements has an object-side surface towards the object side and an image-side surface towards the image side;
wherein the object-side surface of the seventh lens element is convex in a paraxial region thereof; the image-side surface of the eighth lens element comprises at least one inflection point;
wherein a focal length of the photographing system lens assembly is f, a focal length of the first lens element is f1, a focal length of the second lens element is f2, a focal length of the fifth lens element is f5, a focal length of the sixth lens element is f6, a focal length of the seventh lens element is f7, a focal length of the eighth lens element is f8, a sum of central thicknesses of the lens elements of the photographing system lens assembly is ΣCT, a sum of all axial distances between adjacent lens elements of the photographing system lens assembly is ΣAT, a central thickness of the first lens element is CT1, a central thickness of the fifth lens element is CT5, a central thickness of the sixth lens element is CT6, a central thickness of the seventh lens element is CT7, a curvature radius of the image-side surface of the seventh lens element is R14, a curvature radius of the image-side surface of the eighth lens element is R16, and the following conditions are satisfied:
$$0 < ( \vert f / f 5 \vert + \vert f / f 6 \vert ) / ( \vert f / f 7 \vert + \vert f / f 8 \vert ) < 0.5 ;$$
$$2. < \sum CT / \sum AT < 5. ;$$
$$0.5 < CT 5 / ( CT 6 + CT 7 ) < 1. ;$$
$$0.16 < ( R 14 + R 16 ) / ( R 14 - R 16 ) < 2.1 ;$$
$$0.1 < f 1 / CT 1 < 10. ; and$$
$$0.3 < \vert f 1 / f 2 \vert < 2. .$$

17. The photographing system lens assembly of claim 16, wherein the seventh lens element has positive refractive power; the focal length of the photographing system lens assembly is f, a focal length of the fourth lens element is f4, the focal length of the fifth lens element is f5, the focal length of the sixth lens element is f6, and the following condition is satisfied:
$$0.10 < \vert f / f 4 \vert + \vert f / f5 \vert + \vert f / f 6 \vert < 0.7 .$$

18. The photographing system lens assembly of claim 16, wherein the eighth lens element has negative refractive power; the image-side surface of the eighth lens element is concave in a paraxial region thereof; the focal length of the second lens element is f2, the focal length of the sixth lens element is f6, and the following condition is satisfied:
$$0 < \vert f 2 / f 6 \vert < 1.2 .$$

19. The photographing system lens assembly of claim 16, wherein the focal length of the photographing system lens assembly is f, an axial distance between the object-side surface of the first lens element and an image surface is TL, a curvature radius of the object-side surface of the seventh lens element is R13, the curvature radius of the image-side surface of the seventh lens element is R14, and the following conditions are satisfied:
$$0.5 < TL / f < 2. ; and$$
$$- 1.5 < ( R 13 + R 14 ) / ( R 13 - R 14 ) < 0 .$$

20. The photographing system lens assembly of claim 16, wherein an axial distance between the sixth lens element and the seventh lens element is T67, an axial distance between the seventh lens element and the eighth lens element is T78, and the following condition is satisfied:
$$0 < T 67 / T 78 < 0.40 .$$

21. The photographing system lens assembly of claim 16, wherein the focal length of the photographing system lens assembly is f, a curvature radius of the object-side surface of the seventh lens element is R13, the curvature radius of the image-side surface of the seventh lens element is R14, and the following condition is satisfied:
$$0.1 < \vert f / R 13 \vert + \vert f / R 14 \vert < 2. .$$

22. The photographing system lens assembly of claim 16, wherein the focal length of the first lens element is f1, a curvature radius of the image-side surface of the first lens element is R2, and the following condition is satisfied:
$$0.1 < f 1 / \vert R 2 \vert < 0.5 .$$

23. The photographing system lens assembly of claim 16, wherein an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the sixth lens element is V6, an Abbe number of the seventh lens element is V7, an Abbe number of the eighth lens element is V8, and the following conditions are satisfied:
$$5. < Vi < 20. , wherein i is at least one of 1 , 2 , 3 , 4 , 5 , 6 , 7 , 8 ; and 20. < V 4 + V 6 < 45. .$$

24. The photographing system lens assembly of claim 16, wherein a half of a maximum field of view of the photographing system lens assembly is HFOV, an axial distance between the object-side surface of the first lens element and an image surface is TL, an axial distance between the image-side surface of the eighth lens element and the image surface is BL, and the following conditions are satisfied:
$$30. degrees < HFOV < 50. degrees ; and 7.5 < TL / BL < 11. .$$

25. The photographing system lens assembly of claim 16, wherein a focal length of the third lens element is f3, the focal length of the seventh lens element is f7, and the following condition is satisfied:
$$- 6.0 < f 3 / f 7 < 3.2 .$$

26. The photographing system lens assembly of claim 16, wherein the curvature radius of the image-side surface of the eighth lens element is R16, a central thickness of the fourth lens element is CT4, and the following condition is satisfied:
$$2.9 < R 16 / C T 4 < 8.0 .$$
